(19) United States
(12) Patent Application Publication
(10) Pub. No.: US 2023/0204822 A1
(43) Pub. Date: Jun. 29, 2023

(54) STRUCTURALLY-COLORED ARTICLES AND METHODS FOR MAKING AND USING STRUCTURALLY-COLORED ARTICLES

(71) Applicant: NIKE, Inc., Beaverton, OR (US)

(72) Inventors: Jeremy Gantz, Lake Oswego, OR (US); Kim Kovel, Portland, OR (US); Yuanmin Wang, Portland, OR (US)

(21) Appl. No.: 17/660,683

(22) Filed: Apr. 26, 2022

Related U.S. Application Data
(60) Provisional application No. 63/266,133, filed on Dec. 29, 2021.
(60) Provisional application No. 63/266,130, filed on Dec. 29, 2021.
(60) Provisional application No. 63/266,135, filed on Dec. 29, 2021.

(51) Int. Cl. G02B 1/14; G02B 5/28; A43B 3/00

(52) U.S. Cl. CPC G02B 1/14; G02B 5/286; A43B 3/00

(57) ABSTRACT

The present disclosure provides for articles that exhibit structural colors. The article includes optical stacks that can be incorporated onto one or more components of an article, for example, when the article is an article of footwear, on an upper or sole of an article of footwear. Upon being subjected to abrasive forces, one or more of the layers of the optical stacks are removed, which can alter the appearance (e.g., structural color and/or non-structural color of areas) of the article. In this way, an article may have a certain appearance originally, but can change (e.g., randomly or intentionally) upon application of abrasive forces (e.g., through use or intentionally).

### CLAIM OF PRIORITY TO RELATED APPLICATION

This application claims the benefit of and priority to U.S. Provisional Application Ser. No. 63/266,133, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

In addition, this application claims the benefit of and priority to U.S. Provisional Application Ser. No. 63/266,130, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

In addition, this application claims the benefit of and priority to U.S. Provisional Application Ser. No. 63/266,135, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

### BACKGROUND

Structural color is caused by the physical interaction of light with the micro- or nano-features of a surface and the bulk material as compared to color derived from the presence of dyes or pigments that absorb or reflect specific wavelengths of light based on the chemical properties of the dyes or pigments. Color from dyes and pigments can be problematic in a number of ways. For example, dyes and pigments and their associated chemistries for fabrication and incorporation into finished goods may not be environmentally friendly.

### BRIEF DESCRIPTION OF THE DRAWINGS

Further embodiments of the present disclosure will be more readily appreciated upon review of the detailed description of its various embodiments, described below, when taken in conjunction with the accompanying drawings.

FIGS. 1A-1M shows various articles of footwear, apparel, athletic equipment, container, electronic equipment, and vision wear that include the primer layer in accordance with the present disclosure, while FIGS. 1N(a)-1Q(e) illustrate additional details regarding different types of footwear.

FIGS. 2A and 2B are transverse cross-section illustrations of optical stack having a textured surface and a substantially flat surface, respectively.

FIG. 3A illustrates a transverse cross-sectional illustration of a substrate including an optical stack including a first abrasion release layer between the first stack and the second stack, where areas of the first abrasion release layer and second stack are removed.

FIG. 3B illustrates a top view of substrate in FIG. 3A.

FIG. 4A illustrates a transverse cross-sectional illustration of a substrate including an optical stack including a first abrasion release layer between the first stack and a second abrasion layer between the substrate and the first stack. In addition, FIG. 4A illustrates areas where the first abrasion release layer and second stack are removed as well as areas of first stack are removed. FIG. 4B illustrates a top view of substrate in FIG. 4A.

FIG. 5A illustrates a transverse cross-sectional illustration of a substrate including an optical stack including a first abrasion release layer between the first stack and a second abrasion layer between the substrate and the first stack. In addition, FIG. 5A illustrates areas where the first abrasion release layer and second stack are removed as well as areas of first stack are removed. FIG. 5B illustrates a top view of substrate in FIG. 5A. FIG. 5C is a top view of a larger area that includes that shown in FIGS. 5A and 5B, but also includes other areas.

The drawings described herein are for illustration purposes only and are not intended to limit the scope of the present disclosure in any way.

### DESCRIPTION

The present disclosure provides for articles (e.g., structural color article) that exhibit structural colors. The color (e.g., structural color or non-structural color) can change upon abrasive forces applied to areas of the article that include optical stacks. The article includes optical stacks that can be incorporated onto one or more components of an article, for example, when the article is an article of footwear, on an upper or sole of an article of footwear. Upon being subjected to abrasive forces, one or more of the layers of the optical stacks are removed, which can alter the appearance (e.g., structural color and/or non-structural color of areas) of the article. In this way, an article may have a certain appearance at purchase, but can change (e.g., randomly or intentionally) upon application of abrasive forces (e.g., through use or intentionally).

The present disclosure provides for articles that exhibit structural colors through the use of the optical stacks upon exposure of certain areas to visible light. The optical stack(s) is disposed on an article surface (e.g., directly or on a substrate that is disposed on the article surface and when exposed to visible light, the optical stack(s) can impart a structural color (e.g., a first structural color or a second structural to the article), where the structural color (e.g., single color, multicolor such as iridescent color) is visible color produced, at least in part, through optical effects (e.g., through scattering, refraction, reflection, interference, and/or diffraction of visible wavelengths of light). The present disclosure provides for at least two optical stacks with at least one abrasion release layer (e.g., a polymer, composite materials, and the like) disposed between the optical stacks. For example, an article can have the following configuration: a first optical stack disposed on the article surface and an abrasion release layer is disposed between the first optical stack and a second optical stack (e.g., surface/first stack/release layer/second stack), where the second optical stack has a top side that is exterior facing to visible light. Prior to application of an abrasive force, the second stack imparts a second structural color that can be viewed by someone with 20 20 visual acuity from a distance of about 1 meter from the article. Upon application of an abrasive force, the second stack and/or the abrasion release layer are removed from the substrate. If the release layer is not removed, the surface has the color of the abrasion release layer. If the abrasion release layer is removed (or areas where the abrasion release layer is removed), the first optical stack imparts a first structural color, since visible light contacts the first stack, that can be viewed by someone with 20 20 visual acuity from a distance of about 1 meter from the article. If the abrasive force removes the second optical stack, the abrasion release layer, and the first optical stack, then the article has the color corresponding to the surface of the article. In other words, someone with 20 20 visual acuity from a distance of about 1 meter from the article observing the article can see the first structural color, the color of the abrasion release layer, the second structural color, or the color of the surface of the article on areas of the article. In this way, the appearance can change with use and/or be modified using abrasive forces.

In an additional example, an article can have the following configuration: an abrasion release layer disposed on article surface and a first optical stack disposed on the abrasion release layer (e.g., surface/abrasion release layer/first optical stack), where the first optical stack has a top exterior surface facing visible light. Prior to application of an abrasive force, the first stack imparts a first structural color that can be viewed by someone with 20 20 visual acuity from a distance of about 1 meter from the article. Upon application of an abrasive force, the first optical stack and/or the abrasion release layer are removed from the substrate. If the abrasion release layer is not removed, the article has the color of the abrasion release layer. If the abrasion release layer is removed and first optical stack is completely removed and then the color exposed is that of the underlying substrate.

In the various embodiments provided herein, the abrasive force (e.g., first, second, or third abrasive force) is likely to be applied in an uneven manner so that random areas of the article will have different colors (e.g., structural and/or non-structural colors). In this way, articles of the present disclosure can have an aesthetically pleasing and unique appearance that can change over time as the article is used and subject to various abrasive forces (e.g., random abrasive forces and/or intentional random forces).

Upon exposure to visible light (e.g., sunlight, interior lighting, and the like), each optical stack can impart a structural color (e.g., first structural color, second structural color) upon exposure to visible light. For example, upon exposure to light the first stack imparts a first structural color and upon exposure to visible light the second stack imparts a second structural color. In some aspects, the abrasion release layer can have a color that is not a structural color, where the color may be inherent in the material or can be altered using colorants such as pigments or dyes. In some aspects, the abrasion release layer can contribute to the structural color (e.g., the abrasion release layer may be reflective). The first structural color and the second structural color can be different in one or more of a hue, a value, a chroma, or any combination thereof when viewed from the same angle of observation from someone with 20 20 visual acuity from a distance of about 1 meter from the article under the same lighting conditions. The first structural color, the second structural color, and the color of one or more of the release layers can be different in one or more of a hue, a value, a chroma, or any combination thereof when viewed from the same angle of observation from someone with 20 20 visual acuity from a distance of about 1 meter from the article under the same lighting conditions. As a result, after application of abrasive forces, the article can have an aesthetically pleasing and unique appearance that displays various color combinations in different areas (e.g., two or more colors (structural colors and non-structural color)).

Each optical stack (e.g., first optical stack, second optical stack), independently of one another, can include one or more layers (e.g., a reflective layer(s), a constituent layer(s), and the like). Each optical stack thereof can be a single layer reflector, a single layer filter, a multilayer reflector or a multilayer filter. In an aspect, the layers of each of the optical stacks contribute entirely to the production of the structural color. In another aspect, the abrasion release layer can contribute some to production of the second structural color, but the structural is primarily produced by the other layers (those excluding the abrasion release layer) of the optical stack.

In addition, each optical stack (first optical stack, second optical stack) can include an optional textured surface, where the optical stack is disposed on a surface of the article with the optional textured surface between the optical stack and the surface or where the textured surface is part of the optical stack, depending upon the design. The combination of the optical stack and the optional textured surface can impart the structural color (e.g., the first structural color and/or the second structural color) to the article, where the first structural color and the second structural color can be designed to be different than the color of the components of the optical stack, the release layer(s), and/or the underlying material.

The article can be a finished article such as, for example, an article of footwear, apparel or sporting equipment. The article can be a component of an article of footwear, apparel or sporting equipment, such as, for example, an upper or a sole for an article of footwear, a waistband or arm or hood of an article of apparel, a brim of a hat, a portion of a backpack, or a panel of a soccer ball, and the like. The optical stack can be disposed on the surface directly or indirectly so that the optical stack is parallel or substantially parallel the surface (e.g., the plane of the optical stack is parallel the plane of the surface of the article) (also referred to as “in-line”, or “in-line” configuration) or so that the optical stack is perpendicular or substantially perpendicular the surface (also referred to as the optical stack laying “on its side”, or “on its side” configuration). The optical stack that is on the opposite side from the surface of the article and optionally on the other exposed sides of the article where visible light can contact.

The optical stack can be disposed (e.g., affixed, attached, adhered, bonded, joined) on a surface of one or more components of the footwear, such as on the shoe upper and/or the sole. The optical stack can be incorporated into the sole by incorporating it into a cushioning element such as a bladder or a foam. The sole and/or upper can be designed so that one or more portions of the optical stack are visible in the finished article, by including an opening, or a transparent component covering the optical stack, and the like.

The present disclosure provides for an article comprising: a first optical stack of optical layers, a second optical stack of optical layers, and a first abrasion release layer between the first optical stack and the second optical stack, wherein the first optical stack is positioned adjacent an article surface, wherein the first optical stack is positioned relatively closer to the article surface than the second optical stack, wherein the first optical stack has a first side and a second side opposite the first side, wherein the first side of the first optical stack is adjacent the article surface, wherein the first abrasion release layer has a first side disposed on the second side of the first optical stack, wherein the first abrasion release layer has a second side opposite the first side that is adjacent a first side of the second optical stack, wherein the second optical stack has a second side opposite the first side, wherein the second side of the second optical stack is externally facing; wherein the first optical stack imparts a first structural color, wherein the second optical stack imparts a second structural color, wherein the first abrasion release layer imparts a third color, wherein the first structural color and the second structural color are different in a hue, a value, a chroma, or any combination thereof when viewed from the same angle of observation from some with 20 20 visual acuity from a distance of about 1 meter from the article.

In an aspect, the first abrasion release layer is disposed over a first area of the first optical stack, wherein the first area of the first optical stack is not visible to the observer with 20 20 visual acuity from a distance of about 1 meter from the article; wherein in a second area of the optical stack the first abrasion release layer has been removed from the first optical stack and the second area of the first optical stack imparts the first structural color so that the second area of the first optical stack is visible to someone with 20 20 visual acuity from a distance of about 1 meter from the article, optionally, wherein in a third area, the first optical stack, the second optical stack, and the first abrasion release layer have been removed so the surface of the article is visible to the observer with 20 20 visual acuity from a distance of about 1 meter from the article.

In an aspect, the first abrasion release layer has the characteristic that application of a first abrasive force to a first area of the second optical stack, the second optical stack in the first area is removed; wherein the first abrasion release layer remains disposed on a first area of the first optical stack, wherein the first area of the optical stack is positioned directly underneath the first area of the second optical stack.

In an aspect, the first abrasion release layer is disposed over a first area of the first optical stack where the second optical stack is not disposed on the first area of the first optical stack, wherein the first area of the first optical stack is not visible to the observer with 20 20 visual acuity from a distance of about 1 meter from the article; optionally wherein the first abrasion release layer has the characteristic that application of a second abrasive force to the first area of the first optical stack, the first abrasion release layer in the first area of the first optical stack is removed so that the first optical stack is visible to someone with 20 20 visual acuity from a distance of about 1 meter from the article.

In an aspect, the first abrasive force is sufficient to break the bonds between the first abrasion release layer and the second optical stack but less than the an abrasive force sufficient to break the bonds between or among optical layers of the first optical stack or sufficient to break the bonds between the first optical stack and the first abrasion release layer or sufficient to break the bonds between the first optical stack and the article surface, or a combination of these.

In an aspect, the second abrasive force is sufficient to break the bonds between the first abrasion release layer and the first optical stack but less than an abrasive force sufficient to break the bonds between or among optical layers of the first optical stack or sufficient to break the bonds between the first optical stack and the article surface, or a combination of these.

In an aspect, a third second abrasive force is sufficient to break the bonds between the second optical stack, first abrasion release layer and the first optical stack to remove each of the second optical stack, first abrasion release layer and the first optical stack from the article surface.

The present disclosure also provides for methods of making an article, comprising: disposing, applying or positioning a first stack onto the surface of a substrate (optionally disposing, applying or positioning, a second abrasion release layer on the substrate prior to disposing, applying or positioning a first stack onto the surface of a substrate); disposing, applying or positioning a second stack on first stack (optionally disposing, applying or positioning first release layer on the first stack and then disposing, applying or positioning the second stack on the first release layer on the first stack); disposing, applying or positioning a release layer on the second stack, wherein the first stack imparts a first structural color and the second stack imparts a second structural color, wherein a hue, a value, a chroma, or any combination thereof of the first structural color and the second structural color are different when viewed from the same angle of observation from someone with 20 20 visual acuity from a distance of about 1 meter from the article, wherein the release layer impart a first color.

The present disclosure will be better understood upon reading the following numbered aspects, which should not be confused with the claims. Any of the numbered aspects below can, in some instances, can be combined with aspects described elsewhere in this disclosure and such combinations are intended to form part of the disclosure.

Aspect 1. An article, comprising:

a first optical stack of optical layers, a second optical stack of optical layers, and a first abrasion release layer between the first optical stack and the second optical stack, wherein the first optical stack is positioned adjacent an article surface, wherein the first optical stack is positioned relatively closer to the article surface than the second optical stack,

wherein the first optical stack has a first side and a second side opposite the first side, wherein the first side of the first optical stack is adjacent the article surface, wherein the first abrasion release layer has a first side disposed on the second side of the first optical stack, wherein the first abrasion release layer has a second side opposite the first side that is adjacent a first side of the second optical stack, wherein the second optical stack has a second side opposite the first side, wherein the second side of the second optical stack is externally facing;

wherein the first optical stack imparts a first structural color, wherein the second optical stack imparts a second structural color, wherein the first abrasion release layer imparts a third color, wherein the first structural color and the second structural color are different in a hue, a value, a chroma, or any combination thereof when viewed from the same angle of observation from some with 20 20 visual acuity from a distance of about 1 meter from the article.

Aspect 2. The article of aspect 1, wherein the first abrasion release layer is disposed over a first area of the first optical stack, wherein the first area of the first optical stack is not visible to the observer with 20 20 visual acuity from a distance of about 1 meter from the article; wherein in a second area of the optical stack the first abrasion release layer has been removed from the first optical stack and the second area of the first optical stack imparts the first structural color so that the second area of the first optical stack is visible to someone with 20 20 visual acuity from a distance of about 1 meter from the article, optionally, wherein in a third area, the first optical stack, the second optical stack, and the first abrasion release layer have been removed so the surface of the article is visible to the observer with 20 20 visual acuity from a distance of about 1 meter from the article.
Aspect 3. The article of aspects 1 to 2, wherein the first abrasion release layer has the characteristic that application of a first abrasive force to a first area of the second optical stack, the second optical stack in the first area is removed; wherein the first abrasion release layer remains disposed on a first area of the first optical stack, wherein the first area of the optical stack is positioned directly underneath the first area of the second optical stack.
Aspect 4. The article of aspects 1 or 2, wherein the first abrasion release layer is disposed over a first area of the first optical stack where the second optical stack is not disposed on the first area of the first optical stack, wherein the first area of the first optical stack is not visible to the observer with 20 20 visual acuity from a distance of about 1 meter from the article; optionally wherein the first abrasion release layer has the characteristic that application of a second abrasive force to the first area of the first optical stack, the first abrasion release layer in the first area of the first optical stack is removed so that the first optical stack is visible to someone with 20 20 visual acuity from a distance of about 1 meter from the article.
Aspect 5. The article of any one of aspects 1-4, wherein the first abrasive force is sufficient to break the bonds between the first abrasion release layer and the second optical stack but less than the an abrasive force sufficient to break the bonds between or among optical layers of the first optical stack or sufficient to break the bonds between the first optical stack and the first abrasion release layer or sufficient to break the bonds between the first optical stack and the article surface, or a combination of these.
Aspect 6. The article of any one of aspects 1-4, wherein the second abrasive force is sufficient to break the bonds between the first abrasion release layer and the first optical stack but less than an abrasive force sufficient to break the bonds between or among optical layers of the first optical stack or sufficient to break the bonds between the first optical stack and the article surface, or a combination of these.
Aspect 7. The article of any one of aspects 1-4, wherein a third abrasive force is sufficient to break the bonds between the second optical stack, first abrasion release layer and the first optical stack to remove each of the second optical stack, first abrasion release layer and the first optical stack from the article surface.
Aspect 8. The article of any preceding aspect, wherein the first abrasion release layer is opaque.
Aspect 9. The article of any preceding aspect, wherein the first abrasion release layer is about 10 to 200 nanometers thick.
Aspect 10. The article of any preceding aspect, wherein the first abrasion release layer does not impart structural color, optionally wherein the first abrasion release layer includes colorants, optionally the colorants are pigments, dyes, or both.
Aspect 11. The article of any preceding aspect, wherein the first abrasion release layer includes a polymeric material or a composite material.
Aspect 12. The article of any preceding aspect, wherein the polymeric material comprises one or more thermoplastic polymers, or one or more cross-linked polymers, optionally the polymeric material is an adhesive composition, optionally the adhesive composition is a temperature-sensitive adhesive (optionally a hot melt adhesive), or a thermally-cured adhesive or light-cured adhesive.
Aspect 13. The article of any preceding aspect, wherein the first abrasion release layer comprises or consists essentially of a material that is different than the material of the first optical stack and the second optical stack, optionally wherein the first abrasion release layer is comprises or consists of a polymeric composition and where the first optical stack and second optical stack, independently, consists of metal or metal oxides or both.
Aspect 14. The article of any preceding aspect, wherein the first abrasion release layer is a film, optionally wherein the film is applied to the first optical stack using heat, pressure, or both; or wherein the first abrasion release layer is a coating, optionally wherein the material comprising the abrasion release layer is applied by spraying, brushing, printing, or applied by dipping to form the coating.
Aspect 15. The article of any preceding aspect, wherein the second side of the first optical stack is disposed on a first side of a substrate, wherein the substrate includes a second side opposite the first side, optionally, wherein the second side of the substrate is disposed on the article surface; or wherein the second side of the first optical stack is disposed directly on the article surface.
Aspect 16. The article of any preceding aspect, wherein the imparted second structural color is attributed to the layers of the second stack and not first abrasion release layer and the first stack; or wherein the imparted second structural color is attributed to the layers of the second stack in combination with the first abrasion release layer.
Aspect 17. The article of any preceding aspect, wherein the first stack has a base unit height of about 10 to about 200 nanometers, wherein the second stack has a base unit height of about 10 to about 200 nanometers, optionally wherein second stack and the first stack have an area of about 1 micrometer squared to 100 centimeters squared, a width of about 1 micrometer to 500 centimeters, about length of about 1 micrometer to 500 centimeters, or radius of about 1 micrometer to 500 centimeters.
Aspect 18. The article of aspect 1, further comprising a second abrasion release layer disposed between the first side of the optical stack and the article surface; optionally wherein a fourth abrasive force is sufficient to break the bonds between the second optical stack, first abrasion release layer and the first optical stack to remove each of the second optical stack, first abrasion release layer and the first optical stack from the second abrasion release layer on the article surface.
Aspect 19. A method of making an article, comprising: disposing the optical stack of any one of aspects 1 to 18 onto the surface of the article.
Aspect 20. An article comprising: a product of the method of aspect 19.
Aspect 21. A method of making an article, comprising:
disposing, applying or positioning a first stack onto the surface of a substrate (optionally disposing, applying or positioning, a second abrasion release layer on the substrate prior to disposing, applying or positioning a first stack onto the surface of a substrate);
disposing, applying or positioning a second stack on first stack (optionally disposing, applying or positioning first release layer on the first stack and then disposing, applying or positioning the second stack on the first release layer on the first stack);
optionally disposing, applying or positioning a third abrasion release layer on the second stack,
optionally disposing, applying or positioning a fourth abrasion release layer on the surface of the article,
wherein the first stack imparts a first structural color and the second stack imparts a second structural color, wherein a hue, a value, a chroma, or any combination thereof of the first structural color and the second structural color are different when viewed from the same angle of observation from someone with 20 20 visual acuity from a distance of about 1 meter from the article, wherein the release layer impart a first color.
   Aspect 22. The method of aspect 36, wherein the first stack and the second stack are described in the independent article aspects 1-18.
   Aspect 23. An article comprising: a product of the method of any one of aspects 21 to 22.
   Aspect 24. The article of any one of the preceding aspects, wherein the first stack and the second stack are independently selected from a single layer reflector, a single layer filter, a multilayer reflector or a multilayer filter.
   Aspect 25. The article of any one of the preceding aspects, wherein the first stack and the second stack independently include at least one layer, optionally wherein the at least one layer includes at least one constituent layer, optionally wherein the at least one layer includes at least one reflective layer, optionally wherein the at least one layer includes at least one constituent layer and at least one reflective layer.
   Aspect 26. The article of any one of the preceding aspects, wherein the first stack and the second stack are independently selected from an inorganic optical stack, an organic optical stack, or a mixed inorganic/organic optical stack.
   Aspect 27. The article of any one of the preceding aspects, wherein the organic optical stack has at least one layer that is made of an organic material, optionally wherein the at least one layer is made of a non-metal or non-metal oxide or non-alloy material, optionally, wherein at least one layer is made of a polymeric material (optionally a synthetic polymeric material), optionally wherein the at least one layer is made an organic material that does not include a metal or metal oxide or alloy, optionally wherein the at least one layer is made of a polymeric (optionally a synthetic polymeric material) that does not include a metal or metal oxide or alloy, optionally wherein at least one layer is made of stainless steel.
   Aspect 28. The article of any one of the preceding aspects, wherein the first stack and the second stack independently have 1 to 20 layer, 2 to 20 layers, 3, to 20 layers, 4 to 20 layers, 5 to 20 layers, 1 to 10 layers, 2 to 10 layers, 3 to 10 layers, 4 to 10 layers, or 5 to 10 layers, or wherein the first stack and the second stack independently include 2-6 layers, 3 to 6 layers, or optionally 3-5 layers.
   Aspect 29. The article of any one of the preceding aspects, wherein each of the layers have different refractive indices.
   Aspect 30. The article of any one of the preceding aspects, each layer has a thickness of at least 10 nanometers (optionally at least 30 nanometers, optionally at least 40 nanometers, optionally at least 50 nanometers, optionally at least 60 nanometers, optionally a thickness of from about 10 nanometers to about 100 nanometers, about 10 nanometers to about 50 nanometers, about 10 nanometers to about 40 nanometers or of from about 30 nanometers to about 80 nanometers, or from about 40 nanometers to about 60 nanometers), or optionally, each layer has a thickness of about one quarter of the wavelength of the wavelength to be reflected.
   Aspect 31. The article of any of the preceding aspects, wherein the first optical stack and the second optical stack, independently has a thickness of 10 to about 50 nanometers, about 10 to about 100 nanometers, 20 to about 200 nanometers, about 20 to about 700 nanometers, or of about 20 to about 500 nanometers.
   Aspect 32. The article of any one of the preceding aspects, wherein the at least one layers is made of a material selected from a metal or a metal oxide or an alloy.
   Aspect 33. The article of any one of the aspects, wherein the at least one layer is made of a metal.
   Aspect 34. The article of any one of the preceding aspects, wherein the metal is selected from the group consisting of: titanium, aluminum, silver, zirconium, chromium, magnesium, silicon, gold, platinum, and a combination thereof.
   Aspect 35. The article of any one of the preceding aspects, wherein at least one of the constituent layers comprises a metal selected from the group consisting of: titanium, aluminum, silver, zirconium, chromium, magnesium, silicon, gold, platinum, niobium, an oxide of any of these, and a combination thereof.
   Aspect 36. The article of any one of the preceding aspects, wherein at least one of the constituent layers is made of a material selected from the group consisting of: silicon dioxide, titanium dioxide, zinc sulphide, magnesium fluoride, tantalum pentoxide, and a combination thereof.
   Aspect 37. The methods and/or articles of any one of the aspects, wherein the second optical stack is on and visible from an outside surface of the article.
   Aspect 38. The methods and/or articles of any one of the preceding aspects, wherein the surface of the article, or the substrate, or both are comprises or consists of a material is selected from: thermoplastic polymer, thermoset polymer, or elastomeric polymer.
   Aspect 39. The methods and/or articles of any one of the preceding aspects, wherein the thermoplastic material includes one or more thermoplastic polyurethanes, thermoplastic polyethers, thermoplastic polyesters, thermoplastic polyamides, thermoplastic polyolefins, thermoplastic co-polymers thereof, or a combination thereof.
   Aspect 40. The methods and/or articles of any one of the preceding aspects, wherein the at least one constituent layer further comprises a textured surface, and the textured surface and the optical stack imparts the first structural color and the second structural color.
   Aspect 41. The methods and/or articles of any one of the preceding aspects, wherein the surface of the article is a textured surface, wherein the at least one constituent layer is on the textured surface, and the textured surface of the substrate and the optical stack imparts the first structural color and the second structural color.
   Aspect 42. The methods and/or articles of any one of the preceding aspects, wherein the textured surface includes a plurality of profile features and flat planar areas, wherein the profile features extend above the flat areas of the textured surface, optionally wherein the dimensions of the profile features, a shape of the profile features, a spacing among the plurality of the profile features, in combination with the optical stack create the first structural color and/or the second structural color, optionally wherein the profile features are in random positions relative to one another for a specific area, optionally wherein the spacing among the profile features is set to reduce distortion effects of the profile features from interfering with one another in regard to the first structural color and/or the second structural color of the article, optionally wherein the profile features and the flat areas result in at least one layer of the optical stack having an undulating topography across the textured surface, wherein there is a planar region between neighboring profile features that is planar with the flat planar areas of the textured surface, wherein the planar region has dimensions relative to the profile features to impart the first structural color and/or the second structural color optionally wherein the profile features and the flat areas result in each layer of the optical stack having an undulating topography across the textured surface.
   Aspect 43. The article and/or method of any of the preceding aspects, wherein the height of the profile feature is about 50 micrometers to 250 micrometers, optionally wherein at least one of the length and width of the profile feature is less than 250 micrometers or both the length and the width of the profile feature is less than 250 micrometers.
   Aspect 44. The article and/or method of any of the preceding aspects, wherein at least one of the dimensions of the profile feature is in the nanometer range, while at least one other dimension is in the micrometer range.
   Aspect 45. The article and/or method of any of the preceding aspects, wherein the nanometer range is about 10 nanometers to about 1000 nanometers, while the micrometer range is about 5 micrometers to 250 micrometers.
   Aspect 46. The article and/or method of any of the preceding aspects, wherein at least one of the length and width of the profile feature is in the nanometer range, while the other of the length and the width of the profile feature is in the micrometer range.
   Aspect 47. The article and/or method of any of the preceding aspects, wherein at least one of the length and width of the profile feature is in the nanometer range and the other in the micrometer range, where the height is about 250 nanometers to 250 micrometers.
   Aspect 48. The article and/or method of any of the preceding aspects, wherein spatial orientation of the profile features is periodic.
   Aspect 49. The article and/or method of any of the preceding aspects, wherein spatial orientation of the profile features is a semi-random pattern or a set pattern.
   Aspect 50. The article and/or method of any of the preceding aspects, wherein the surface of the layers of the optical stack are a substantially three-dimensional flat planar surface or a three dimensional flat planar surface.
   Aspect 51. The methods and/or articles of any one of the preceding aspects, wherein the first structural color, the second structural color, or both exhibits a single hue or multiple different hues when viewed from different viewing angles at least 15 degrees apart.
   Aspect 52. The methods and/or articles of any one of the preceding aspects, wherein the article is a fiber.
   Aspect 53. The methods and/or articles of any one of the preceding aspects, wherein the article is a yarn.
   Aspect 54 The methods and/or articles of any one of the preceding aspects, wherein the article is a monofilament yarn.
   Aspect 55. The methods and/or articles of any one of the preceding aspects, wherein the article is a textile.
   Aspect 56. The methods and/or articles of any one of the preceding aspects, wherein the article is a knit textile.
   Aspect 57. The methods and/or articles of any one of the preceding aspects, wherein the article is a non-woven textile.
   Aspect 58. The methods and/or articles of any one of the preceding aspects, wherein the article is a synthetic leather.
   Aspect 59. The methods and/or articles of any one of the preceding aspects, wherein the article is a film.
   Aspect 60. The methods and/or articles of any one of the preceding aspects, wherein the article is an article of footwear, a component of footwear, an article of apparel, a component of apparel, an article of sporting equipment, or a component of sporting equipment.
   Aspect 61. The methods and/or articles of any one of the preceding aspects, wherein the article is an article of footwear.
   Aspect 62. The methods and/or articles of any one of the preceding aspects, wherein the article is a sole component of an article of footwear.
   Aspect 63. The methods and/or articles of any one of the preceding aspects, wherein the article is foam midsole component of an article of footwear.
   Aspect 64. The methods and/or articles of any one of the preceding aspects, wherein the article is an upper component of an article of footwear.
   Aspect 65. The methods and/or articles of any one of the preceding aspects, wherein the article is a knit upper component of an article of footwear.
   Aspect 66. The methods and/or articles of any one of the preceding aspects, wherein the article is a non-woven synthetic leather upper for an article of footwear.
   Aspect 67. The methods and/or articles of any one of the preceding aspects, wherein the article is a bladder including a volume of a fluid, wherein the bladder has a first bladder wall having a first bladder wall thickness, wherein the first bladder wall has a gas transmission rate of 15 cm³/m²·atm·day or less for nitrogen for an average wall thickness of 20 mils.
   Aspect 68. The methods and/or articles of any one of the preceding aspects, wherein the article is a bladder, and the optical stack is optionally on an inside surface of the bladder or optionally the optical stack is on an outside surface of the bladder.
   Aspect 70. The methods and/or articles of any preceding aspect, wherein the first structural color, the second structural color, or both is iridescent.
   Aspect 71. The methods and/or articles of any preceding aspect, wherein the first structural color, the second structural color, or both has limited iridescence.
   Aspect 72. The methods and/or articles of any preceding aspect, wherein the first structural color, the second structural color, or both has limited iridescence such that, when each color is visible at each possible angle of observation is, independently, assigned to a single hue selected from the group consisting of the primary, secondary and tertiary colors on the red yellow blue (RYB) color wheel, all of the assigned hues fall into a single hue group, wherein the single hue group is one of a) green-yellow, yellow, and yellow-orange; b) yellow, yellow-orange and orange; c) yellow-orange, orange, and orange-red; d) orange-red, and red-purple; e) red, red-purple, and purple; f) red-purple, purple, and purple-blue; g) purple, purple-blue, and blue; h) purple-blue, blue, and blue-green; i) blue, blue-green and green; and j) blue-green, green, and green-yellow.
   Aspect 73. The methods and/or articles of any preceding aspect, wherein the first structural color, the second structural color, or both is a chromatic color.
   Aspect 74. The methods and/or articles of any preceding aspect, wherein one of the first structural color and the second structural color is an achromatic color.
   Aspect 75. The methods and/or articles of any preceding aspect, wherein the chromatic color is a red/yellow/blue (RYB) primary color, a RYB secondary color, a RYB tertiary color, a RYB quaternary color, a RYB quinary color, or a chromatic color that is a combination thereof
   Aspect 76. The methods and/or articles of any preceding aspect, wherein the chromatic color is cyan, blue, indigo, violet, or a chromatic color that is a combination thereof.
   Aspect 77. The methods and/or articles of any preceding aspect, wherein the achromatic color is selected from black, white, or neutral gray.
   Aspect 78. The methods and/or articles of any preceding aspect, wherein the chromatic color is red, yellow, blue, green, orange, purple, or a chromatic color that is a combination thereof.
   Aspect 79. The methods and/or articles of any preceding aspect, wherein the chromatic color is red, orange, yellow, green, blue, indigo, violet, or a chromatic color that is a combination thereof.
   Aspect 80. The article of any one of the preceding aspects, wherein a layer of the optical stack further comprises a textured surface.
   Aspect 81. The article of aspect 80, wherein a layer of the optical stack (e.g., first optical stack, second optical stack, or independently both the first optical stack and the second optical stack) further comprises a textured surface, wherein the optical stack is on the textured surface, and a hue of the structural color (e.g., first structural color and second structural color respectively), an intensity of the first structural color, a viewing angle at which the structural color is visible, or any combination thereof, is altered by the textured surface, as determined by comparing the optical stack comprising the textured surface of a substantially identical optical stack which is free of the textured surface.
   Aspect 82. The article of aspect 80, wherein a layer of the optical stack (e.g., first optical stack, second optical stack, or independently both the first optical stack and the second optical stack) further comprises a textured surface, wherein the optical stack is on the textured surface, wherein the textured surface reduces or eliminates shift of the structural color (e.g., first structural color and second structural color respectively) as a viewing angle is varied from a first viewing angle to a second viewing angle, as compared to a substantially identical optical stack which is free of the textured surface.
   Aspect 83. The article of aspect 80, wherein a layer of the optical stack (e.g., first optical stack, second optical stack, or independently both the first optical stack and the second optical stack) further comprises a textured surface, wherein the optical stack is on the textured surface, and a hue of the structural color (e.g., first structural color and second structural color respectively), an intensity of the structural color, a viewing angle at which the structural color is visible, or any combination thereof, is unaffected by or substantially unaffected by the textured surface, as determined by comparing the optical stack comprising the textured surface to a substantially identical optical stack which is free of the textured surface.
   Aspect 84. The article of aspect 80, wherein a layer of the optical stack (e.g., first optical stack, second optical stack, or independently both the first optical stack and the second optical stack) further comprises a textured surface, or wherein the optical stack is on a textured surface; and wherein shift of the structural color (e.g., first structural color and second structural color respectively) is unaltered by or substantially the same as a viewing angle is varied from a first viewing angle to a second viewing angle, as compared to a substantially identical optical stack which is free of the textured surface or which is not on the textured surface.
   Aspect 85. The article of any one of the preceding aspects, wherein the surface of the article or the substrate is a textured surface, wherein the optical stack (e.g., first optical stack, second optical stack, or independently both the first optical stack and the second optical stack) is on the textured surface.
   Aspect 86. The article of aspect 85, wherein the surface of the article is a textured surface, wherein the optical stack (e.g., first optical stack, second optical stack, or independently both the first optical stack and the second optical stack) is on the textured surface, and a hue of the structural color (e.g., first structural color and second structural color respectively), an intensity of the structural color, a viewing angle at which the structural color is visible, or any combination thereof, is altered by the textured surface, as determined by comparing the optical stack comprising the textured surface of a substantially identical optical stack on a surface of a substantially identical article which is free of the textured surface.
   Aspect 87. The article of aspect 85, wherein the surface of the article is a textured surface, wherein the optical stack (e.g., first optical stack, second optical stack, or independently both the first optical stack and the second optical stack) is on the textured surface, wherein the textured surface reduces or eliminates shift of the structural color (e.g., first structural color and second structural color respectively) as a viewing angle is varied from a first viewing angle to a second viewing angle, as compared to a substantially identical optical stack on a surface of a substantially identical article which is free of the textured surface.
   Aspect 88. The article of aspect 85, wherein the surface of the article is a textured surface, wherein the optical stack (e.g., first optical stack, second optical stack, or independently both the first optical stack and the second optical stack) is on the textured surface, and a hue of the structural color (e.g., first structural color and second structural color respectively), an intensity of the structural color, a viewing angle at which the structural color is visible, or any combination thereof, is unaffected by or substantially unaffected by the textured surface, as determined by comparing the optical stack comprising the textured surface to a substantially identical optical stack on a surface of a substantially identical article which is free of the textured surface.
   Aspect 89. The article of aspect 85, wherein the surface of the article is a textured surface, wherein the optical stack (e.g., first optical stack, second optical stack, or independently both the first optical stack and the second optical stack) is on the textured surface, wherein shift of the structural color (e.g., first structural color and second structural color respectively) is unaltered by or substantially the same as a viewing angle is varied from a first viewing angle to a second viewing angle, as compared to a substantially identical optical stack on a surface of a substantially identical article which is free of the textured surface.
   Aspect 90. The article of any one of the preceding aspects, wherein the textured surface includes a plurality of profile features and flat planar areas, wherein the profile features extend above the flat areas of the textured surface.
   Aspect 91. The article aspect 85, wherein dimensions of the profile features, a shape of the profile features, a spacing among the plurality of the profile features, or any combination thereof, in combination with the optical stack (e.g., first optical stack, second optical stack, or independently both the first optical stack and the second optical stack), affect a hue of the structural color (e.g., first structural color and second structural color respectively), an intensity of the structural color, a viewing angle at which the structural color is visible, or any combination thereof.
   Aspect 92. The article aspect 85, wherein dimensions of the profile features, a shape of the profile features, a spacing among the plurality of the profile features, or any combination thereof, in combination with the optical stack (e.g., first optical stack, second optical stack, or independently both the first optical stack and the second optical stack), affect a hue of the structural color (e.g., first structural color and second structural color respectively), an intensity of the structural color, a viewing angle at which the structural color is visible, shift of the structural color.
   Aspect 93. The article of aspect 85, wherein a hue of the structural color (e.g., first structural color and second structural color respectively), an intensity of the structural color, a viewing angle at which the structural color is visible, or any combination thereof, are unaffected or substantially unaffected by dimensions of the profile features, a shape of the profile features, a spacing among the plurality of the profile features, or any combination thereof, of the textured surface.
   Aspect 94. The article of aspect 85, wherein the profile features of the textured surface are in random positions relative to one another within a specific area and/or wherein spacing among the profile features is random within a specific area.
   Aspect 95. The article of aspect 94, wherein spacing between the profile features, in combination with the optical stack (e.g., first optical stack, second optical stack, or independently both the first optical stack and the second optical stack), affects a hue of the structural color (e.g., first structural color and second structural color respectively), an intensity of the structural color, a viewing angle at which the structural color is visible, or any combination thereof.
   Aspect 96. The article of aspect 94, wherein a hue of the structural color (e.g., first structural color and second structural color respectively), an intensity of the structural color, a viewing angle at which the structural color is visible, or any combination thereof, is unaffected by, or substantially unaffected by, spacing between the profile features in combination with the optical stack (e.g., first optical stack, second optical stack, or independently both the first optical stack and the second optical stack).
   Aspect 97. The article of any one of the preceding aspects, wherein the profile features and the flat areas result in at least one layer of the optical stack (e.g., first optical stack, second optical stack, or independently both the first optical stack and the second optical stack) having an undulating topography across the textured surface, and wherein there is a planar region between neighboring profile features that is planar with the flat planar areas of the textured surface.
   Aspect 98. The article of aspect 97, wherein dimensions of the planar region relative to the profile features affect a hue of the structural color (e.g., first structural color and second structural color respectively), an intensity of the structural color, a viewing angle at which the structural color is visible, or any combination thereof.
   Aspect 99. The article of aspect 97, wherein a hue of the structural color (e.g., first structural color and second structural color respectively), an intensity of the structural color, a viewing angle at which the structural color is visible, shift of the structural color as a viewing angle is varied from a first viewing angle to a second viewing angle, or any combination thereof, is unaffected by or substantially unaffected by dimensions of the planar region relative to the profile features.
   Aspect 100. The article of any one of the preceding aspects, wherein the profile features and the flat areas result in each layer of the optical stack (e.g., first optical stack, second optical stack, or independently both the first optical stack and the second optical stack) having an undulating topography across the textured surface.
   Aspect 101. The article of aspect 100, wherein the undulating topography of the optical stack affects a hue of the structural color (e.g., first structural color and second structural color respectively), an intensity of the structural color, a viewing angle at which the structural color is visible, or any combination thereof.
   Aspect 102. The article of aspect 100, wherein a hue of the structural color (e.g., first structural color and second structural color respectively), an intensity of the structural color, a viewing angle at which the structural color is visible, or any combination thereof, is unaffected by or substantially unaffected by the undulating topography of the optical stack (e.g., first optical stack, second optical stack, or independently both the first optical stack and the second optical stack).

Now having described embodiments of the present disclosure generally, additional discussion regarding embodiments will be described in greater details.

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of material science, chemistry, textiles, polymer chemistry, and the like, which are within the skill of the art. Such techniques are explained fully in the literature.

Unless otherwise defined, all technical and scientific terms used herein have the same meaning as commonly understood by one of ordinary skill in the art of material science, chemistry, textiles, polymer chemistry, and the like. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

An article can include one or more colors (e.g., structural color or non-structural color) in different areas. The color in an area including the optical stacks can change upon use of the article due to abrasive forces applied to areas of the article. In addition or alternatively, the color in an area including the optical stacks can change based upon intentional or unintentional application of abrasive forces to areas of the article. The amount of abrasive force can vary upon the desired outcome, areas of article, and the like, where in some instances very little abrasive force is needed and in other instances the abrasive force is great, so the article can be designed to achieve the desired outcome. The article includes optical stacks having an abrasion release layer disposed therebetween, where the optical stacks can be incorporated, indirectly via a substrate or direction onto the surface of the article, onto one or more components of an article (e.g., on an upper or sole of an article of footwear). The present disclosure provides for articles that exhibit structural colors through the use of the optical stacks upon exposure to visible light. The optical stacks are disposed on a substrate and when certain parts of the optical stack are exposed to visible light, the optical stack imparts a structural color that can be viewed by someone with 20 20 visual acuity from a distance of about 1 meter from the article. The structural color is visible color produced, at least in part, through optical effects (e.g., through scattering, refraction, reflection, interference, and/or diffraction of visible wavelengths of light). Upon subjecting the optical stacks to abrasive forces, one of the optical stacks is removed, which can alter the appearance (e.g., structural color and/or non-structural color of areas) of the article. In this way, an article may have a certain appearance when new, but can change upon application of abrasive forces (e.g., through use and/or intentionally).

As described above, an abrasion release layer is disposed between a pair of optical stacks (e.g., a first optical stack and a second optical stack) or between the substrate and an optical stack, or a combination thereof. In an aspect, multiple abrasion release layers can be used, for example a first abrasion release layer between the article surface and a first optical stack and a second abrasion release layer can be between the first optical stack and a second optical stack. When more than one abrasion release layer is used, each release layer requires a different amount of abrasive force to remove. For example, when the structure is the following: article surface/first release layer/first optical stack/second release layer/second optical stack, the abrasive force required to remove the second release layer is less than the abrasive force need to remove the first release layer. In other words, the strength of the abrasion release layer is weakest closer to the exterior surface (stronger closer to the substrate surface) so that the release layers and/or optical stack(s) can come off at different times to reveal what is under it as opposed to removing the entire optical stack at once, albeit the abrasive force may be strong enough to do that. In an aspect, a design goal may be that the release layer and/or optical stack come off one at a time so the appearance can change multiple times for the same area. This approach can be beneficial from a design perspective and advantageous for diversity of product appearance.

While a few configurations are provided herein, other configurations are envisioned and within the scope of the present disclosure.

In the various embodiments provided herein, the abrasive force (e.g., first, second, or third abrasive force) is likely to be applied in an uneven manner across the surface of the optical stacks. The result is that different layers can be removed with the result being different areas of the article will have different colors (e.g., structural and/or non-structural colors). In this way, some areas of the article can retain their original appearance while other areas of the article can different color (e.g., structural color or non-structural color). The result is an article that has an aesthetically pleasing and unique appearance that can change over time as the article is used and subject to various abrasive forces, where the abrasive forces can be caused by normal wear and tear and/or by intentional abrasive forces applied to the optical stack. In addition, the abrasive force needed can vary and be about the abrasive force needed to remove the layer in a scratch-to-win card (e.g., lottery game item), or about the abrasive force encountered when scuffing a portion of an article of footwear on the ground or against another article of footwear, or about the abrasive force required to scratch paint off of a wall, table, chair, or about the abrasive force required to sand a rough area of plastic or wood, or about the abrasive force required to scuff leather (real or synthetic), or about the abrasive force required to scratch skin. Each release layer can be designed to require the appropriate and desired amount abrasive force. In some embodiments, the exact amount of abrasive force may not be important since the variability in the required force will add diversity and character to the article including the optical stack. In addition, the type of article (e.g., article of footwear, article of clothing, article of sports equipment) can guide how much the required force is desired.

In an aspect, the abrasive force is sufficient to break the bonds between the abrasion release layer and the second optical stack but less than the an abrasive force sufficient to break the bonds between or among optical layers of the first optical stack or sufficient to break the bonds between the first optical stack and the abrasion release layer or sufficient to break the bonds between the first optical stack and the article surface, or a combination of these.

In an aspect, the abrasive force is sufficient to break the bonds between the abrasion release layer and the second optical stack and the abrasion release layer and the first optical stack but less than the abrasive force sufficient to break the bonds between or among optical layers of the first optical stack or sufficient to break the bonds between the first optical stack and the article surface, or a combination of these.

In an aspect, the abrasive force is sufficient to break the bonds between the second optical stack, first abrasion release layer and the first optical stack to remove each of the second optical stack, first abrasion release layer and the first optical stack from the article surface

The structural color (e.g., first structural color and the second structural color) imparted by each of the optical stacks can be a single color, multicolor such as iridescent color, based, partly, on the changing angle of observation. The first structural color and the second structural colors as well as the color of the abrasion release layer(s) are different in a hue, a value, a chroma, or any combination thereof when viewed from the same angle of observation from someone with 20 20 visual acuity from a distance of about 1 meter from the article under the same lighting conditions.

The first stack and the second stack, independently of one another, can be a single layer reflector, a single layer filter, a multilayer reflector or a multilayer filter. Generally, the first stack and the second stack of can include one or more layers (e.g., constituent layers, reflective layers). Also as described herein, the optical stacks can optionally include a textured surface, such as a textured layer and/or a textured structure, where the textured surface is of a different dimensional scale and distinguishable from the protrusion(s) and/or indentation(s) provided herein. Optionally, the optical stacks can include one or more layers to provide or give one or more characteristics to the optical stacks (e.g., better wear characteristic, better adhesion characteristic, and the like).

The first stack and the second stack can be disposed on a surface in a variety of ways. For example, the optical stack can be disposed on the surface so that each of the layers of the optical stack are parallel or substantially parallel the surface (e.g., disposed “in line”). In other words, the length and width of the layers of the optical stack define the plane, while the thickness of the layer is the smallest dimension. In another example, each of the layers of the optical stack are perpendicular or substantially perpendicular the surface. In either configuration, the optical stack can produce an aesthetically pleasing appearance.

In one or more embodiments of the present disclosure the surface of the article includes the optical stack (e.g., the first stack disposed on the article surface), and is optionally a textured surface, where the optical stack (e.g., the first optical stack and/or the second optical stack) and optionally the textured surface impart the structural color (e.g., first structural color, the second structural color). The optional textured surface can be disposed between the optical stack and the surface or be part of the optical stack(s), depending upon the design. Additional details are provided herein.

In an aspect, the optical stacks are disposed on a substrate (e.g., a film, textile, and the like) and the substrate is disposed on the article surface. When the optical stacks are disposed on the substrate, the optical stacks include all of the characteristics as described herein.

In an embodiment, the structural color may not be used in combination with a pigment and/or dye, so the structural color is independent of a pigment and/or dye. In another aspect, the structural color can be used in combination with a pigment and/or dye, but the structural color is not the same color, shade, and/or hue as the pigment and/or dye. In this regard, the structural color is the product of the textured surface, the optical stack(s), and/or the pigment and/or dye. In an embodiment, the structural color can be used in combination with a pigment and/or dye to enhance the color of the pigment and/or dye in regard to the color of the pigment and/or dye or enhance a tone, tint, shade, or hue associated with the pigment and/or dye.

The article can be an article of manufacture or a component of the article. The article of manufacture can include footwear, apparel (e.g., shirts, jerseys, pants, shorts, gloves, glasses, socks, hats, caps, jackets, undergarments), containers (e.g., backpacks, bags), and upholstery for furniture (e.g., chairs, couches, car seats), bed coverings (e.g., sheets, blankets), table coverings, towels, flags, tents, sails, and parachutes, or components of any one of these. In addition, the optical stacks can be used with or disposed on textiles or other items such as striking devices (e.g., bats, rackets, sticks, mallets, golf clubs, paddles, etc.), athletic equipment (e.g., golf bags, baseball and football gloves, soccer ball restriction structures), protective equipment (e.g., pads, helmets, guards, visors, masks, goggles, etc.), locomotive equipment (e.g., bicycles, motorcycles, skateboards, cars, trucks, boats, surfboards, skis, snowboards, etc.), balls or pucks for use in various sports, fishing or hunting equipment, furniture, electronic equipment, construction materials, eyewear, timepieces, jewelry, and the like.

The article can be an article of footwear. The article of footwear can be designed for a variety of uses, such as sporting, athletic, military, work-related, recreational, or casual use. Primarily, the article of footwear is intended for outdoor use on unpaved surfaces (in part or in whole), such as on a ground surface including one or more of grass, turf, gravel, sand, dirt, clay, mud, pavement, and the like, whether as an athletic performance surface or as a general outdoor surface. However, the article of footwear may also be desirable for indoor applications, such as indoor sports including dirt playing surfaces for example (e.g., indoor baseball fields with dirt infields).

In particular, the article of footwear can be designed for use in indoor or outdoor sporting activities, such as global football/soccer, golf, American football, rugby, baseball, running, track and field, cycling (e.g., road cycling and mountain biking), and the like. The article of footwear can optionally include traction elements (e.g., lugs, cleats, studs, and spikes as well as tread patterns) to provide traction on soft and slippery surfaces, where components of the present disclosure can be used or applied between or among the traction elements and optionally on the sides of the traction elements but on the surface of the traction element that contacts the ground or surface. Cleats, studs and spikes are commonly included in footwear designed for use in sports such as global football/soccer, golf, American football, rugby, baseball, and the like, which are frequently played on unpaved surfaces. Lugs and/or exaggerated tread patterns are commonly included in footwear including boots design for use under rugged outdoor conditions, such as trail running, hiking, and military use.

In particular, the article can be an article of apparel (i.e., a garment). The article of apparel can be an article of apparel designed for athletic or leisure activities. The article of apparel can be an article of apparel designed to provide protection from the elements (e.g., wind and/or rain), or from impacts.

In particular, the article can be an article of sporting equipment. The article of sporting equipment can be designed for use in indoor or outdoor sporting activities, such as global football/soccer, golf, American football, rugby, baseball, running, track and field, cycling (e.g., road cycling and mountain biking), and the like.

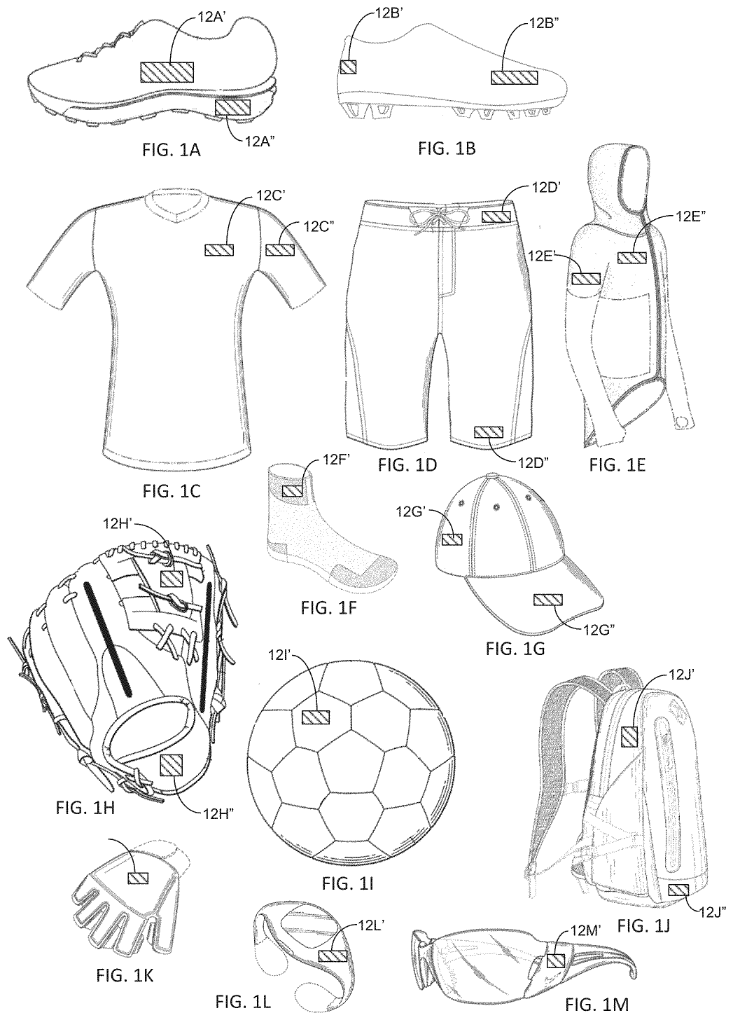

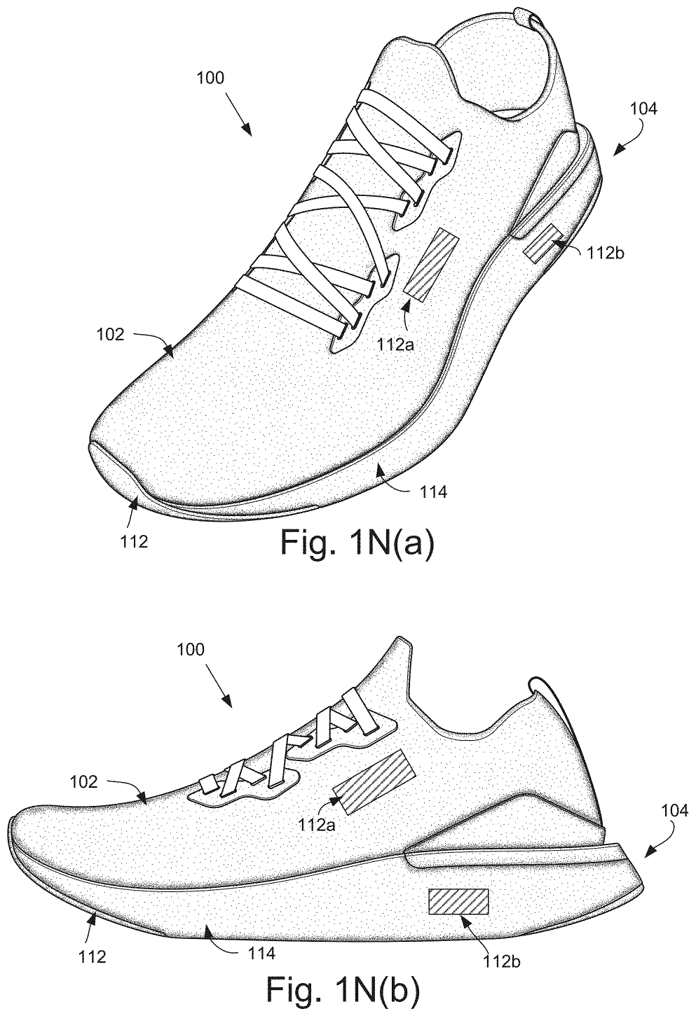

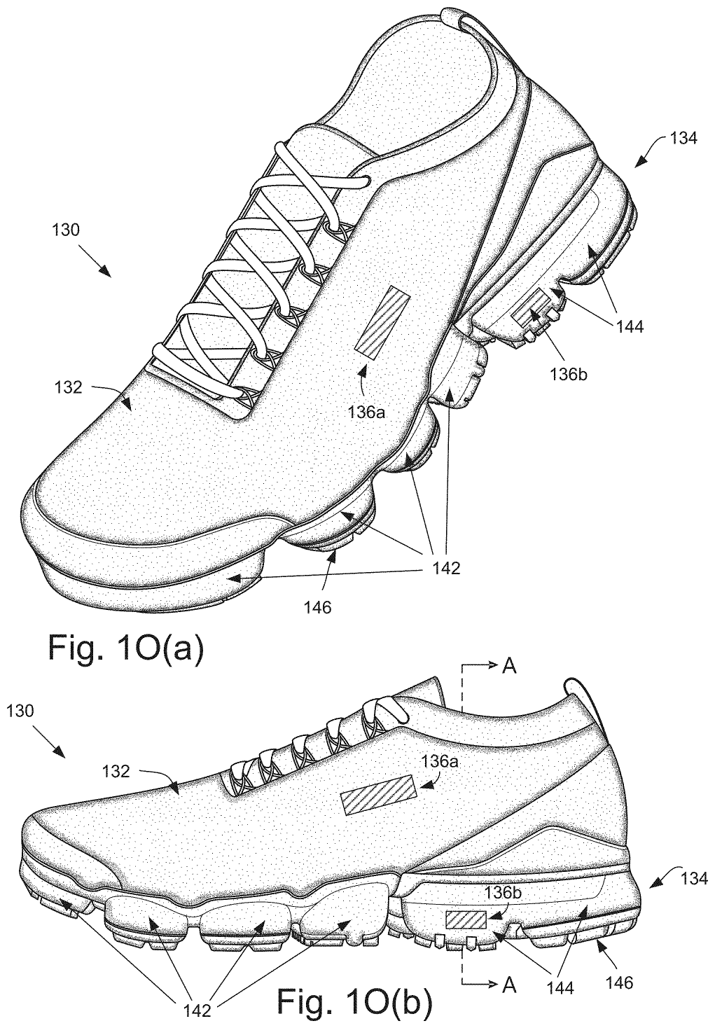

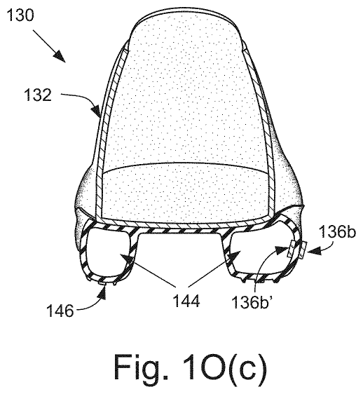

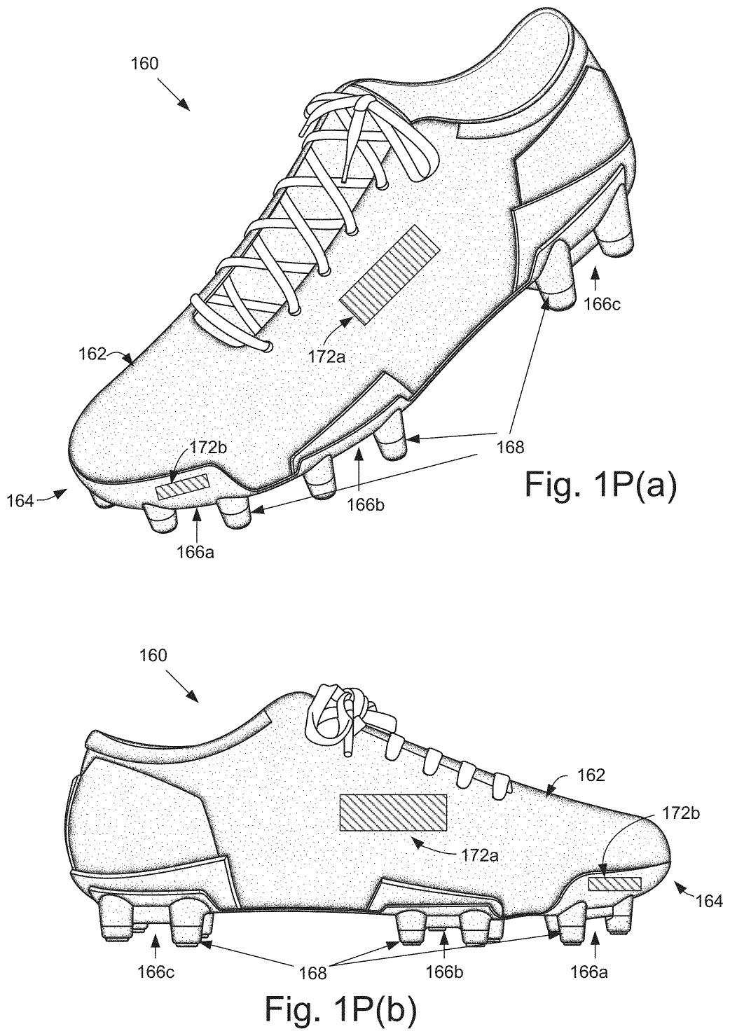

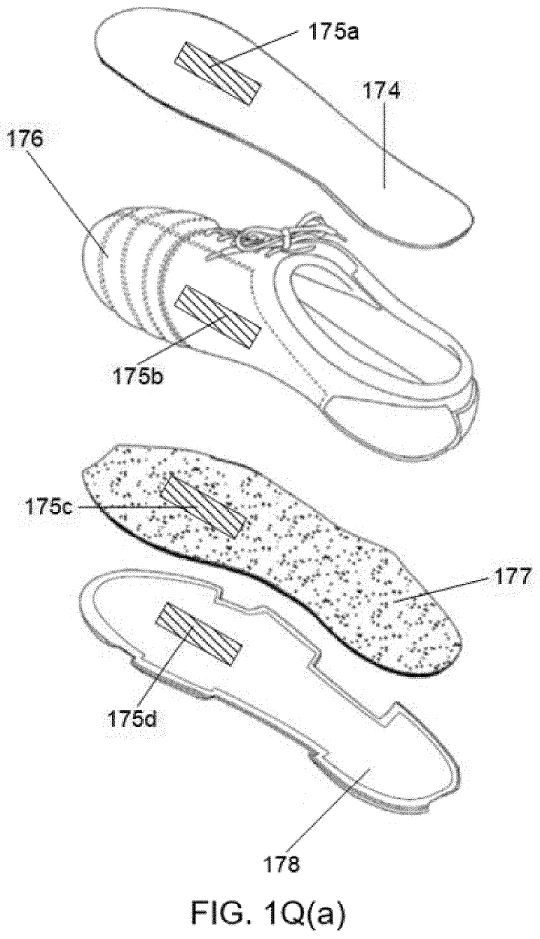

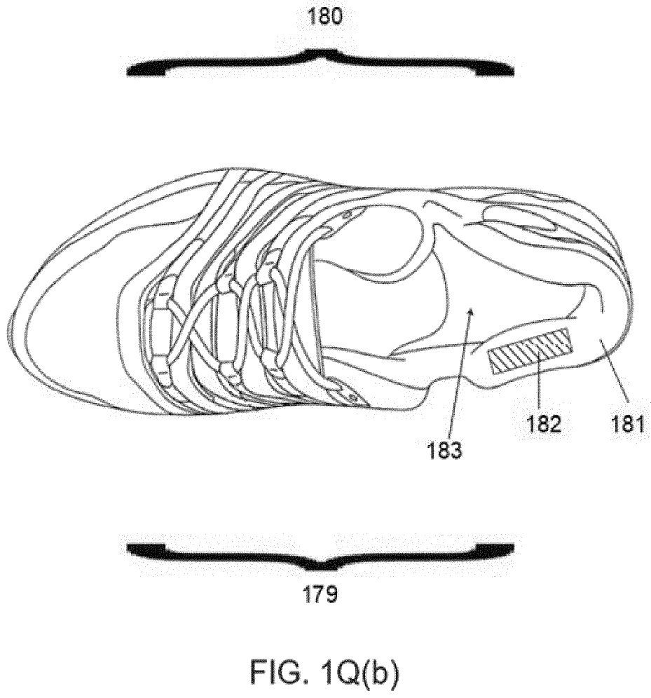

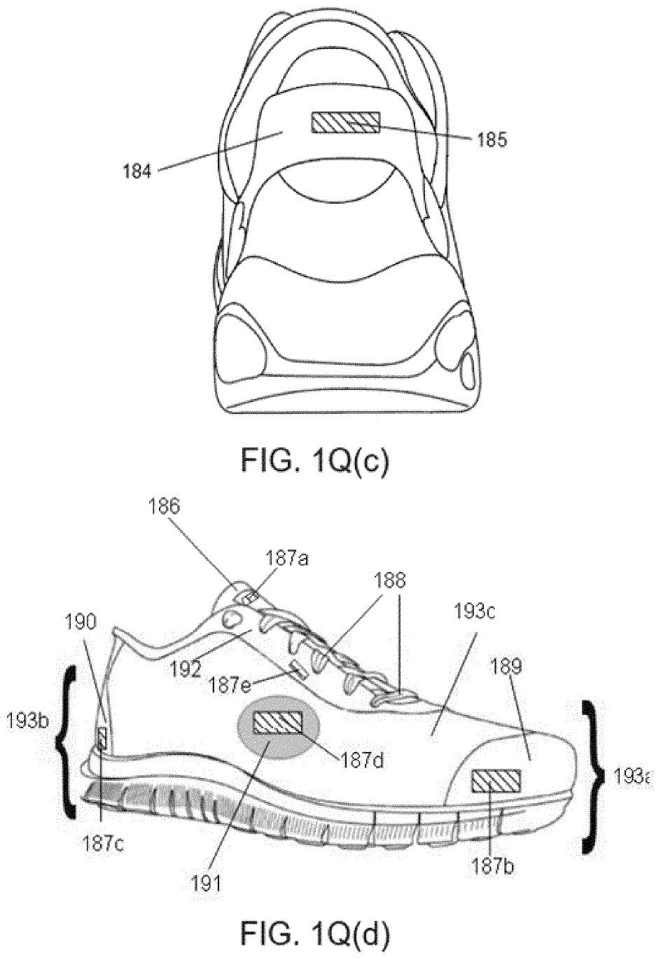

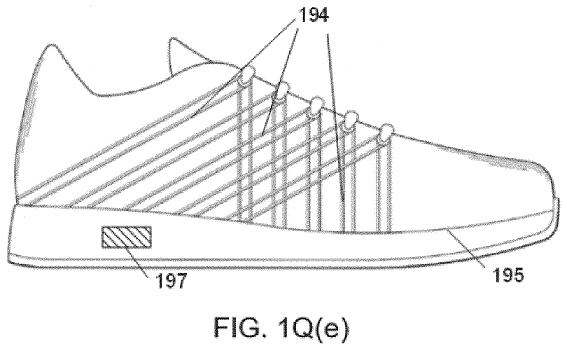

FIGS. 1A-1M illustrates footwear, apparel, athletic equipment, container, electronic equipment, and vision wear that include the structure (e.g., the optical stack, optionally the textured surface) of the present disclosure. The structure can include the optical stack in the “in-line” configuration and/or the “on its side” configuration. The structure including the optical stack is represented by hashed areas 12A′/12M′-12A″/12M′. although much larger areas of the structure can be covered by the optical stack, for example a large portion or the entire upper or lower of an article of footwear, an entire logo present on an article, or the like. The location of the structure is provided only to indicate one possible area that the structure can be located and does not limit the size of the optical stack. Also, two locations are illustrated in some of the figures and one location is illustrated in other figures, but this is done only for illustration purposes as the items can include one or a plurality of structure, where the size and location can be determined based on the item. The structure(s) located on each item can represent a number, letter, symbol, design, emblem, graphic mark, icon, logo, or the like.

FIGS. 1N(a) and 1N(b) illustrate a perspective view and a side view of an article of footwear 100 that include a sole structure 104 and an upper 102. The structure including the optical stack is represented by 122a and 122b. The sole structure 104 is secured to the upper 102 and extends between the foot and the ground when the article of footwear 100 is worn. The primary elements of the sole structure 104 are a midsole 114 and an outsole 112. The midsole 114 is secured to a lower area of the upper 102 and may be formed of a polymer foam or another appropriate material. In other configurations, the midsole 114 can incorporate fluid-filled chambers, plates, moderators, and/or other elements that further attenuate forces, enhance stability, or influence motions of the foot. The outsole 112 is secured to a lower surface of the midsole 114 and may be formed from a wear-resistant rubber material that is textured to impart traction, for example. The upper 102 can be formed from various elements (e.g., lace, tongue, collar) that combine to provide a structure for securely and comfortably receiving a foot. Although the configuration of the upper 102 may vary significantly, the various elements generally define a void within the upper 102 for receiving and securing the foot relative to sole structure 104. Surfaces of the void within upper 102 are shaped to accommodate the foot and extend over the instep and toe areas of the foot, along the medial and lateral sides of the foot, under the foot, and around the heel area of the foot. The upper 102 can be made of one or more materials such as textiles, a polymer foam, leather, synthetic leather, and the like that are stitched or bonded together. Although this configuration for the sole structure 104 and the upper 102 provides an example of a sole structure that may be used in connection with an upper, a variety of other conventional or nonconventional configurations for the sole structure 104 and/or the upper 102 can also be utilized. Accordingly, the configuration and features of the sole structure 104 and/or the upper 102 can vary considerably.

FIGS. 1O(a) and 1O(b) illustrate a perspective view and a side view of an article of footwear 130 that include a sole structure 134 and an upper 132. The structure including the optical stack is represented by 136a and 136b/136b′. The sole structure 134 is secured to the upper 132 and extends between the foot and the ground when the article of footwear 130 is worn. The upper 132 can be formed from various elements (e.g., lace, tongue, collar) that combine to provide a structure for securely and comfortably receiving a foot. Although the configuration of the upper 132 may vary significantly, the various elements generally define a void within the upper 132 for receiving and securing the foot relative to the sole structure 134. Surfaces of the void within the upper 132 are shaped to accommodate the foot and extend over the instep and toe areas of the foot, along the medial and lateral sides of the foot, under the foot, and around the heel area of the foot. The upper 132 can be made of one or more materials such as textiles, polymer foam, leather, synthetic leather, and the like that are stitched or bonded together.

The primary elements of the sole structure 134 are a forefoot component 142, a heel component 144, and an outsole 146. Each of the forefoot component 142 and the heel component 144 are directly or indirectly secured to a lower area of the upper 132 and formed from a polymer material that encloses a fluid, which may be a gas, liquid, or gel. During walking and running, for example, the forefoot component 142 and the heel component 144 compress between the foot and the ground, thereby attenuating ground reaction forces. That is, the forefoot component 142 and the heel component 144 are inflated and generally pressurized with the fluid to cushion the foot. The outsole 146 is secured to lower areas of the forefoot component 142 and the heel component 144 and may be formed from a wear-resistant rubber material that is textured to impart traction. The forefoot component 142 can be made of one or more polymers (e.g., layers of one or more polymers films) that form a plurality of chambers that includes a fluid such as a gas. The plurality of chambers can be independent or fluidically interconnected. Similarly, the heel component 144 can be made of one or more polymers (e.g., layers of one or more polymers films) that form a plurality of chambers that includes a fluid such as a gas and can also be independent or fluidically interconnected. In some configurations, the sole structure 134 may include a foam layer, for example, that extends between the upper 132 and one or both of the forefoot component 142 and the heel component 144, or a foam element may be located within indentations in the lower areas of the forefoot component 142 and the heel component 144. In other configurations, the sole structure 132 may incorporate plates, moderators, lasting elements, or motion control members that further attenuate forces, enhance stability, or influence the motions of the foot, for example. Although the depicted configuration for the sole structure 134 and the upper 132 provides an example of a sole structure that may be used in connection with an upper, a variety of other conventional or nonconventional configurations for the sole structure 134 and/or the upper 132 can also be utilized. Accordingly, the configuration and features of the sole structure 134 and/or the upper 132 can vary considerably.

FIG. 1O(c) is a cross-sectional view of A-A that depicts the upper 132 and the heel component 144. The optical stack 136b can be disposed on the outside wall of the heel component 144 or alternatively or optionally the optical stack 136b′ can be disposed on the inside wall of the heel component 144.

FIGS. 1P(a) and 1P(b) illustrate a perspective view and a side view of an article of footwear 160 that includes traction elements 168. The structure including the optical stack is represented by 172a and 172b. The article of footwear 160 includes an upper 162 and a sole structure 164, where the upper 162 is secured to the sole structure 164. The sole structure 164 can include a toe plate 166a, a mid-plate 166b, and a heel plate 166c as well as traction elements 168. The traction elements 168 can include lugs, cleats, studs, and spikes as well as tread patterns to provide traction on soft and slippery surfaces. In general, the cleats, studs and spikes are commonly included in footwear designed for use in sports such as global football/soccer, golf, American football, rugby, baseball, and the like, while lugs and/or exaggerated tread patterns are commonly included in footwear (not shown) including boots design for use under rugged outdoor conditions, such as trail running, hiking, and military use. The sole structure 164 is secured to the upper 162 and extends between the foot and the ground when the article of footwear 160 is worn. The upper 162 can be formed from various elements (e.g., lace, tongue, collar) that combine to provide a structure for securely and comfortably receiving a foot. Although the configuration of the upper 162 may vary significantly, the various elements generally define a void within the upper 162 for receiving and securing the foot relative to the sole structure 164. Surfaces of the void within upper 162 are shaped to accommodate the foot and extend over the instep and toe areas of the foot, along the medial and lateral sides of the foot, under the foot, and around the heel area of the foot. The upper 162 can be made of one or more materials such as textiles, a polymer foam, leather, synthetic leather, and the like that are stitched or bonded together. In other aspects not depicted, the sole structure 164 may incorporate foam, one or more fluid-filled chambers, plates, moderators, or other elements that further attenuate forces, enhance stability, or influence the motions of the foot. Although the depicted configuration for the sole structure 164 and the upper 162 provides an example of a sole structure that may be used in connection with an upper, a variety of other conventional or nonconventional configurations for the sole structure 164 and/or the upper 162 can also be utilized. Accordingly, the configuration and features of the sole structure 164 and/or the upper 162 can vary considerably.

FIGS. 1Q(a)-1Q(e) illustrate additional views of exemplary articles of athletic footwear including various configurations of upper 176. FIG. 1Q(a) is an exploded perspective view of an exemplary article of athletic footwear showing insole 174, upper 176, optional midsole or optional lasting board 177, and outsole 178, which can take the form of a plate. Structures including optical stacks are represented by 175a-175d. FIG. 1Q(b) is a top view of an exemplary article of athletic footwear indicating an opening 183 configured to receive a wearers foot as well as an ankle collar 181 which may include optical stack 182. The ankle collar is configured to be positioned around a wearer's ankle during wear, and optionally can include a cushioning element. Also illustrated are the lateral side 180 and medial side 179 of the exemplary article of athletic footwear. FIG. 1Q(c) is a back view of the article of footwear depicted in FIG. 1Q(b), showing an optional heel clip 184 that can include optical stack 185. FIG. 1Q(d) shows a side view of an exemplary article of athletic footwear, which may optionally also include a tongue 186, laces 188, a toe cap 189, a heel counter 190, a decorative element such as a logo 191, and/or eyestays for the laces 192 as well as a toe area 193a, a heel area 193b, and a vamp 193c. In some aspects, the heel counter 190 can be covered by a layer of knitted, woven, or nonwoven fabric, natural or synthetic leather, film, or other shoe upper material. In some aspects, the eyestays 192 are formed as one continuous piece; however, they can also comprise several separate pieces or cables individually surrounding a single eyelet or a plurality of eyelets. Structures including optical stacks are represented by 187a-187e. While not depicted, optical stacks can be present on the eyestays 192 and/or the laces 188. In some configurations, the sole structure can include a sole structure, such as a midsole having a cushioning element in part or substantially all of the midsole, and the optical stack can be disposed on an externally-facing side of the sole structure, including on an externally-facing side of the midsole. FIG. 1Q(e) is a side view of another exemplary article of athletic footwear. In certain aspects, the upper can comprise one or more containment elements 194 such as wires, cables or molded polymeric component extending from the lace structure over portions of the medial and lateral sides of the exemplary article of athletic footwear to the top of the sole structure to provide lockdown of the foot to the sole structure, where the containment element(s) can have an optical stack (not shown) disposed on an externally-facing side thereon. In some configurations, a rand (not shown) can be present across part or all of the biteline 195.

Now having described embodiments of the present disclosure generally, additional details are provided. In regard to non-structural color, the non-structural color can be chromatic or achromatic. In an aspect the non-structural color may be the natural color of the material or can be altered by a colorant such as a pigment or dye. The material may be recycled material and take on a gray or an off-white or darker shade of red/yellow/blue or a combination thereof.

The optical stack (e.g., first stack, second stack, and the like) can produce the structural color upon exposure to visible light. The structural color (e.g., first structural color, second structural color, and so on) can be achromatic structural color (e.g., black, white, or neutral gray) or chromatic structural color. A “chromatic color” is a color in which one particular wavelength or hue predominates, while an “achromatic color” is a color in which no particular wavelength or hue predominates, as all wavelengths or hues are present in equal parts or substantially equal parts. The chromatic color can be selected from a red/yellow/blue (RYB) primary color, a RYB secondary color, a RYB tertiary color, a RYB quaternary color, a RYB quinary color, or a chromatic color that is a combination thereof. The chromatic color can be red, yellow, blue, green, orange, purple, or a chromatic color that is a combination thereof. The chromatic color can be red, orange, yellow, green, blue, indigo, violet, or a chromatic color that is a combination thereof. The chromatic color has hue and/or chroma according the Munsell color system. The chromatic color does not include black, white, or neutral gray. In an aspect, chromatic color and achromatic color are mutually exclusive of one another.

The achromatic color can be selected from black, white, or neutral gray. When the achromatic color is black, white, or a neutral gray, the phrase “pure achromatic color” can be used. As used herein, the achromatic color excludes the following colors: a warm gray, a warm brown, a warm tan, a cool gray, a cool brown, a cool tan, each of which is considered a chromatic color. For example, a warm gray, a warm brown, and a warm tan would be colors in which yellow or red predominates and so would not be achromatic. Similarly, a cool gray, a cool brown, and a cool tan would be colors in which blue or green predominates, and so would not be achromatic. Achromatic gray can include gainsboro gray, light gray, silver gray, medium gray, spanish gray, gray, dim gray, Davy's gray, jet gray, and the middle grays.

The structural color of an article as perceived by a viewer can differ from the actual structural color of the article, as the structural color perceived by a viewer is determined by the actual structural color of the article (e.g., the structural color of the light leaving the surface of the article), by the presence of optical stacks which may absorb, refract, interfere with, or otherwise alter light reflected by the article, the viewer's visual acuity, by the viewer's ability to detect the wavelengths of light reflected by the article, by the characteristics of the perceiving eye and brain, by the intensity and type of light used to illuminate the article (e.g., sunlight, incandescent light, fluorescent light, and the like), as well as other factors such as the coloration of the environment of the article. As a result, the structural color of an object as perceived by a viewer can differ from the actual color of the article.

Conventionally, color is imparted to man-made objects by applying colored pigments or dyes to the object. Non-structurally colored materials are made of molecules which absorb all but particular wavelengths of light and reflect back the unabsorbed wavelengths, or which absorb and emit particular wavelengths of light. In non-structural color, it is the unabsorbed and/or the emitted wavelengths of light which impart the color to the article. As the color-imparting property is due to molecule's chemical structure, the only way to remove or eliminate the color is to remove the molecules or alter their chemical structure.

More recently, methods of imparting “structural color” to man-made objects have been developed. Structural color is color that is produced, at least in part, by microscopically structured surfaces that interfere with visible light contacting the surface. The structural color is color caused by physical phenomena including the scattering, refraction, reflection, interference, and/or diffraction of light, unlike color caused by the absorption or emission of visible light through coloring matters. For example, optical phenomena which impart structural color can include single- or multi-layer interference, thin-film interference, refraction, dispersion, light scattering, Mie scattering, diffraction, and diffraction grating. As structural color is produced by physical structures, destroying or altering the physical structures can eliminate or alter the imparted color. The ability to eliminate color by destroying the physical structure, such as by grinding or melting an article can facilitate recycling and reuse colored materials. In various aspects described herein, structural color imparted to an article can be visible to an observer having 20/20 visual acuity and normal color vision from a distance of about 1 meter from the article, when the structurally-colored region is illuminated by about 30 lux of sunlight, incandescent light, or fluorescent light. In some such aspects, the structurally-colored region is at least one square centimeter in size to 10 s of centimeters in size.

As described herein, structural color is produced, at least in part, by the optical stack, as opposed to the color being produced solely by pigments and/or dyes. The coloration of an article can be due solely to structural color (i.e., the article, a colored portion of the article, or a colored outer layer of the article can be substantially free of pigments and/or dyes). Structural color can also be used in combination with pigments and/or dyes, for example, to alter all or a portion of the structural color.

In another aspect, the optical stack can impart a “combined color,” where a “combined color” can be described as having a structural color component and a non-structural color component (e.g., release layer such as abrasion release layer). For example, the structural color can be used in combination with pigments and/or dyes to alter all or a portion of the structural color, forming a combined structural color. In a combined color, the structural color component, when viewed without the non-structural color component, imparts a structural color having a first structural color and the non-structural color component, when viewed without the structural color component imparts a second color, where the first structural color and the second color differ. Further in this aspect, when viewed together, the first structural color and the second color combine to form a third combined color, which differs from either the first structural color or the second color, for example, through shifting the reflectance spectrum of the optical stack.

In another aspect, an optical stack can impart a “modified color,” where a “modified color” can be described as having a structural color component and a modifier component (e.g., release layer such as abrasion release layer). In a modified color, the structural color component, when viewed without the modifier component, imparts a structural color and the modifier component, when viewed without the structural color component, does not impart any color, hue, or chroma. Further in this aspect, when viewed together, the modifier component can expand, narrow, or shift the range of wavelengths of light reflected or absorbed by the structural color component. In still another aspect, an optical stack can impart a “modified combined color,” where a “modified combined color” can be described as having a structural color component having a first structural color, a non-structural color component having a second color, and a modifier component not imparting a color but instead functioning to expand, narrow, or shift the range of wavelengths of light reflected by the combined color formed from the structural color component and the non-structural color component.

In one aspect, the structural color component, combined color component, or modified color component disclosed herein is opaque; that is, it prevents light from passing through any articles to which they are applied (e.g., release layer such as cover release layer or abrasion release layer). Further in this aspect, most wavelengths of light are absorbed by one or more layers of the structural color, combined color, or modified color component, with only a narrow band of light reflected about the wavelength of maximum reflectance.

“Hue” is commonly used to describe the property of color which is discernible based on a dominant wavelength(s) of visible light, and is often described using terms such as magenta, red, orange, yellow, green, cyan, blue, indigo, violet, etc. or can be described in relation (e.g., as similar or dissimilar) to one of these. The hue of a color is generally considered to be independent of the intensity or lightness of the color. For achromatic color, the hue is typically zero and lightness imparts the white, black, or gray color (or shade) as opposed to chromatic where hue and lightness can have zero or non-zero values depending upon the chromatic color. For example, in the Munsell color system, the properties of color include hue, value (lightness) and chroma (color purity) (e.g., achromatic has a zero or close to zero value for hue and chroma, whereas chromatic can have zero or non-zero values depending upon the chromatic color). Particular hues are commonly associated with particular ranges of wavelengths in the visible spectrum (e.g., about 380 to 740 nanometers): wavelengths in the range of about 700 to 635 nanometers are associated with red, the range of about 635 to 590 nanometers is associated with orange, the range of about 590 to 560 nanometers is associated with yellow, the range of about 560 to 520 nanometers is associated with green, the range of about 520 to 490 nanometers is associated with cyan, the range of about 490 nanometers to 450 nanometers is associated with blue, and the range of about 450 to 400 nanometers is associated with violet. As described herein, that achromatic color can have no hue or chroma and the achromatic color is a color in which no particular wavelength or hue predominates, as all wavelengths or hues are present in equal parts or substantially equal parts. The achromatic color can be selected from black, white, or neutral gray. The chromatic color can be selected from a red/yellow/blue (RYB) primary color, a RYB secondary color, a RYB tertiary color, a RYB quaternary color, a RYB quinary color, or a chromatic color that is a combination thereof. The chromatic color can be red, yellow, blue, green, orange, purple, or a chromatic color that is a combination thereof. The chromatic color can be red, orange, yellow, green, blue, indigo, violet, or a chromatic color that is a combination thereof. The wavelength range can be about 380 to 740 nanometers and can be measured as a function of absorbance or reflectance, each of which can be used to define the chromatic or achromatic structural color imparted by the optical stack.

While the optical stack may impart a first structural color, the presence of an optional textured surface and/or release layer (e.g., abrasion release layer) can alter the structural color or in the alternative have no impact on the first structural color. Other factors such as coatings or transparent elements may further alter the perceived structural color.

In some embodiments, the structural color of a structurally-colored article does not change substantially, if at all, depending upon the angle at which the article is observed or illuminated. In instances such as this the structural color can be an angle-independent or when observed is substantially independent or is independent of the angle of observation.

Other factors such as coatings or transparent elements may further alter the perceived structural color. The structural color can be referred to as a “non-shifting” (i.e., the color remains substantially the same, regardless of the angle of observation and/or illumination), or “shifting” (i.e., the structural color varies depending upon the angle of observation and/or illumination). For example, a shift can occur over a small change in the angle of observation and/or illumination (e.g., less than 5 degrees, less than 7 degrees, or less than 10 degrees, but this is dependent upon the particular optical stack). In another example, the shift can occur over a larger angle of observation and/or illumination (e.g., greater than 10 degrees, greater than 12 degrees, greater than 15 degrees but this is dependent upon the particular optical stack). In an aspect, the shifting color can change gradually (e.g., as the angle changes by 4 or 5 degrees) over two or more shades or colors. In as aspect, the shifting color can shift upon reaching a threshold change (e.g., an abrupt (e.g., a change of 1 to 3 degrees) or the change is gradual (e.g., a change of about 4 to 8 degrees), and not abrupt, in angle of observation or illumination (e.g., a change of more than 10, 12, or 15 degrees). For example, an abrupt change can occur as the angle changes from 14 to 15 degrees, whereas a gradual change can occur as the angle changes from 13 to 17 degrees. Thus, the shifting of the structural color can change gradually or abruptly as the angle of observation or illumination changes, which can be determined by the design of the optical stack.

In an example, the shift in structural color can be observed as the angle of observation or illumination changes from 13 to 15 degree (an abrupt change). In another example, the shift in structural color can be observed as the angle of observation or illumination changes from 12 to 17 degree (a gradual change). These examples simply illustrate that the shifting can be varied and diverse and the optical stack can be designed according to the desired outcome.

As discussed above, the color of a structurally-colored article (e.g., an article include structural color) can be independent of or vary depending upon the angle at which the structurally-colored article is observed or illuminated. As used herein, the “angle” of illumination or viewing is the angle measured from an axis or plane that is orthogonal to the surface. The viewing or illuminating angles can be set between about 0 and 180 degrees. The viewing or illuminating angles can be set at 0 degrees, 5 degrees, 10 degrees, 15 degrees, 30 degrees, 45 degrees, 60 degrees, and −15 degrees (as well as increments of 1 within the ranges described above and herein) and the color can be measured using a colorimeter or spectrophotometer (e.g., Konica Minolta), which focuses on a particular area of the article to measure the color. The viewing or illuminating angles can be set at 0 degrees, 5 degrees, 10 degrees, 15 degrees, 30 degrees, 45 degrees, 60 degrees, 75 degrees, 90 degrees, 105 degrees, 120 degrees, 135 degrees, 150 degrees, 165 degrees, 180 degrees, 195 degrees, 210 degrees, 225 degrees, 240 degrees, 255 degrees, 270 degrees, 285 degrees, 300 degrees, 315 degrees, 330 degrees, and 345 degrees and the color can be measured using a colorimeter or spectrophotometer

Various methodologies for defining color coordinate systems exist. One example is L*a*b* color space, where, for a given illumination condition, L* is a value for lightness, and a* and b* are values for color-opponent dimensions based on the CIE coordinates (CIE 1976 color space or CIELAB) (e.g., a* and b* are 0 or close to 0). In an embodiment, a structural color can be considered as having a “single” color when the change in color measured for the article is within about 10 percent or within about 5 percent of the total scale of the a* or b* coordinate of the L*a*b* scale (CIE 1976 color space) at three or more measured observation or illumination angles selected from measured at observation or illumination angles of 0 degrees, 15 degrees, 30 degrees, 45 degrees, 60 degrees, and −15 degrees.

Another example of a color scale is the CIELCH color space, where, for a given illumination condition, L* is a value for lightness, C* is a value for chroma, and h° denotes a hue as an angular measurement (e.g., C* and h° are 0 or close to 0). In an embodiment, a structural color can be considered as having a “single” color when the color measured for the article is less than 10 degrees different or less than 5 degrees different at the h° angular coordinate of the CIELCH color space, at three or more measured observation or illumination angles selected from measured at observation or illumination angles of 0 degrees, 15 degrees, 30 degrees, 45 degrees, 60 degrees, and −15 degrees. In certain embodiments, colors which, when measured and assigned values in the CIELCH system that vary by at least 45 degrees in the h° measurements, are considered to be different colors.

Another system for characterizing color includes the “PANTONE” Matching System (Pantone LLC, Carlstadt, N.J., USA), which provides a visual color standard system to provide an accurate method for selecting, specifying, broadcasting, and matching colors through any medium. In an example, a first optical stack and a second optical stack (or the same optical stack at different angles) can be said to have the same color when the color measured for each optical stack is within a certain number of adjacent standards, e.g., within 20 adjacent PANTONE standards, at three or more measured observation or illumination angles selected from 0 degrees, 15 degrees, 30 degrees, 45 degrees, 60 degrees, and 75 degrees. In an alternative aspect, the first optical stack and the second optical stack (or a single optical stack at different angles) can be said to have different colors when the color measured for each optical stack is outside a certain number of adjacent standards, e.g., at least 20 adjacent PANTONE standards or farther apart, at three or more measured observation or illumination angles selected from 0 degrees, 15 degrees, 30 degrees, 45 degrees, 60 degrees, and 75 degrees. In another aspect, an optical stack can be said to be single color when all areas of the optical stack have the same PANTONE color as defined herein, or can be multi-colored when at least two areas of the optical stack have different PANTONE colors. In another aspect, a single optical stack can be said to have a non-shifting color if it exhibits the same PANTONE color as defined herein at three or more measured observation or illumination angles (e.g., 0 degrees, 15 degrees, 30 degrees, 45 degrees, 60 degrees, and −15 degrees). In an alternative aspect, a single optical stack can be said to be shifting if it exhibits two, three, or four different PANTONE colors as defined herein at two or more measured observation or illumination angles (e.g., 0 degrees, 15 degrees, 30 degrees, 45 degrees, 60 degrees, and −15 degrees).

Another example of a color scale is the Natural Color System® or NCS, which is built on principles of human physiological vision and describes color by using color similarity relationships. The NCS is based on the premise that the human visual system consists of six elementary color precepts, or colors that can be challenging to define perceptually in terms of other colors. These colors consist of three pairs: (i) the achromatic colors of black (S) and white (W), (ii) the opposing primary color pair of red (R) and green (G), and (iii) the opposing primary color pair of yellow (Y) and blue (B). In the NCS, any color that can be perceived by the human eye can be similar to the two achromatic colors and a maximum of two non-opposing primary colors. Thus, for example, a perceived color can have similarities to red and blue but not to red and green. NCS descriptions of colors are useful for colors that belong to the surfaces of materials, so long as the surfaces are not fluorescent, translucent, luminescent, or the like; the NCS does not encompass other visual properties of the surface such as, for example, gloss and texture.

The NCS color space is a three dimensional model consisting of a flat circle at which the four primary colors are positioned in order at 0 degrees, 90 degrees, 180 degrees, and 270 degrees. For example, if yellow is at 0 degrees, red is at 90 degrees, blue is at 180 degrees, and green is at 270 degrees. White is represented above the circle and black below such that a hue triangle forms between the black/white (grayscale) axis and any point on the circle.

Percentage “blackness” (s) is defined in the NCS as a color's similarity to the elementary color black. Percentage “chromaticness” (c) represents similarity to the most saturated color in a hue triangle. “Hue” (ϕ) in the NCS, meanwhile, represents similarity of a color to one or at most two non-opposing primary colors. Blackness and chromaticness add up to a value less than or equal to 100 percent; any remaining value is referred to as “whiteness” (w) of a color. In some cases, the NCS can be used to further describe “saturation” (m), a value from 0 to 1 determined in terms of chromaticness and whiteness (e.g., m=c/(w+c)). NCS can further be used to describe “lightness” (v), a description of whether the color contains more of the achromatic elementary colors black or white. A pure black article would have a lightness of 0 and a pure white article would have a lightness of 1. Purely neutral grays (c=0) have lightness defined by v=(100−s)/100, while chromatic colors are first compared to a reference scale of grays and lightness is then calculated as for grays.

NCS notation takes the generic form sc-AϕB, where sc defines “nuance,” ss is the percent blackness and cc refers to the chromaticity; A and B are the two primary colors to which the color relates; and ϕ is a measure of where a color falls between A and B. Thus, a color (e.g., orange) that has equal amounts of yellow and red could be represented such that ASB=Y50R (e.g., yellow with 50 percent red), whereas a color having relatively more red than yellow is represented such that AϕB=Y60R, Y70R, Y80R, Y90R, or the like. The color having equal amounts of yellow and red with a relatively low (10 percent) amount of darkness and a medium (50 percent) level of chromaticity would thus be represented as 1050-Y50R. In this system, neutral colors having no primary color components are represented by sc-N, where sc is defined in the same manner as with a non-neutral color and N indicates neutrality, while a pure color would have a notation such as, for example, 3050-B (for a blue with 30 percent darkness and 50 percent chromaticity). A capital “S” in front of the notation indicates that a value was present in the NCS 1950 Standard, a reduced set of samples. As of 2004, the NCS system contains 1950 standard colors.

The NCS is more fully described in ASTM E2970-15, “Standard Practice for Specifying Color by the Natural Colour System (NCS).” Although the NCS is based on human perception and other color scales such as the CIELAB or CIELCH spaces may be based on physical properties of objects, NCS and CIE tristimulus values are interconvertible.

In an example, a first optical stack and a second optical stack (or the same optical stack at different angles) can be considered as being the same structural color when the structural colors measured for each optical stack are within a certain number of adjacent standards, e.g., within 20 adjacent NCS values, at three or more measured observation or illumination angles selected from 0 degrees, 15 degrees, 30 degrees, 45 degrees, 60 degrees, and −15 degrees. In another example, the first optical stack and the second optical stack (or the same optical stack at different angles) can be considered as being different structural colors when the colors measured for each optical stack are outside a certain number of adjacent standards, e.g., farther apart than at least 20 adjacent NCS values, at three or more measured observation or illumination angles selected from 0 degrees, 15 degrees, 30 degrees, 45 degrees, 60 degrees, and −15 degrees. In another aspect, an optical stack can be said to be a single structural color when all areas of the optical stack have the same NCS color as defined herein, or can be multi-colored when at least two areas of the optical stack have different NCS colors. In another aspect, a single optical stack can be said to have a non-shifting color if it exhibits the same NCS color as defined herein at three or more measured observation or illumination angles (e.g., 0 degrees, 15 degrees, 30 degrees, 45 degrees, 60 degrees, and −15 degrees). In an alternative aspect, a single optical stack can be said to be shifting color if it exhibits two, three, or four different NCS colors as defined herein at two or more measured observation or illumination angles (e.g., 0 degrees, 10 degree, 15 degrees, 30 degrees, 45 degrees, 60 degrees, and −15 degrees).

A change or difference in color between two measurements (the same or different angles for a single structural color) and/or two colors (e.g., first structural color and the second structural color from the same of different angles) in the CIELAB space can be determined mathematically. For example, a first measurement (e.g., a first structural color) has coordinates L₁*, a₁* and b₁*, and a second measurement (e.g., a second structural color) has coordinates L₂*, a₂* and b₂*. The total difference between these two measurements on the CIELAB scale can be expressed as E*ab, which is calculated as follows: ΔE*ab=[(L₁*−L₂*)²+(a₁*−a₂)²+(b₁*−b₂*)²]^{1/2}. Generally speaking, if two colors (e.g., first structural color and the second structural color) have a ΔE*ₐb of less than or equal to 1, the difference in color is not perceptible to human eyes, and if two colors (e.g., first structural color and the second structural color) have a E*ab of greater than 100 the colors are considered to be opposite colors, while a E*ab of about 2-3 is considered the threshold for perceivable color difference from someone with 20 20 visual acuity from a distance of about 1 meter from the article under the same lighting conditions.

In certain embodiments, a structural color (e.g., first structural color or second structural color) can be considered as having a “single” color when the ΔE*ₐb is less than 2, or less than 3, between three or more measured observation or illumination angles selected from measured at observation or illumination angles of 0 degrees, 10 degrees, 15 degrees, 30 degrees, 45 degrees, 60 degrees, and −15 degrees.

In regard to a potential difference between structural color, at the same area of the optical stack the structural color can be observed at two different angles of observation. The difference can be determined in the CIELAB space mathematically. For example, a first measurement (e.g., obtained from a first angle) has coordinates L₁*, a₁* and b₁*, and a second measurement (e.g., obtained from a second angle) has coordinates L₂*, a₂* and b₂*. The total difference between these two measurements on the CIELAB scale can be expressed as ΔE*ab, which is calculated as follows: ΔE*ab=[(L₁*−L₂*)²+(a₁*−a₂*)²+(b₁*−b₂*)²]^{1/2}. Generally speaking, if two structural colors have a ΔE*ₐb of less than or equal to 1, the difference in color is not perceptible to human eyes, and if two structural colors have a ΔE*ₐb of greater than 100 the colors are considered to be opposite colors, while a ΔE*ₐb of about 2-3 is considered the threshold for perceivable color difference and can depend upon the person perceiving the structural colors, the illumination considerations, and the like. The first structural color and the second structural color can be different in that they can have a ΔE*ₐb of greater than about 2.2, greater than about 3, greater than about 4, greater than about 5, or greater than about 10 or more. The first structural color and the second structural color can be the same or substantially the same in that they can have a ΔE*ₐb of less than about 3 or less than about 2. Since the threshold of perceivable color difference is about 2-3 and the perception is depended upon the person perceiving, the conditions, and the like, the first structural color and the second structural color may be subjectively the same or different depending upon the circumstance from someone with 20 20 visual acuity from a distance of about 1 meter from the article under the same lighting conditions.

The method of making the structurally colored article can include disposing (e.g., affixing, attaching, bonding, fastening, joining, appending, connecting, binding) the optical stacks (e.g., the first stack disposed on the surface of the article) onto an article (e.g., an article of footwear, an article of apparel, an article of sporting equipment, etc.) in an “in-line” or “on its side” configuration. The article includes a component, and the component has a surface upon which the optical stacks can be disposed. The surface of the article can be made of a material such as a thermoplastic material or thermoset material, as described herein. For example, the article has a surface including a thermoplastic material (i.e., a first thermoplastic material), for example an externally-facing surface of the component or an internally-facing surface of the component (e.g., an externally-facing surface or an internally-facing surface a bladder). The optical stacks can be disposed onto the thermoplastic material, for example. The surface upon which the optical stacks are disposed is not opaque and is semi-transparent or transparent to light in from 380 to 740 nanometers, for example, the surface can have a minimum percent transmittance of about 30 percent or more, about 40 percent or more, or about 50 percent or more, for light in the visible spectrum.

In an aspect, the temperature of at least a portion of the first surface of the article including the thermoplastic material is increased to a temperature at or above creep relaxation temperature (Tcr), Vicat softening temperature (Tvs), heat deflection temperature (Thd), and/or melting temperature (Tm) of the thermoplastic material, for example to soften or melt the thermoplastic material. The temperature can be increased to a temperature at or above the creep relaxation temperature. The temperature can be increased to a temperature at or above the Vicat softening temperature. The temperature can be increased to a temperature at or above the heat deflection temperature. The temperature can be increased to a temperature at or above the melting temperature. While the temperature of the at least a portion of the first side of the article is at or above the increased temperature (e.g., at or above the creep relaxation temperature, the heat deflection temperature, the Vicat softening temperature, or the melting temperature of the thermoplastic material), the optical stack is affixed to the thermoplastic material within the at least a portion of the first side of the article. Following the affixing, the temperature of the thermoplastic material is decreased to a temperature below its creep relaxation temperature to at least partially re-solidify the thermoplastic material. The thermoplastic material can be actively cooled (e.g., removing the source that increases the temperature and actively (e.g., flowing cooler gas adjacent the article reducing the temperature of the thermoplastic material) or passively cooled (e.g., removing the source that increases the temperature and allowing the thermoplastic layer to cool on its own).

Now having described color and other aspects generally, additional details regarding the optical stack are provided.

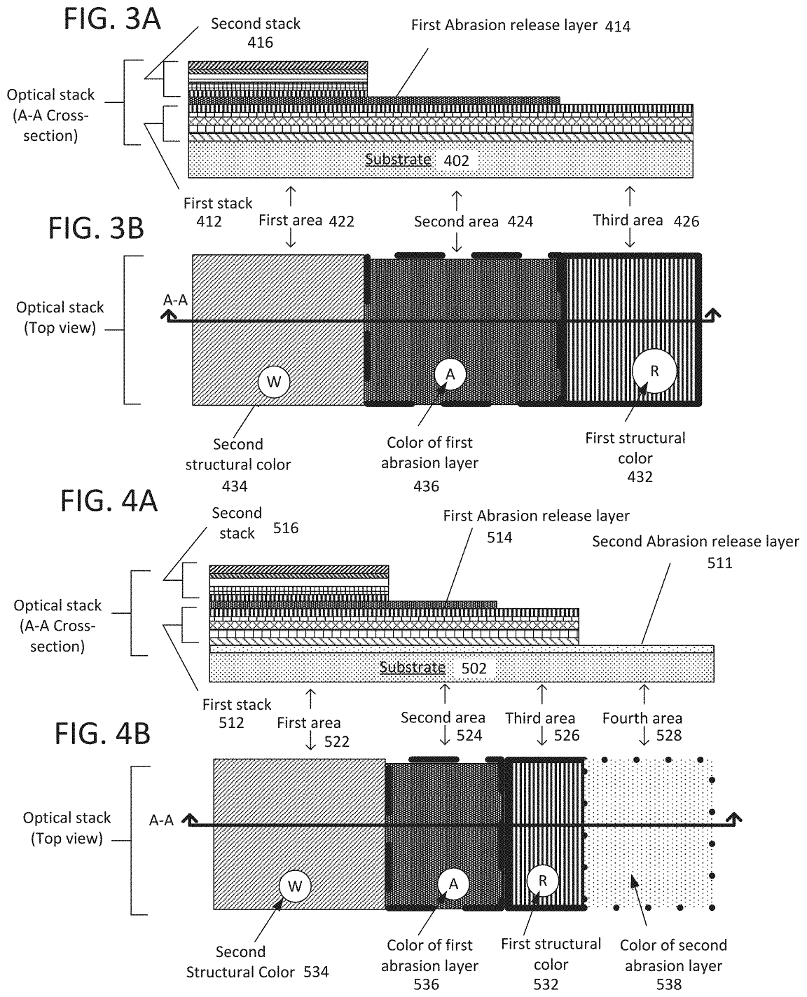

FIG. 3A is a transverse cross-sectional illustration of a first stack 412 (also referred to as the “first optical stack”) and a second stack 416 (also referred to as the “second optical stack”), where a first abrasion release layer 414 is disposed between the first stack 412 and the second stack 416. The first stack 412 is disposed on the substrate 402. The first stack 412 includes 5 layers (e.g., constituent layer, reflective layer) and the second stack 416 also includes 5 layers. Adjacent layers of each of the first stack and the second stacks are made of different materials.

FIG. 3B illustrates a top view of structure in FIG. 3A. As shown in FIGS. 3A and 3B, a first area 422 includes the first stack 412, first abrasion release layer 414, and the second stack 416, a second area 424 includes the first stack 412 and the first abrasion release layer 414, and a third area 426 includes the first stack 412. FIG. 3B illustrates that the second stack 416 in the first area 422 imparts a second structural color 434 and the first stack 412 in the third area 426 imparts a first structural color 432 since both are exposed to visible light, while the second area 424 has the color 436 of the first abrasion release layer 414.

To have a cross-sectional structure as shown in FIGS. 3A and 3B, different abrasive forces were applied across the surface of the article having the first stack 412 and the second stack 416 disposed thereon. In the first area 422 the abrasive force was not enough (or not applied) so the first stack 412 and the second stack 416 remained unchanged, while in the second area 424 and third area 426 the abrasive force was enough to remove the second stack 416 and the second stack 416 and first abrasion release layer 414, respectively. The differential application of abrasive forces results in unique and interesting features (e.g., coloring with structural color for example) as shown in top view of FIG. 3B.

FIG. 4A is a transverse cross-sectional illustration of a first stack 512 (also referred to as the “first optical stack”) and a second stack 516 (also referred to as the “second optical stack”), where a first abrasion release layer 514 is disposed between the first stack 512 and the second stack 516 and a second abrasion release layer 511 is disposed between the substrate surface 502 and the first stack 512. The second abrasion release layer 511 is disposed on the surface of the substrate 502. The first stack 512 includes 5 layers (e.g., constituent layer, reflective layer) and the second stack 516 also includes 5 layers. Adjacent layers of the first stack 512 and the second stack 516 are made of different materials.

FIG. 4B illustrates a top view of structure in FIG. 4A. As shown in FIGS. 4A and 4B, a first area 522 includes: the second abrasion layer 511, the first stack 512, first abrasion release layer 514, and the second stack 516; a second area 524 includes the second abrasion layer 511, the first stack 512, and the first abrasion release layer 514; a third area 526 includes the second abrasion release layer 511, the first stack 512 and the second abrasion release layer 514; and a fourth area 528 includes only the second abrasion release layer 511. FIG. 4B illustrates that the second stack 516 in the first area 522 imparts a second structural color 534 and the first stack 512 in the third area 526 imparts a first structural color 532, while the second area 524 has the color 536 of the first abrasion release layer 514 and the fourth area 528 has the color 538 of the second abrasion release layer 511.

To have a cross-sectional structure as shown in FIGS. 4A and 4B, different abrasive forces were applied across the surface of the article having the first stack 512 and the second stack 516 disposed thereon. In the first area 522 the abrasive force was not enough (or not applied) so the first stack 512 and the second stack 516 remained unchanged, while in the second area 524, third area 526, and fourth area 528 the abrasive force was enough to remove: the second stack 516; the second stack 516 and first abrasion release layer 514; and second stack 516, first abrasive release layer 514, and the first stack 512, respectively. The differential application of abrasive forces results in unique and interesting features (e.g., coloring with structural color for example) as shown in top view of FIG. 4B.

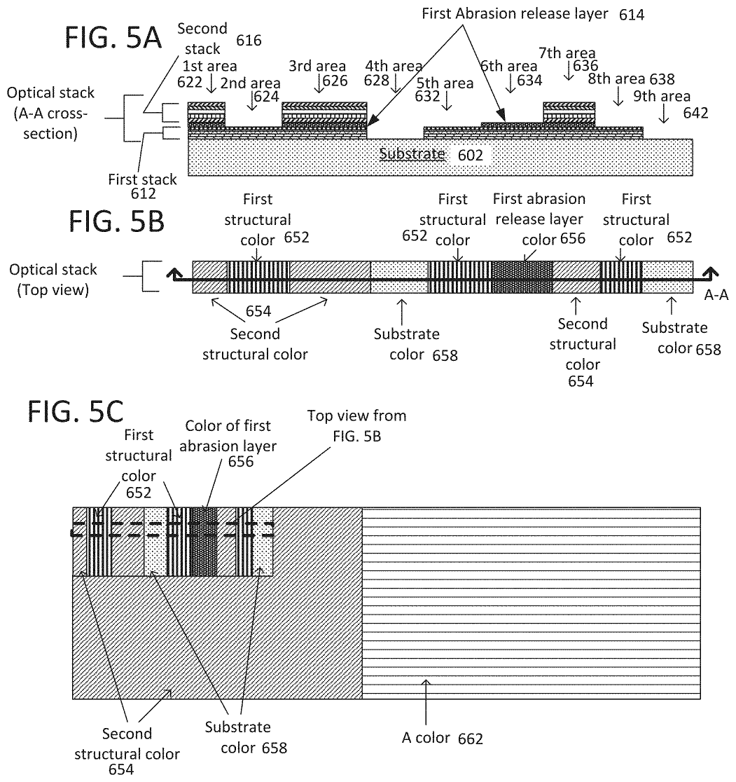

FIG. 5A is a transverse cross-sectional illustration of a first stack 612 (also referred to as the “first optical stack”) and a second stack 616 (also referred to as the “second optical stack”), where a first abrasion release layer 614 is disposed between the first stack 612 and the second stack 616 and optionally a second abrasion release layer (not shown) can disposed between the surface of the substrate 602 and the first stack 612. The first stack 612 is disposed on the substrate 602. The first stack 612 includes 5 layers (e.g., constituent layer, reflective layer) and the second stack 616 also includes 5 layers. Adjacent layers of the first stack 612 and the second stack 616 are made of different materials.

FIG. 5B illustrates a top view of structure in FIG. 5A. As shown in FIGS. 5A and 5B, a first area 622, a third area 626, and seventh area 636 includes the first stack 612, first abrasion release layer 614, and the second stack 616; a second area 624, a fifth area 632, and an eighth area 638 includes the first stack 612 and the first abrasion release layer 614; a fourth area 628 and ninth area 642 show that only the surface of the substrate is present in those areas; and a sixth area 634 includes the first abrasion release layer 614 and the first stack 612. FIG. 5B illustrates that the first area 622, the third area 626, and the seventh area 636 impart a second structural color 654; the second area 624, the fifth area 632, and the eighth area 638 impart a first structural color 652; the fourth area 628 and ninth area 642 are the color 658 of the surface, and the sixth area 634 is the color 656 of the first abrasion release layer 614.

To have a cross-sectional structure as shown in FIGS. 5A and 5B, different abrasive forces were applied across the surface of the article having the first stack 612 and the second stack 616 disposed thereon. In the first area 622, the third area 626, and the seventh area 636 the abrasive force was not enough (or not applied) so the first stack 612 and the second stack 616 remains unchanged, while the other areas show different degrees of removal of the layers. The differential application of abrasive forces results in unique and interesting features (e.g., coloring with structural color for example) as shown in top view of FIG. 5B.

FIG. 5C is a top view of a larger area that includes those shown in FIGS. 5A and 5B, but also includes other areas. The differential application of abrasive force can be seen by the areas where the abrasion release layer was removed and it was not removed. The other area denoted as “color” can be yet a different region that has a different color (e.g., structural color or non-structural color) that includes other optical stacks or include the article surface only.

As illustrated in the figures, the dimensions of the optical stacks (e.g., first stack and second stack of each of FIGS. 3A-5C) can vary depending upon the desired structural colors, design, surface upon which they are disposed, and the like. The first stack has a base unit height (or thickness) of about 10 to about 200 nanometers, about 50 to 100 nanometers, about 50 to about 200 nanometers, about 50 to 500 nanometers, about 40 to 70 nanometers, about 50 to 750 nanometers. The second stack can have a base unit height (or thickness) of about 10 to about 200 nanometers, about 40 to 70 nanometers, about 50 to 100 nanometers, about 50 to about 200 nanometers, about 50 to 500 nanometers, about 50 to 750 nanometers. The first abrasion release layer can have a height (or thickness) of about 10 to 100 nanometer or ranges therein as well as those described herein. The dimensions of the areas having the first structural color, the second structural color, the color associated with the first abrasion release layer and the color associated with the substrate can vary from square millimeters to centimeters or more depending upon the size of the article. While the areas are shown as rectangular areas, the areas will have a wide range of shape and can be completely random which might be expected from normal wear and tear. As a result, the figures provided are only illustrative to show aspects more clearly.

Each of the optical stacks can independently be an inorganic optical stack, an organic optical stack, or a mixed inorganic/organic optical stack. The organic optical stack has at least one layer and that layer is made of an organic material. The organic material can include a polymer, such as those described herein. The organic material is made of a non-metal or non-metal oxide material. The organic material that does not include a metal or metal oxide or alloy. The organic material is made of a polymeric material that does not include a metal or metal oxide or alloy.

The inorganic optical stack has at least one layer and that layer is made of a non-organic material. As described in detail herein, the non-organic material can be a metal, metal oxide, and alloys. The non-organic material does not include any organic material.

The optical stack can be a mixed inorganic/organic optical stack, meaning that one or more of the layers can be made of an inorganic material, one or more layers can be made of an organic material, and/or one or more layers can be made of a layer of a mixture of inorganic and organic materials (e.g., a polymer include metal or metal oxide particles (e.g., micro- or nano-particles).

Each of the optical stacks can independently include at least one layer (also referred to as “optical layer”), which can be at least one constituent layer and/or at least one reflective layer (e.g., intermediate and/or non-intermediate reflective layers). In addition, the optical stack includes one or more abrasion release layers. The optical layers are distinct and different from the release layers.

In general, the abrasion release layer (e.g., first abrasion release layer) does not impart structural color. The abrasion release layer may include colorant such as an ink or pigment, while in other embodiments the abrasion release layer does not include an ink or pigment. The abrasion release layer can be opaque.

The abrasion release layer can be made of a material such as a polymeric material or a composite material (e.g., polymer/metal/metal oxide composite material), where the abrasion release layer bonds less strongly to the first optical stack than between layers of the first optical stack, bonds less strongly to the second optical stack than between layers of the second optical stack, and bonds less strongly than the first optical stack is bonded to the article surface, or a combination thereof. In regard to the polymeric material, the polymeric material can be a thermoset polymer or a thermoplastic polymer, where both are described in detail herein. In regard to the composite material, the composite material can include one or more layers of polymeric material combined with layers of a metal, a metal oxide, or both or blends of polymeric material and metal or metal oxides. Details regarding the metals and metal oxides are described in reference to the first optical stack and second optical stack layers, but the abrasion release layer and the layers of the first optical stack and the second optical stack are separate and distinct and the material of the layer of the first optical layer and the layer of the second optical stack between which is the abrasion release layer is disposed is different so that the abrasion release layer can be removed from each optical stack without removing the optical stack or optical stack layers under certain abrasion forces.

In general and as described herein, the abrasion release layer is made of a different material than the optical layers of the first optical stack and second optical stack and/or can have a greater thickness (e.g., 1.5×, 2×, 3×, 5×, or more) than that greatest thickness of layers of the first optical stack and the second optical stack. The abrasion release layer can be a film applied to the first optical stack (or second optical stack) or it can be a liquid or solid disposed on the first optical stack optical stack (or second optical stack) as a coating. In one aspect, the abrasion release layer is a film that can be applied using heat, pressure, or both. When the abrasion release layer is a coating, the abrasion release layer is applied by spraying, brushing, printing, or applied by dipping to form the coating. In aspects where the abrasion release layer is a composite material, combinations of techniques as described herein can be used to apply the abrasion release layer. In general, the abrasion release layer (e.g., as a film or coating) can have a height (or thickness) of about 10 nanometers to 100 millimeters, about 10 nanometers to 10 millimeters, about 10 nanometers to 1 millimeters, about 10 nanometers to 100 micrometers, about 10 nanometers to 10 micrometers, about 50 nanometers to 10 millimeters, about 50 nanometers to 1 millimeter, about 50 nanometers to 100 micrometers, about 50 nanometers to 10 micrometers, or about 50 nanometers to 1 micrometer.

The material and thickness of the abrasion release layer can be selected based on the material that the first optical stack and second optical stack are made of so that depending upon the abrasive force applied, the second optical stack is removed without removing the first optical stack from the article surface, for example. However, upon enough abrasive force being applied, the second optical stack, the abrasion release layer, and the first optical stack can be removed from the article surface. As a result, the abrasion release material and the thickness of the abrasion release layer as well as the optical stack materials and surface of the article are selected to ensure the desired result of the optical stack being attached to the surface while the abrasion release layer is removed under certain abrasive forces.

Each optical stack that can be or include a single layer reflector, a single layer filter, or multilayer reflector or a multilayer filter. Each optical stack can function to modify the light that impinges thereupon so that structural color is imparted to the article. Each optical stack can also optionally include one or more additional layers (e.g., a protective layer, the textured layer, a polymeric layer, and the like). Each optical stack can have a height (or thickness) of about 10 to 50 nanometers, about 10 to 100 nanometers, about 50 to 100 nanometers, about 50 to 150 nanometers, about 50 to 500 nanometers, about 100 to 1,500 nanometers, about 100 to 1,200 nanometers, about 100 to about 700 nanometers, or of about 200 to about 500 nanometers.

Each optical stack, or layers or portions thereof (e.g., reflective layer, constituent layer, release layer) can be formed using known techniques such as physical vapor deposition, electron beam deposition, atomic layer deposition, molecular beam epitaxy, cathodic arc deposition, pulsed laser deposition, sputtering deposition (e.g., radio frequency, direct current, reactive, non-reactive), chemical vapor deposition, plasma-enhanced chemical vapor deposition, low pressure chemical vapor deposition and wet chemistry techniques such as layer-by-layer deposition, sol-gel deposition, Langmuir blodgett, and the like, which can optionally use techniques (e.g., masks) to control the thickness of a layer in one or more areas of the surface of the article. The temperature of the first side can be adjusted using the technique to form the optical stack and/or a separate system to adjust the temperature.

As stated herein, each optical stack can comprise a single layer or multilayer reflector (e.g., reflective layer(s) and/or constituent layer(s)). The multilayer reflector can be configured to have a certain reflectivity at a given wavelength of light (or range of wavelengths) depending, at least in part, on the material selection, thickness and number of the layers of the multilayer reflector. In other words, one can judiciously select the materials, thicknesses, and numbers of the layers of a multilayer reflector and optionally its interaction with one or more other layers, so that it can reflect a certain wavelength of light (or range of wavelengths), to produce a desired structural color.

Each stack (e.g., first stack, second stack, and the like), independently, can include 1 to 20 layers, 2 to 15, 2 to 10 layer, 2 to 6 layers, 2 to 4 layers, 2 to 20 layers, 3 to 20 layers, 4 to 20 layers, 5 to 20 layers, 2 to 10 layer, 3 to 10 layers, 4 to 10 layers, or 5 to 10 layers. Each layer can have a thickness that is about one-fourth of the wavelength of light to be reflected to produce the desired structural color. Each layer can have a height (or thickness) of at least 10 nanometers, optionally at least 30 nanometers, at least 40 nanometers, at least 50 nanometers, at least 60 nanometers, at least 100 nanometers, at least 150 nanometers, optionally a thickness of from about 10 nanometers to about 500 nanometers, about 10 nanometers to about 250 nanometers, about 10 nanometers to about 200 nanometers, about 10 nanometers to about 150 nanometers, about 10 nanometers to about 100 nanometers, or of from about 30 nanometers to about 80 nanometers, or from about 40 nanometers to about 60 nanometers. For example, the layer can be about 30 to 200 nanometers or about 30 to 150 nanometers, or about 20 to 50 nanometers thick.

Each stack (e.g., first stack, the second stack) can comprise a single layer or multilayer filter. The single layer or multilayer filter destructively interferes with light that impinges upon the article, where the destructive interference of the light and optionally interaction with one or more other layers or structures of the optical stack (e.g., a multilayer reflector, a textured structure) impart the structural color. In this regard, the layer of the single layer filter or the layers of the multilayer filter can be designed (e.g., material selection, thickness, number of layer, and the like) so that a single wavelength of light, or a particular range of wavelengths of light, make up the structural color. For example, the range of wavelengths of light can be limited to a range within plus or minus 30 percent or a single wavelength, or within plus or minus 20 percent of a single wavelength, or within plus or minus 10 percent of a single wavelength, or within plus or minus 5 percent or a single wavelength. The range of wavelengths can be broader to produce a more iridescent structural color.

Each stack (e.g., first stack, the second stack) can independently include a metal layer, an oxide layer, a metal alloy, or stainless steel. The oxide layer can be a metal oxide, a doped metal oxide, or a combination thereof. The metal layer, the metal oxide or the doped metal oxide, or metal alloy can include the following: the transition metals, the metalloids, the lanthanides, and the actinides, as well as nitrides, oxynitrides, sulfides, sulfates, selenides, tellurides and a combination of these. The metal layer can be titanium, aluminum, silver, zirconium, chromium, magnesium, silicon, gold, platinum, and a combination thereof or alloys thereof. The metal oxide can include titanium oxide, silver oxide, aluminum oxide, silicon dioxide, tin dioxide, chromia, iron oxide, nickel oxide, silver oxide, cobalt oxide, zinc oxide, platinum oxide, palladium oxide, vanadium oxide, molybdenum oxide, lead oxide, and combinations thereof as well as doped versions of each. In some aspects, the layer can consist essentially of a metal oxide. In some aspects, the layer can consist essentially of titanium dioxide. The metal oxide can be doped with water, inert gasses (e.g., argon), reactive gasses (e.g., oxygen or nitrogen), metals, and a combination thereof. In some aspects, the reflective layer can consist essentially of a doped metal oxide or a doped metal oxynitride or both. In an aspect, the reflective layer can be made of Ti or TiTiOₓ (x=1-2). The density of the Ti layer or TiOₓ layer can be about 3 to 6 grams per centimeter cubed, about 3 to 5 grams per centimeter cubed, about 4 to 5 grams per centimeter cubed, or 4.5 grams per centimeter cubed.

In addition, each layer can be made of liquid crystals. Each layer can be made of a material such as: silicon dioxide, titanium dioxide, zinc sulfide, magnesium fluoride, tantalum pentoxide, aluminum oxide, or a combination thereof. To improve adhesion between layers, a metal layer is adjacent a metal oxide layer formed of the same metal. For example, Ti and TiOₓ can be positioned adjacent one another to improve adhesion.

The material of the layer can be selected based on the desired structural color to be produced. Select materials reflect some wavelengths more than other wavelengths. In this way, the material of the layer can be selected based on the desired structural color. Each stack (e.g., single stack, first stack, the second stack) of the optical stack can be made with a combination of constituent layers and/or reflective layers so that the desired structural color is imparted. Each of the first stack and the second stack can include a reflective layer can have a minimum percent reflectance of about 50 percent or more (e.g., up to about 70 percent, about 80 percent, about 90 percent, about 95 percent, about 99 percent, or 100 percent) or optionally about 60 percent or more, about 70 percent or more, about 80 percent or more, about 90 percent or more, or about 95 percent or more. Each of the first stack and the second stack can include a reflective layer can have a minimum percent reflectance for one or more of the following wavelength ranges: violet 380 to 450 nanometer, blue 450 to 485 nanometer, cyan 485 to 500 nanometer, green 500 to 565 nanometer, yellow 564 to 590 nanometer, orange 590 to 625 nanometer, or red 625 to 740 nanometer. The reflective layer can have a minimum percent reflectance for one or more wavelength widths (e.g., about 10 nanometers, about 20 nanometers, about 30 nanometers, about 40 nanometers, about 50 nanometers, about 60 nanometers, about 75 nanometers, or about 100 nanometers) in the range from 380 to 740 nanometers. For the ranges not selected in a particular configuration, the minimum reflectivity is lower than that for the selected range, for example, the minimum reflectivity is lower than that for the selected range by about 10 percent or more, about 20 percent or more, about 30 percent or more, about 40 percent or more, or about 50 percent or more. In an aspect, the reflective layer can be Al or AlOₓ, where the structural color is iridescent. In another example, the reflective layer can Ti or TiOₓ, where the structural color can be one or more hues of blue or one or more hues of green, or a combination thereof.

The optical stacks can be a coating on the surface of the article. The coating can be chemically bonded (e.g., covalently bonded, ionically bonded, hydrogen bonded, and the like) to the surface of the article. The coating has been found to bond well to a surface made of a polymeric material. In an example, the surface of the article can be made of a polymeric material such as a polyurethane, including a thermoplastic polyurethane (TPU), as those described herein.

The material of the optical stacks can be uncolored (e.g., no pigments or dyes added to the structure or its layers), colored (e.g., pigments and/or dyes are added to the structure or its layers (e.g., dark or black color)). The surface of the component upon which the optical stack is disposed can be uncolored (e.g., no pigments or dyes added to the material), colored (e.g., pigments and/or dyes are added to the material (e.g., dark or black color)), reflective, and/or transparent (e.g., percent transmittance of 75 percent or more).

The layers can be formed in a layer-by-layer manner, where each layer has a different index of refraction. Each of layers can be formed using known techniques such as those described above and herein.

A polymeric layer can be disposed on the first and/or the second side of the optical stack. The polymeric layer can be used to dispose the optical stack onto an article, such as, for example, when the article does not include a thermoplastic material to adhere the optical stack. The polymeric layer can comprise a polymeric adhesive material, such as a hot melt adhesive. The polymeric layer can be a thermoplastic material and can include one or more layers. The thermoplastic material can be any one of the thermoplastic material described herein. The polymeric layer can be applied using various methodologies, such as spin coating, dip coating, doctor blade coating, and so on. The polymeric layer can have a thickness of about 3 nanometer to 1 millimeter.

Having described aspects, additional details will now be described for the optional textured surface. As described herein, the article includes the optical stack that optionally include a textured surface, where the textured surface is distinct from the protrusions and indentations as described herein. The textured surface can be a surface of a textured structure or a textured layer. The textured surface may be provided as part of the optical stack. For example, the optical stack may comprise a textured layer or a textured structure that comprises the textured surface. The textured surface may be provided as part of the article to which the optical stack is disposed. For example, the unit may be disposed onto the surface of the article where the surface of the article is a textured surface, or the surface of the article includes a textured structure or a textured layer affixed to it.

The textured surface (or a textured structure or textured layer including the textured surface) may be provided as a feature on or part of another medium, such as a transfer medium, and imparted to a side or layer of the optical stack or to the surface of the component. For example, a mirror image or relief form of the textured surface may be provided on the side of a transfer medium, and the transfer medium contacts a side of the optical stack or the surface of the component in a way that imparts the textured surface to the optical stack or article. While the various embodiments herein may be described with respect to a textured surface of the optical stack, it will be understood that the features of the textured surface, or a textured structure or textured layer, may be imparted in any of these ways.

The textured surface can contribute to the structural color resulting from the optical stack. As described herein, structural coloration is imparted, at least in part, due to optical effects caused by physical phenomena such as scattering, diffraction, reflection, interference or unequal refraction of light rays from an optical stack. The textured surface (or its mirror image or relief) can include a plurality of profile features and flat or planar areas, which are distinct from the protrusions and indentions described herein. For example, the textured surface (e.g., profile features, flat or planar areas) are superimposed on the protrusions and indentations. In general, the size of the protrusions and indentations is larger than the profile features. The plurality of profile features included in the textured surface, including their size, shape, orientation, spatial arrangement, etc., can affect the light scattering, diffraction, reflection, interference and/or refraction resulting from the optical stack. The flat or planar areas included in the textured surface, including their size, shape, orientation, spatial arrangement, etc., can affect the light scattering, diffraction, reflection, interference and/or refraction resulting from the optical stack. The desired structural color can be designed, at least in part, by adjusting one or more of properties of the profile features and/or flat or planar areas of the textured surface.

The profile features can extend from a side of the flat areas, so as to provide the appearance of projections and/or depressions therein. A flat area can be a flat planar area. A profile feature may include various combinations of projections and depressions, which are distinct from the protrusions and indentations. For example, a profile feature may include a projection with one or more depressions therein, a depression with one or more projections therein, a projection with one or more further projections thereon, a depression with one or more further depressions therein, and the like. The flat areas do not have to be completely flat and can include texture, roughness, and the like. The texture of the flat areas may not contribute much, if any, to the imparted structural color. The texture of the flat areas typically contributes to the imparted structural color. For clarity, the profile features and flat areas are described in reference to the profile features extending above the flat areas, but the inverse (e.g., dimensions, shapes, and the like) can apply when the profile features are depressions in the textured surface.

The textured surface can comprise a thermoplastic material. The profile features and the flat areas can be formed using a thermoplastic material. For example, when the thermoplastic material is heated above its softening temperature a textured surface can be formed in the thermoplastic material such as by molding, stamping, printing, compressing, cutting, etching, vacuum forming, etc., the thermoplastic material to form profile features and flat areas therein. The textured surface can be imparted on a side of a thermoplastic material. The textured surface can be formed in a layer of thermoplastic material. The profile features and the flat areas can be made of the same thermoplastic material or a different thermoplastic material.

The textured surface generally has a length dimension extending along an x-axis, and a width dimension extending along a z-axis, and a thickness dimension extending along a y-axis. The textured surface has a generally planar portion extending in a first plane that extends along the x-axis and the z-axis. A profile feature can extend outward from the first plane, so as to extend above or below the plane x. A profile feature may extend generally orthogonal to the first plane, or at an angle greater to or less than 90 degrees to the first plane.

The dimensional measurements in reference to the profile features (e.g., length, width, height, diameter, and the like) described herein refer to an average dimensional measurement of profile features in 1 square centimeter in the optical stack.

The dimension (e.g., length, width, height, diameter, depending upon the shape of the profile feature) of each profile feature can be within the nanometer to micrometer range. A textured surface can have a profile feature and/or flat area with a dimension of about 10 nanometers to about 500 micrometers. The profile feature can have dimensions in the nanometer range, e.g., from about 10 nanometers to about 1000 nanometers. All of the dimensions of the profile feature (e.g., length, width, height, diameter, depending on the geometry) can be in the nanometer range, e.g., from about 10 nanometers to about 1000 nanometers. The textured surface can have a plurality of profile features having dimensions that are 1 micrometer or less. In this context, the phrase “plurality of the profile features” is meant to mean that about 50 percent or more, about 60 percent or more, about 70 percent or more, about 80 percent or more, about 90 percent or more, or about 99 percent or more of the profile features have a dimension in this range. The profile features can have a ratio of width:height and/or length:height dimensions of about 1:2 and 1:100, or 1:5 and 1:50, or 1:5 and 1:10.

The textured surface can have a profile feature and/or flat area with a dimension within the micrometer range of dimensions. A textured surface can have a profile feature and/or flat area with a dimension of about 1 micrometer to about 500 micrometers. All of the dimensions of the profile feature (e.g., length, width, height, diameter, depending on the geometry) can be in the micrometer range, e.g., from about 1 micrometer to about 500 micrometers. The textured surface can have a plurality of profile features having dimensions that are from about 1 micrometer to about 500 micrometer. In this context, the phrase “plurality of the profile features” is meant to mean that about 50 percent or more, about 60 percent or more, about 70 percent or more, about 80 percent or more, about 90 percent or more, or about 99 percent or more of the profile features have a dimension in this range. The height of the profile features (or depth if depressions) can be about 0.1 and 50 micrometers, about 1 to 5 micrometers, or 2 to 3 micrometers. The profile features can have a ratio of width:height and/or length:height dimensions of about 1:2 and 1:100, or 1:5 and 1:50, or 1:5 and 1:10.

A textured surface can have a plurality of profile features having a mixture of size dimensions within the nanometer to micrometer range (e.g., a portion of the profile features are on the nanometer scale and a portion of the profile features are on the micrometer scale). A textured surface can have a plurality of profile features having a mixture of dimensional ratios. The textured surface can have a profile feature having one or more nanometer-scale projections or depressions on a micrometer-scale projection or depression.

The profile feature can have height and width dimensions that are within a factor of three of each other (0.33w≤h≤3w where w is the width and h is the height of the profile feature) and/or height and length dimensions that are within a factor of three of each other (0.33l≤h≤3l where l is the length and h is the height of the profile feature). The profile feature can have a ratio of length:width that is from about 1:3 to about 3:1, or about 1:2 to about 2:1, or about 1:1.5 to about 1.5:1, or about 1:1.2 to about 1.2:1, or about 1:1. The width and length of the profile features can be substantially the same or different.

It should be stated that while the broad range of the dimensions of the profile features and protrusions and indentations overlap, these dimensions would not overlap in a particular application. The one or more of the dimensions of the protrusions and indentations would be a factor of 10, 15, 20, 50 or 100 or more than one or more of the dimensions of the profile features.

In another aspect, the textured surface can have a profile feature and/or flat area with at least one dimension in the mid-micrometer range and higher (e.g., greater than 500 micrometers). The profile feature can have at least one dimension (e.g., the largest dimension such as length, width, height, diameter, and the like depending upon the geometry or shape of the profile feature) of greater than 500 micrometers, greater than 600 micrometers, greater than 700 micrometers, greater than 800 micrometers, greater than 900 micrometers, greater than 1000 micrometers, greater than 2 millimeters, greater than 10 millimeters, or more. For example, the largest dimension of the profile feature can range from about 600 micrometers to about 2000 micrometers, or about 650 micrometers to about 1500 micrometers, or about 700 micrometers to about 1000 micrometers. At least one or more of the dimensions of the profile feature (e.g., length, width, height, diameter, depending on the geometry) can be in the micrometer range, while one or more of the other dimensions can be in the nanometer to micrometer range (e.g., less than 500 micrometers, less than 100 micrometers, less than 10 micrometers, or less than 1 micrometer). The textured surface can have a plurality of profile features having at least one dimension that is in the mid-micrometer or more range (e.g., 500 micrometers or more). In this context, the phrase “plurality of the profile features” is meant to mean that about 50 percent or more, about 60 percent or more, about 70 percent or more, about 80 percent or more, about 90 percent or more, or about 99 percent or more of the profile features have at least one dimension that is greater than 500 micrometers. In particular, at least one of the length and width of the profile feature is greater than 500 micrometers or both the length and the width of the profile feature is greater than 500 micrometers. In another example, the diameter of the profile feature is greater than 500 micrometers. In another example, when the profile feature is an irregular shape, the longest dimension is greater than 500 micrometers.

In aspects, the height of the profile features can be greater than 50 micrometers. In this context, the phrase “plurality of the profile features” is meant to mean that about 50 percent or more, about 60 percent or more, about 70 percent or more, about 80 percent or more, about 90 percent or more, or about 99 percent or more of the profile features have at height that is greater than 50 micrometers. The height of the profile feature can be 50 micrometers, about 60 micrometers, about 70 micrometers, about 80 micrometers, about 90 micrometers, or about 100 micrometers to about 60 micrometers, about 70 micrometers, about 80 micrometers, about 90 micrometers, about 100 micrometers, about 150 micrometers, about 250 micrometers, about 500 micrometers or more. For example, the ranges can include 50 micrometers to 500 micrometers, about 60 micrometers to 250 micrometers, about 60 micrometers to about 150 micrometers, and the like. One or more of the other dimensions (e.g., length, width, diameter, or the like) can be in the nanometer to micrometer range (e.g., less than 500 micrometers, less than 100 micrometers, less than 10 micrometers, or less than 1 micrometer). In particular, at least one of the length and width of the profile feature is less than 500 micrometers or both the length and the width of the profile feature is less than 500 micrometers, while the height is greater than 50 micrometers. One or more of the other dimensions (e.g., length, width, diameter, or the like) can be in the micrometer to millimeter range (e.g., greater than 500 micrometers to 10 millimeters).

The dimension (e.g., length, width, height, diameter, depending upon the shape of the profile feature) of each profile feature can be within the nanometer to micrometer range. The textured surface can have a profile feature and/or flat area with a dimension of about 10 nanometers to about 500 micrometers or higher (e.g., about 1 millimeter, about 2 millimeters, about 5 millimeters, or about 10 millimeters). At least one of the dimensions of the profile feature (e.g., length, width, height, diameter, depending on the geometry) can be in the nanometer range (e.g., from about 10 nanometers to about 1000 nanometers), while at least one other dimension (e.g., length, width, height, diameter, depending on the geometry) can be in the micrometer range (e.g., 5 micrometers to 500 micrometers or more (e.g., about 1 to 10 millimeters)). The textured surface can have a plurality of profile features having at least one dimension in the nanometer range (e.g., about 10 to 1000 nanometers) and the other in the micrometer range (e.g., 5 micrometers to 500 micrometers or more). In this context, the phrase “plurality of the profile features” is meant to mean that about 50 percent or more, about 60 percent or more, about 70 percent or more, about 80 percent or more, about 90 percent or more, or about 99 percent or more of the profile features have at least one dimension in the nanometer range and at least one dimension in the micrometer range. In particular, at least one of the length and width of the profile feature is in the nanometer range, while the other of the length and the width of the profile feature is in the micrometer range.

In aspects, the height of the profile features can be greater than 250 nanometers. In this context, the phrase “plurality of the profile features” is meant to mean that about 50 percent or more, about 60 percent or more, about 70 percent or more, about 80 percent or more, about 90 percent or more, or about 99 percent or more of the profile features have at height that is greater than 250 nanometers. The height of the profile feature can be 250 nanometers, about 300 nanometers, about 400 nanometers, or about 500 nanometers, to about 300 nanometers, about 400 nanometers, about 500 nanometers, or about 1000 nanometers or more. For example, the range can be 250 nanometers to about 1000 nanometers, about 300 nanometers to 500 nanometers, about 400 nanometers to about 1000 nanometers, and the like. One or more of the other dimensions (e.g., length, width, diameter, or the like) can be in the micrometer to millimeter range (e.g., greater than 500 micrometers to 10 millimeters). In particular, at least one of the length and width of the profile feature is in the nanometer range (e.g., about 10 to 1000 nanometers) and the other in the micrometer range (e.g., 5 micrometers to 500 micrometers or more), while the height is greater than 250 nanometers.

The profile features can have a certain spatial arrangement. The spatial arrangement of the profile features may be uniform, such as spaced evenly apart or forming a pattern. The spatial arrangement can be random. Adjacent profile features can be about 10 to 500 nanometers apart, about 100 to 1000 nanometers apart, about 1 to 100 micrometers apart or about 5 to 100 micrometers apart. Adjacent profile features can overlap one another or be adjacent one another so little or no flat regions are positioned there between. The desired spacing can depend, at least in part, on the size and/or shape of the profile structures and the desired structural color effect.

The profile features can have a certain cross-sectional shape (with respect to a plane parallel the first plane). The textured surface can have a plurality of profile features having the same or similar cross-sectional shape. The textured surface has a plurality of profile features having a mixture of different cross-sectional shapes. The cross-sectional shapes of the profile features can include polygonal (e.g., square or triangle or rectangle cross section), circular, semi-circular, tubular, oval, random, high and low aspect ratios, overlapping profile features, and the like.

The profile feature (e.g., about 10 nanometers to 500 micrometers) can include an upper, flat surface. The profile feature (e.g., about 10 nanometers to 500 micrometers) can include an upper, concavely curved surface. The concave curved surface may extend symmetrically either side of an uppermost point. The concave curved surface may extend symmetrically across only 50 percent of the uppermost point. The profile feature (e.g., about 10 nanometers to 500 micrometers) can include an upper, convexly curved surface. The curved surface may extend symmetrically either side of an uppermost point. The curved surface may extend symmetrically across only 50 percent of the uppermost point.

The profile feature can include protrusions from the textured surface. The profile feature can include indents (hollow areas) formed in the textured surface. The profile feature can have a smooth, curved shape (e.g., a polygonal cross-section with curved corners).

The profile features (whether protrusions or depressions) can be approximately conical or frusto-conical (i.e., the projections or indents may have horizontally or diagonally flattened tops) or have an approximately part-spherical surface (e.g., a convex or concave surface respectively having a substantially even radius of curvature).

The profile features may have one or more sides or edges that extend in a direction that forms an angle to the first plane of the textured surface. The angle between the first plane and a side or edge of the profile feature is about 45 degrees or less, about 30 degrees or less, about 25 degrees or less, or about 20 degrees or less. The one or more sides or edges may extend in a linear or planar orientation, or may be curved so that the angle changes as a function of distance from the first plane. The profile features may have one or more sides that include step(s) and/or flat side(s). The profile feature can have one or more sides (or portions thereof) that can be orthogonal or perpendicular to the first plane of the textured surface, or extend at an angle of about 10 degrees to 89 degrees to the first plane (90 degrees being perpendicular or orthogonal to the first plane)). The profile feature can have a side with a stepped configuration, where portions of the side can be parallel to the first plane of the textured surface or have an angle of about 1 degrees to 179 degrees (0 degrees being parallel to the first plane)).

The textured surface can have profile features with varying shapes (e.g., the profile features can vary in shape, height, width and length among the profile features) or profile features with substantially uniform shapes and/or dimensions. The structural color produced by the textured surface can be determined, at least in part, by the shape, dimensions, spacing, and the like, of the profile features.

The profile features can be shaped so as to result in a portion of the surface (e.g., about 25 to 50 percent or more) being about normal to the incoming light when the light is incident at the normal to the first plane of the textured surface. The profile features can be shaped so as to result in a portion of the surface (e.g., about 25 to 50 percent or more) being about normal to the incoming light when the light is incident at an angle of up to 45 degrees to the first plane of the textured surface.

The spatial orientation of the profile features on the textured surface can be used to produce the structural color, or to effect the degree to which the structural color shifts at different viewing angles. The spatial orientation of the profile features on the textured surface can be random, a semi-random pattern, or in a set pattern. A set pattern of profile features is a known set up or configuration of profile features in a certain area (e.g., about 50 nanometers squared to about 10 millimeters squared depending upon the dimensions of the profile features (e.g., any increment between about 50 nanometers and about 10 millimeters is included)). A semi-random pattern of profile features is a known set up of profile features in a certain area (e.g., about 50 nanometers squared to 10 millimeters squared) with some deviation (e.g., 1 to 15% deviation from the set pattern), while random profile features are present in the area but the pattern of profile features is discernable. A random spatial orientation of the profile features in an area produces no discernable pattern in a certain area, (e.g., about 50 nanometers squared to 10 millimeters squared).

The spatial orientation of the profile features can be periodic (e.g., full or partial) or non-periodic. A periodic spatial orientation of the profile features is a recurring pattern at intervals. The periodicity of the periodic spatial orientation of the profile features can depend upon the dimensions of the profile features but generally are periodic from about 50 nanometers to 100 micrometers. For example, when the dimensions of the profile features are submicron, the periodicity of the periodic spatial orientation of the profile features can be in the 50 to 500 nanometer range or 100 to 1000 nanometer range. In another example, when the dimensions of the profile features are at the micron level, the periodicity of the periodic spatial orientation of the profile features can be in the 10 to 500 micrometer range or 10 to 1000 micrometer range. Full periodic pattern of profile features indicates that the entire pattern exhibits periodicity, whereas partial periodicity indicates that less than all of the pattern exhibits periodicity (e.g., about 70-99 percent of the periodicity is retained). A non-periodic spatial orientation of profile features is not periodic and does not show periodicity based on the dimensions of the profile features, in particular, no periodicity in the 50 to 500 nanometer range or 100 to 1000 nanometer range where the dimensions are of the profile features are submicron or no periodicity in the 10 to 500 micrometer range or 10 to 1000 micrometer range where the dimensions are of the profile features are in the micron range.

In an aspect, the spatial orientation of the profile features on the textured surface can be set to reduce distortion effects, e.g., caused by the interference of one profile feature with another in regard to the structural color of the article. Since the shape, dimension, relative orientation of the profile features can vary considerably across the textured surface, the desired spacing and/or relative positioning for a particular area (e.g., in the micrometer range or about 1 to 10 square micrometers) having profile features can be appropriately determined. As discussed herein, the shape, dimension, relative orientation of the profile features affect the contours of the reflective layer(s) and/or constituent layer(s), so the dimensions (e.g., thickness), index of refraction, number of layers in the optical stack (e.g., reflective layer(s) and constituent layer(s)) are considered when designing the textured side of the texture layer.

The profile features are located in nearly random positions relative to one another across a specific area of the textured surface (e.g., in the micrometer range or about 1 to 10 square micrometers to centimeter range or about 0.5 to 5 square centimeters, and all range increments therein), where the randomness does not defeat the purpose of producing the structural color. In other words, the randomness is consistent with the spacing, shape, dimension, and relative orientation of the profile features, the dimensions (e.g., thickness), index of refraction, and number of layers (e.g., the reflective layer(s), the constituent layer(s), and the like, with the goal to achieve the structural color.

The profile features are positioned in a set manner relative to one another across a specific area of the textured surface to achieve the purpose of producing the structural color. The relative positions of the profile features do not necessarily follow a pattern, but can follow a pattern consistent with the desired structural color. As mentioned above and herein, various parameters related to the profile features, flat areas, and reflective layer(s) and/or the constituent layer can be used to position the profile features in a set manner relative to one another.

The textured surface can include micro and/or nanoscale profile features that can form gratings (e.g., a diffractive grating), photonic crystal structure, a selective mirror structure, crystal fiber structures, deformed matrix structures, spiraled coiled structures, surface grating structures, and combinations thereof. The textured surface can include micro and/or nanoscale profile features that form a grating having a periodic or non-periodic design structure to impart the structural color. The micro and/or nanoscale profile features can have a peak-valley pattern of profile features and/or flat areas to produce the desired structural color. The grading can be an Echelette grating.

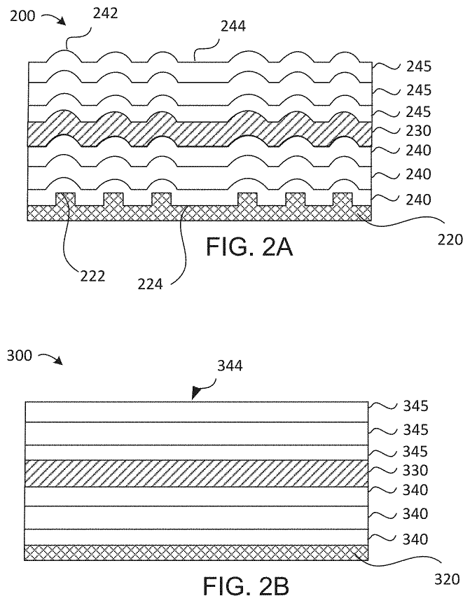

The profile features and the flat areas of the textured surface in the optical stack can appear as topographical undulations in each layer (e.g., reflective layer(s) and/or the constituent layer(s)). For example, referring to FIG. 2A, an optical stack 200 includes a textured structure 220 having a plurality of profile features 222 and flat areas 224. As described herein, one or more of the profile features 222 can be projections from a surface of the textured structure 220, and/or one or more of the profile features can be depressions in a surface of the textured structure 220 (not shown). One or more constituent layers 240 (e.g., first stack)) are disposed on the textured structure 220 and then a release layer 230 and one or more constituent layers 245 (second stack) are disposed on the preceding layers (note that an abrasion release layer can be disposed on layer 245 but is intentional not shown for this embodiment). Adjacent layers (constituent layers and release layer) are made of different types of materials. In some embodiments, the resulting topography of the textured structure 220 and the one or more constituent layers 240 and 245 and the release layer 230 are not identical, but rather, the one or more constituent layers 240 and 245 and the release layer 230 can have elevated or depressed regions 242 which are either elevated or depressed relative to the height of the planar regions 244 and which roughly correspond to the location of the profile features 222 of the textured structure 220. The one or more constituent layers 240 and 245 and the release layer 230 have planar regions 244 that roughly correspond to the location of the flat areas 224 of the textured structure 220. Due to the presence of the elevated or depressed regions 242 and the planar regions 244, the resultant overall topography of the one or more constituent layers 240 and 245 and the release layer 230 can be that of an undulating or wave-like structure. The dimension, shape, and spacing of the profile features along with the number of layers of the constituent layer, the reflective layer, the thickness of each of the layers, refractive index of each layer, and the type of material, can be used to produce an optical stack which results in a particular structural color.

While the textured surface can produce the structural color in some embodiments, or can affect the degree to which the structural color shifts at different viewing angles, in other embodiments, a “textured surface” or surface with texture may not produce the structural color, or may not affect the degree to which the structural color shifts at different viewing angles. The structural color can be produced by the design of the optical stack with or without the textured surface. As a result, the optical stack can include the textured surface having profile elements of dimensions in the nanometer to millimeter range, but the structural color or the shifting of the structural color is not attributable to the presence or absence of the textured surface. In other words, the optical stack imparts the same structural color where or not the textured surface is present The design of the textured surface can be configured to not affect the structural color imparted by the optical stack, or not affect the shifting of the structural color imparted by the optical stack. The shape of the profile features, dimensions of the shapes, the spatial orientation of the profile features relative to one another, and the like can be selected so that the textured surface does not affect the structural color attributable to the optical stack.

In another embodiment, the structural color can be imparted by the optical stack without the textured surface. The surface of the layers of the optical stack are substantially flat (or substantially three dimensional flat planar surface) or flat (or three dimensional flat planar surface) at the microscale (e.g., about 1 to 500 micrometers) and/or nanoscale (e.g., about 50 to 500 nanometers). In regard to substantially flat or substantially planar the surface can include some minor topographical features (e.g., nanoscale and/or microscale) such as those that might be caused due to unintentional imperfections, slight undulations that are unintentional, other topographical features (e.g., extensions above the plane of the layer or depressions below or into the plane of the layer) caused by the equipment and/or process used and the like that are unintentionally introduced. The topographical features do not resemble profile features of the textured surface. In addition, the substantially flat (or substantially three dimensional flat planar surface) or flat (or three dimensional flat planar surface) may include curvature as the dimensions of the optical stack increase, for example about 500 micrometers or more, about 10 millimeter or more, about 10 centimeters or more, depending upon the dimensions of the optical stack, as long as the surface is flat or substantially flat and the surface only includes some minor topographical features.

FIG. 2B is a transverse cross-section illustration of a substantially flat (or substantially three-dimensional flat planar surface) or flat (or three-dimensional flat planar surface) optical stack 300. The optical stack 300 includes one or more constituent layers 340 (e.g., first stack) are disposed on the flat or three-dimensional flat planar surface structure 320 and then a release layer 330 and one or more constituent layers 345 (e.g., second stack) are disposed on the preceding layers. Adjacent layers (constituent layers and release layer) are made of different types of materials. The material that makes up the constituent layers and the release layer, number of layers of the constituent layer, the release layer, the thickness of each of the layers, refractive index of each layer, and the like, can produce an optical stack which results in a particular structural color.

In an aspect, the surface of the article is a textured surface and the optical stack (e.g., first optical stack, second optical stack, or independently the first optical stack and the second optical stack) is on the textured surface. Reference to “structural color” includes the first structural color, second structural color, third or more structural colors, and any combination of these. A hue of the structural color, an intensity of the structural color, a viewing angle at which the structural color is visible, or any combination thereof, can be altered by the textured surface (or optionally the textured surface does not alter any one or a combination of these), as determined by comparing the optical stack comprising the textured surface of a substantially identical optical stack (e.g., material used, thickness, and the like) on a surface of a substantially identical article (e.g., material used, design, and the like) which is free of the textured surface.

In an aspect, the surface of the article is a textured surface and the optical stack (e.g., first optical stack, second optical stack, or independently the first optical stack and the second optical stack) is on the textured surface. The textured surface reduces (e.g., by about 80% to 99%, about 85 to 99%, about 90 to 99%, about 95 to 99%, or about 98 to 99%) or eliminates shift of the structural color (e.g., first structural color, second structural color) as a viewing angle is varied from a first viewing angle to a second viewing angle, as compared to a substantially identical optical stack (e.g., material used, thickness, and the like) on a surface of a substantially identical article (e.g., material used, design, and the like) which is free of the texture.

In an aspect, the surface of the article is a textured surface and the optical stack (e.g., first optical stack, second optical stack, or independently the first optical stack and the second optical stack) is on the textured surface. A hue of the structural color (e.g., first structural color, second structural color), an intensity of the structural color, a viewing angle at which the structural color is visible, or any combination thereof, is unaffected by or substantially unaffected (e.g., affected by about 1% or less, about 0.1 to 2%, about 0.1 to 3%, about 0.1 to 5%, or about 0.1 to 7.5%) by the textured surface, as determined by comparing the optical stack comprising the textured surface to a substantially identical optical stack (e.g., material used, thickness, and the like) on a surface of a substantially identical article (e.g., material used, design, and the like) which is free of the textured surface.

In an aspect, the surface of the article is a textured surface and the optical stack (e.g., first optical stack, second optical stack, or independently the first optical stack and the second optical stack) is on the textured surface. The shift of the structural color (e.g., first structural color, second structural color) is unaltered by or substantially the same (e.g., by about 80% to 99%, about 85 to 99%, about 90 to 99%, about 95 to 99%, or about 98 to 99% the same) as a viewing angle is varied from a first viewing angle to a second viewing angle, as compared to a substantially identical optical stack (e.g., material used, thickness, and the like) on a surface of a substantially identical article (e.g., material used, design, and the like) which is free of the textured surface.

In an aspect, the textured surface includes a plurality of profile features and flat planar areas, where the profile features extend above the flat areas of the textured surface. The dimensions of the profile features, a shape of the profile features, a spacing among the plurality of the profile features, or any combination thereof, in combination with the optical stack (e.g., first optical stack, second optical stack, or independently the first optical stack and the second optical stack), affect a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof.

In an aspect, a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof, are unaffected or substantially unaffected (e.g., affected by about 1% or less, about 0.1 to 2%, about 0.1 to 3%, about 0.1 to 5%, or about 0.1 to 7.5%) by dimensions of the profile features, a shape of the profile features, a spacing among the plurality of the profile features, or any combination thereof, of the textured surface.

In an aspect, the profile features of the textured surface are in random positions relative to one another within a specific area. The spacing between the profile features, in combination with the optical stack (e.g., first optical stack, second optical stack, or independently the first optical stack and the second optical stack), affects a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof.

In an aspect, a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof, is unaffected by, or substantially unaffected (e.g., affected by about 1% or less, about 0.1 to 2%, about 0.1 to 3%, about 0.1 to 5%, or about 0.1 to 7.5%) by, spacing between the profile features in combination with the optical stack.

In an aspect, the profile features and the flat areas result in at least one layer of the optical stack (e.g., first optical stack, second optical stack, or independently the first optical stack and the second optical stack) having an undulating topography across the textured surface and where there is a planar region between neighboring profile features that is planar with the flat planar areas of the textured surface.

In an aspect, the dimensions of the planar region relative to the profile features affect a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof.

In an aspect, a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof, is unaffected by or substantially unaffected (e.g., affected by about 1% or less, about 0.1 to 2%, about 0.1 to 3%, about 0.1 to 5%, or about 0.1 to 7.5%) by dimensions of the planar region relative to the profile features.

In an aspect, the profile features and the flat areas result in each layer of the optical stack (e.g., first optical stack, second optical stack, or independently the first optical stack and the second optical stack) having an undulating topography across the textured surface. The undulating topography of the optical stack affects a hue of the structural color (e.g., first structural color, second structural color), an intensity of the structural color, a viewing angle at which the structural color is visible, shift of the structural color as a viewing angle is varied from a first viewing angle to a second viewing angle, or any combination thereof. A hue of the structural color, an intensity of the structural color, a viewing angle at which the structural color is visible, shift of the structural color as a viewing angle is varied from a first viewing angle to a second viewing angle, or any combination thereof, is unaffected by or substantially unaffected (e.g., affected by about 1% or less, about 0.1 to 2%, about 0.1 to 3%, about 0.1 to 5%, or about 0.1 to 7.5%) by the undulating topography of the optical stack.

Additional details are provided regarding the polymeric materials referenced herein for example, the polymers described in reference to the article, components of the article, structures, layers, films, bladders, foams, coating, and like the. The polymer can be a thermoset polymer or a thermoplastic polymer. The polymer can be an elastomeric polymer, including an elastomeric thermoset polymer or an elastomeric thermoplastic polymer. The polymer can be selected from: polyurethanes (including elastomeric polyurethanes, thermoplastic polyurethanes (TPUs), and elastomeric TPUs), polyesters, polyethers, polyamides, vinyl polymers (e.g., copolymers of vinyl alcohol, vinyl esters, ethylene, acrylates, methacrylates, styrene, and so on), polyacrylonitriles, polyphenylene ethers, polycarbonates, polyureas, polystyrenes, co-polymers thereof (including polyester-polyurethanes, polyether-polyurethanes, polycarbonate-polyurethanes, polyether block polyamides (PEBAs), and styrene block copolymers), and any combination thereof, as described herein. The polymer can include one or more polymers selected from the group consisting of polyesters, polyethers, polyamides, polyurethanes, polyolefins copolymers of each, and combinations thereof.

The term “polymer” refers to a chemical compound formed of a plurality of repeating structural units referred to as monomers. Polymers often are formed by a polymerization reaction in which the plurality of structural units become covalently bonded together. When the monomer units forming the polymer all have the same chemical structure, the polymer is a homopolymer. When the polymer includes two or more monomer units having different chemical structures, the polymer is a copolymer. One example of a type of copolymer is a terpolymer, which includes three different types of monomer units. The co-polymer can include two or more different monomers randomly distributed in the polymer (e.g., a random co-polymer). Alternatively, one or more blocks containing a plurality of a first type of monomer can be bonded to one or more blocks containing a plurality of a second type of monomer, forming a block copolymer. A single monomer unit can include one or more different chemical functional groups.

Polymers having repeating units which include two or more types of chemical functional groups can be referred to as having two or more segments. For example, a polymer having repeating units of the same chemical structure can be referred to as having repeating segments. Segments are commonly described as being relatively harder or softer based on their chemical structures, and it is common for polymers to include relatively harder segments and relatively softer segments bonded to each other in a single monomeric unit or in different monomeric units. When the polymer includes repeating segments, physical interactions or chemical bonds can be present within the segments or between the segments or both within and between the segments. Examples of segments often referred to as hard segments include segments including a urethane linkage, which can be formed from reacting an isocyanate with a polyol to form a polyurethane. Examples of segments often referred to as soft segments include segments including an alkoxy functional group, such as segments including ether or ester functional groups, and polyester segments. Segments can be referred to based on the name of the functional group present in the segment (e.g., a polyether segment, a polyester segment), as well as based on the name of the chemical structure which was reacted in order to form the segment (e.g., a polyol-derived segment, an isocyanate-derived segment). When referring to segments of a particular functional group or of a particular chemical structure from which the segment was derived, it is understood that the polymer can contain up to 10 mole percent of segments of other functional groups or derived from other chemical structures. For example, as used herein, a polyether segment is understood to include up to 10 mole percent of non-polyether segments.

As previously described, the polymer can be a thermoplastic polymer. In general, a thermoplastic polymer softens or melts when heated and returns to a solid state when cooled. The thermoplastic polymer transitions from a solid state to a softened state when its temperature is increased to a temperature at or above its softening temperature, and a liquid state when its temperature is increased to a temperature at or above its melting temperature. When sufficiently cooled, the thermoplastic polymer transitions from the softened or liquid state to the solid state. As such, the thermoplastic polymer may be softened or melted, molded, cooled, re-softened or re-melted, re-molded, and cooled again through multiple cycles. For amorphous thermoplastic polymers, the solid state is understood to be the “rubbery” state above the glass transition temperature of the polymer. The thermoplastic polymer can have a melting temperature from about 90 degrees C. to about 190 degrees C. when determined in accordance with ASTM D3418-97 as described herein below, and includes all subranges therein in increments of 1 degree. The thermoplastic polymer can have a melting temperature from about 93 degrees C. to about 99 degrees C. when determined in accordance with ASTM D3418-97 as described herein below. The thermoplastic polymer can have a melting temperature from about 112 degrees C. to about 118 degrees C. when determined in accordance with ASTM D3418-97 as described herein below.

The glass transition temperature is the temperature at which an amorphous polymer transitions from a relatively brittle “glassy” state to a relatively more flexible “rubbery” state. The thermoplastic polymer can have a glass transition temperature from about −20 degrees C. to about 30 degrees C. when determined in accordance with ASTM D3418-97 as described herein below. The thermoplastic polymer can have a glass transition temperature (from about −13 degree C. to about −7 degrees C. when determined in accordance with ASTM D3418-97 as described herein below. The thermoplastic polymer can have a glass transition temperature from about 17 degrees C. to about 23 degrees C. when determined in accordance with ASTM D3418-97 as described herein below.

The thermoplastic polymer can have a melt flow index from about 10 to about 30 cubic centimeters per 10 minutes (cm3/10 min) when tested in accordance with ASTM D1238-13 as described herein below at 160 degrees C. using a weight of 2.16 kilograms (kg). The thermoplastic polymer can have a melt flow index from about 22 cm3/10 min to about 28 cm3/10 min when tested in accordance with ASTM D1238-13 as described herein below at 160 degrees C. using a weight of 2.16 kg.

The thermoplastic polymer can have a cold Ross flex test result of about 120,000 to about 180,000 cycles without cracking or whitening when tested on a thermoformed plaque of the thermoplastic polymer in accordance with the cold Ross flex test as described herein below. The thermoplastic polymer can have a cold Ross flex test result of about 140,000 to about 160,000 cycles without cracking or whitening when tested on a thermoformed plaque of the thermoplastic polymer in accordance with the cold Ross flex test as described herein below.

The thermoplastic polymer can have a modulus from about 5 megaPascals (MPa) to about 100 MPa when determined on a thermoformed plaque in accordance with ASTM D412-98 Standard Test Methods for Vulcanized Rubber and Thermoplastic Rubbers and Thermoplastic Elastomers-Tension with modifications described herein below. The thermoplastic polymer can have a modulus from about 20 MPa to about 80 MPa when determined on a thermoformed plaque in accordance with ASTM D412-98 Standard Test Methods for Vulcanized Rubber and Thermoplastic Rubbers and Thermoplastic Elastomers-Tension with modifications described herein below.

The polymer can be a thermoset polymer. As used herein, a “thermoset polymer” is understood to refer to a polymer which cannot be heated and melted, as its melting temperature is at or above its decomposition temperature. A “thermoset material” refers to a material which comprises at least one thermoset polymer. The thermoset polymer and/or thermoset material can be prepared from a precursor (e.g., an uncured or partially cured polymer or material) using thermal energy and/or actinic radiation (e.g., ultraviolet radiation, visible radiation, high energy radiation, infrared radiation) to form a partially cured or fully cured polymer or material which no longer remains fully thermoplastic. In some cases, the cured or partially cured polymer or material may remain thermoelastic properties, in that it is possible to partially soften and mold the polymer or material at elevated temperatures and/or pressures, but it is not possible to melt the polymer or material. The curing can be promoted, for example, with the use of high pressure and/or a catalyst. In many examples, the curing process is irreversible since it results in cross-linking and/or polymerization reactions of the precursors. The uncured or partially cured polymers or materials can be malleable or liquid prior to curing. In some cases, the uncured or partially cured polymers or materials can be molded into their final shape, or used as adhesives. Once hardened, a thermoset polymer or material cannot be re-melted in order to be reshaped. The textured surface can be formed by partially or fully curing an uncured precursor material to lock in the textured surface.

### Polyurethane

The polymer can be a polyurethane, such as a thermoplastic polyurethane (also referred to as “TPU”). Alternatively, the polymer can be a thermoset polyurethane. Additionally, polyurethane can be an elastomeric polyurethane, including an elastomeric TPU or an elastomeric thermoset polyurethane. The elastomeric polyurethane can include hard and soft segments. The hard segments can comprise or consist of urethane segments (e.g., isocyanate-derived segments). The soft segments can comprise or consist of alkoxy segments (e.g., polyol-derived segments including polyether segments, or polyester segments, or a combination of polyether segments and polyester segments). The polyurethane can comprise or consist essentially of an elastomeric polyurethane having repeating hard segments and repeating soft segments.

One or more of the polyurethanes can be produced by polymerizing one or more isocyanates with one or more polyols to produce polymer chains having carbamate linkages. The portions of the polyurethane polymer chain formed by the segments derived from isocyanates can be referred to as the hard segments, while the portions derived from polyols can be referred to as soft segments. Optionally, the isocyanates can also be chain extended with one or more chain extenders to bridge two or more isocyanates, increasing the length of the hard segments.

Examples of suitable aliphatic diisocyanates for producing the polyurethane polymer chains include hexamethylene diisocyanate (HDI), isophorone diisocyanate (IPDI), butylenediisocyanate (BDI), bisisocyanatocyclohexylmethane (HMDI), 2,2,4-trimethylhexamethylene diisocyanate (TMDI), bisisocyanatomethylcyclohexane, bisisocyanatomethyltricyclodecane, norbornane diisocyanate (NDI), cyclohexane diisocyanate (CHDI), 4,4′-dicyclohexylmethane diisocyanate (H12MDI), diisocyanatododecane, lysine diisocyanate, and combinations thereof.

The isocyanate-derived segments can include segments derived from aliphatic diisocyanate. A majority of the isocyanate-derived segments can comprise segments derived from aliphatic diisocyanates. At least 90% of the isocyanate-derived segments are derived from aliphatic diisocyanates. The isocyanate-derived segments can consist essentially of segments derived from aliphatic diisocyanates. The aliphatic diisocyanate-derived segments can be derived substantially (e.g., about 50 percent or more, about 60 percent or more, about 70 percent or more, about 80 percent or more, about 90 percent or more) from linear aliphatic diisocyanates. At least 80% of the aliphatic diisocyanate-derived segments can be derived from aliphatic diisocyanates that are free of side chains. The segments derived from aliphatic diisocyanates can include linear aliphatic diisocyanates having from 2 to 10 carbon atoms.

Examples of suitable aromatic diisocyanates for producing the polyurethane polymer chains include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4, 4′-diisocyanate (DDDI), 4,4′-dibenzyl diisocyanate (DBDI), 4-chloro-1,3-phenylene diisocyanate, and combinations thereof. The polymer chains can be substantially free of aromatic groups.

The polyurethane polymer chains can be produced from diisocyanates including HMDI, TDI, MDI, H12 aliphatics, and combinations thereof. For example, the polyurethane can comprise one or more polyurethane polymer chains produced from diisocyanates including HMDI, TDI, MDI, H12 aliphatics, and combinations thereof.

Polyurethane chains which are at least partially crosslinked or which can be crosslinked, can be used in accordance with the present disclosure. It is possible to produce crosslinked or crosslinkable polyurethane chains by reacting multi-functional isocyanates to form the polyurethane. Examples of suitable triisocyanates for producing the polyurethane chains include TDI, HDI, and IPDI adducts with trimethyloylpropane (TMP), uretdiones (i.e., dimerized isocyanates), polymeric MDI, and combinations thereof.

### Polyamides

The polymer can comprise a polyamide, such as a thermoplastic polyamide, or a thermoset polyamide. The polyamide can be an elastomeric polyamide, including an elastomeric thermoplastic polyamide or an elastomeric thermoset polyamide. The polyamide can be a polyamide homopolymer having repeating polyamide segments of the same chemical structure. Alternatively, the polyamide can comprise a number of polyamide segments having different polyamide chemical structures (e.g., polyamide 6 segments, polyamide 11 segments, polyamide 12 segments, polyamide 66 segments, etc.). The polyamide segments having different chemical structure can be arranged randomly, or can be arranged as repeating blocks.

The polyamide can be a co-polyamide (i.e., a co-polymer including polyamide segments and non-polyamide segments). The polyamide segments of the co-polyamide can comprise or consist of polyamide 6 segments, polyamide 11 segments, polyamide 12 segments, polyamide 66 segments, or any combination thereof. The polyamide segments of the co-polyamide can be arranged randomly, or can be arranged as repeating segments. The polyamide segments can comprise or consist of polyamide 6 segments, or polyamide 12 segments, or both polyamide 6 segment and polyamide 12 segments. In the example where the polyamide segments of the co-polyamide include of polyamide 6 segments and polyamide 12 segments, the segments can be arranged randomly. The non-polyamide segments of the co-polyamide can comprise or consist of polyether segments, polyester segments, or both polyether segments and polyester segments. The co-polyamide can be a block co-polyamide, or can be a random co-polyamide. The copolyamide can be formed from the polycondensation of a polyamide oligomer or prepolymer with a second oligomer prepolymer to form a copolyamide (i.e., a co-polymer including polyamide segments. Optionally, the second prepolymer can be a hydrophilic prepolymer.

The polyamide can be a polyamide-containing block co-polymer. For example, the block co-polymer can have repeating hard segments, and repeating soft segments. The hard segments can comprise polyamide segments, and the soft segments can comprise non-polyamide segments. The polyamide-containing block co-polymer can be an elastomeric co-polyamide comprising or consisting of polyamide-containing block co-polymers having repeating hard segments and repeating soft segments. In block co-polymers, including block co-polymers having repeating hard segments and soft segments, physical crosslinks can be present within the segments or between the segments or both within and between the segments.

The polyamide itself, or the polyamide segment of the polyamide-containing block co-polymer can be derived from the condensation of polyamide prepolymers, such as lactams, amino acids, and/or diamino compounds with dicarboxylic acids, or activated forms thereof. The resulting polyamide segments include amide linkages (—(CO)NH—). The term “amino acid” refers to a molecule having at least one amino group and at least one carboxyl group. Each polyamide segment of the polyamide can be the same or different.

The polyamide or the polyamide segment of the polyamide-containing block co-polymer can be derived from the polycondensation of lactams and/or amino acids.

The polyamide can be a thermoplastic polyamide and the constituents of the polyamide block and their proportion can be chosen in order to obtain a melting temperature of less than 150 degrees C., such as a melting point of from about 90 degrees C. to about 135 degrees C. The various constituents of the thermoplastic polyamide block and their proportion can be chosen in order to obtain a melting point of less than 150 degrees C., such as from about and 90 degrees C. to about 135 degrees C.

Exemplary commercially available copolymers include, but are not limited to, those available under the tradenames of “VESTAMID” (Evonik Industries, Essen, Germany); “PLATAMID” (Arkema, Colombes, France), e.g., product code H2694; “PEBAX” (Arkema), e.g., product code “PEBAX MH1657” and “PEBAX MV1074”; “PEBAX RNEW” (Arkema); “GRILAMID” (EMS-Chemie AG, Domat-Ems, Switzerland), or also to other similar materials produced by various other suppliers.

The polyamide can be physically crosslinked through, e.g., nonpolar or polar interactions between the polyamide groups of the polymers. In examples where the polyamide is a copolyamide, the copolyamide can be physically crosslinked through interactions between the polyamide groups, and optionally by interactions between the copolymer groups. When the co-polyamide is physically crosslinked through interactions between the polyamide groups, the polyamide segments can form the portion of the polymer referred to as the hard segment, and copolymer segments can form the portion of the polymer referred to as the soft segment. For example, when the copolyamide is a poly(ether-block-amide), the polyamide segments form the hard segments of the polymer, and polyether segments form the soft segments of the polymer. Therefore, in some examples, the polymer can include a physically crosslinked polymeric network having one or more polymer chains with amide linkages.

The polyamide segment of the co-polyamide can include polyamide-11 or polyamide-12 and the polyether segment can be a segment selected from the group consisting of polyethylene oxide, polypropylene oxide, and polytetramethylene oxide segments, and combinations thereof.

The polyamide can be partially or fully covalently crosslinked, as previously described herein. In some cases, the degree of crosslinking present in the polyamide is such that, when it is thermally processed, e.g., in the form of a yarn or fiber to form the articles of the present disclosure, the partially covalently crosslinked thermoplastic polyamide retains sufficient thermoplastic character that the partially covalently crosslinked thermoplastic polyamide is melted during the processing and re-solidifies. In other cases, the crosslinked polyamide is a thermoset polymer.

### Polyesters

The polymers can comprise a polyester. The polyester can comprise a thermoplastic polyester, or a thermoset polyester. Additionally, the polyester can be an elastomeric polyester, including a thermoplastic polyester or a thermoset elastomeric polyester. The polyester can be formed by reaction of one or more carboxylic acids, or its ester-forming derivatives, with one or more bivalent or multivalent aliphatic, alicyclic, aromatic or araliphatic alcohols or a bisphenol. The polyester can be a polyester homopolymer having repeating polyester segments of the same chemical structure. Alternatively, the polyester can comprise a number of polyester segments having different polyester chemical structures (e.g., polyglycolic acid segments, polylactic acid segments, polycaprolactone segments, polyhydroxyalkanoate segments, polyhydroxybutyrate segments, etc.). The polyester segments having different chemical structure can be arranged randomly, or can be arranged as repeating blocks.

Exemplary carboxylic acids that can be used to prepare a polyester include, but are not limited to, adipic acid, pimelic acid, suberic acid, azelaic acid, sebacic acid, nonane dicarboxylic acid, decane dicarboxylic acid, undecane dicarboxylic acid, terephthalic acid, isophthalic acid, alkyl-substituted or halogenated terephthalic acid, alkyl-substituted or halogenated isophthalic acid, nitro-terephthalic acid, 4,4′-diphenyl ether dicarboxylic acid, 4,4′-diphenyl thioether dicarboxylic acid, 4,4′-diphenyl sulfone-dicarboxylic acid, 4,4′-diphenyl alkylenedicarboxylic acid, naphthalene-2,6-dicarboxylic acid, cyclohexane-1,4-dicarboxylic acid and cyclohexane-1,3-dicarboxylic acid. Exemplary diols or phenols suitable for the preparation of the polyester include, but are not limited to, ethylene glycol, diethylene glycol, 1,3-propanediol, 1,4-butanediol, 1,6-hexanediol, 1,8-octanediol, 1,10-decanediol, 1,2-propanediol, 2,2-dimethyl-1,3-propanediol, 2,2,4-trimethylhexanediol, p-xylenediol, 1,4-cyclohexanediol, 1,4-cyclohexane dimethanol, and bis-phenol A.

The polyester can be a polybutylene terephthalate (PBT), a polytrimethylene terephthalate, a polyhexamethylene terephthalate, a poly-1,4-dimethylcyclohexane terephthalate, a polyethylene terephthalate (PET), a polyethylene isophthalate (PEI), a polyarylate (PAR), a polybutylene naphthalate (PBN), a liquid crystal polyester, or a blend or mixture of two or more of the foregoing.

The polyester can be a co-polyester (i.e., a co-polymer including polyester segments and non-polyester segments). The co-polyester can be an aliphatic co-polyester (i.e., a co-polyester in which both the polyester segments and the non-polyester segments are aliphatic). Alternatively, the co-polyester can include aromatic segments. The polyester segments of the co-polyester can comprise or consist essentially of polyglycolic acid segments, polylactic acid segments, polycaprolactone segments, polyhydroxyalkanoate segments, polyhydroxybutyrate segments, or any combination thereof. The polyester segments of the co-polyester can be arranged randomly, or can be arranged as repeating blocks.

For example, the polyester can be a block co-polyester having repeating blocks of polymeric units of the same chemical structure which are relatively harder (hard segments), and repeating blocks of the same chemical structure which are relatively softer (soft segments). In block co-polyesters, including block co-polyesters having repeating hard segments and soft segments, physical crosslinks can be present within the blocks or between the blocks or both within and between the blocks. The polymer can comprise or consist essentially of an elastomeric co-polyester having repeating blocks of hard segments and repeating blocks of soft segments.

The non-polyester segments of the co-polyester can comprise or consist essentially of polyether segments, polyamide segments, or both polyether segments and polyamide segments. The co-polyester can be a block co-polyester, or can be a random co-polyester. The co-polyester can be formed from the polycondensation of a polyester oligomer or prepolymer with a second oligomer prepolymer to form a block copolyester. Optionally, the second prepolymer can be a hydrophilic prepolymer. For example, the co-polyester can be formed from the polycondensation of terephthalic acid or naphthalene dicarboxylic acid with ethylene glycol, 1,4-butanediol, or 1,3-propanediol. Examples of co-polyesters include polyethylene adipate, polybutylene succinate, poly(3-hydroxbutyrate-co-3-hydroxyvalerate), polyethylene terephthalate, polybutylene terephthalate, polytrimethylene terephthalate, polyethylene napthalate, and combinations thereof. The co-polyamide can comprise or consist of polyethylene terephthalate.

The polyester can be a block copolymer comprising segments of one or more of polybutylene terephthalate (PBT), a polytrimethylene terephthalate, a polyhexamethylene terephthalate, a poly-1,4-dimethylcyclohexane terephthalate, a polyethylene terephthalate (PET), a polyethylene isophthalate (PEI), a polyarylate (PAR), a polybutylene naphthalate (PBN), and a liquid crystal polyester. For example, a suitable polyester that is a block copolymer can be a PET/PEI copolymer, a polybutylene terephthalate/tetraethylene glycol copolymer, a polyoxyalkylenediimide diacid/polybutylene terephthalate copolymer, or a blend or mixture of any of the foregoing.

### Polyolefins

The polymers can comprise or consist essentially of a polyolefin. The polyolefin can be a thermoplastic polyolefin or a thermoset polyolefin. Additionally, the polyolefin can be an elastomeric polyolefin, including a thermoplastic elastomeric polyolefin or a thermoset elastomeric polyolefin. Exemplary polyolefins can include polyethylene, polypropylene, and olefin elastomers (e.g., metallocene-catalyzed block copolymers of ethylene and α-olefins having 4 to about 8 carbon atoms). The polyolefin can be a polymer comprising a polyethylene, an ethylene-α-olefin copolymer, an ethylene-propylene rubber (EPDM), a polybutene, a polyisobutylene, a poly-4-methylpent-1-ene, a polyisoprene, a polybutadiene, a ethylene-methacrylic acid copolymer, and an olefin elastomer such as a dynamically cross-linked polymer obtained from polypropylene (PP) and an ethylene-propylene rubber (EPDM), and blends or mixtures of the foregoing. Further exemplary polyolefins include polymers of cycloolefins such as cyclopentene or norbornene.

It is to be understood that polyethylene, which optionally can be crosslinked, is inclusive a variety of polyethylenes, including low density polyethylene (LDPE), linear low density polyethylene (LLDPE), (VLDPE) and (ULDPE), medium density polyethylene (MDPE), high density polyethylene (HDPE), high density and high molecular weight polyethylene (HDPE-HMW), high density and ultrahigh molecular weight polyethylene (HDPE-UHMW), and blends or mixtures of any the foregoing polyethylenes. A polyethylene can also be a polyethylene copolymer derived from monomers of monolefins and diolefins copolymerized with a vinyl, acrylic acid, methacrylic acid, ethyl acrylate, vinyl alcohol, and/or vinyl acetate. Polyolefin copolymers comprising vinyl acetate-derived units can be a high vinyl acetate content copolymer, e.g., greater than about 50 weight percent vinyl acetate-derived composition.

The polyolefin can be a mixture of polyolefins, such as a mixture of two or more polyolefins disclosed herein above. For example, a suitable mixture of polyolefins can be a mixture of polypropylene with polyisobutylene, polypropylene with polyethylene (for example PP/HDPE, PP/LDPE) or mixtures of different types of polyethylene (for example LDPE/HDPE).

The polyolefin can be a copolymer of suitable monolefin monomers or a copolymer of a suitable monolefin monomer and a vinyl monomer. Exemplary polyolefin copolymers include ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

The polyolefin can be a polypropylene homopolymer, a polypropylene copolymers, a polypropylene random copolymer, a polypropylene block copolymer, a polyethylene homopolymer, a polyethylene random copolymer, a polyethylene block copolymer, a low density polyethylene (LDPE), a linear low density polyethylene (LLDPE), a medium density polyethylene, a high density polyethylene (HDPE), or blends or mixtures of one or more of the preceding polymers.

The polyolefin can be a polypropylene. The term “polypropylene,” as used herein, is intended to encompass any polymeric composition comprising propylene monomers, either alone or in mixture or copolymer with other randomly selected and oriented polyolefins, dienes, or other monomers (such as ethylene, butylene, and the like). Such a term also encompasses any different configuration and arrangement of the constituent monomers (such as atactic, syndiotactic, isotactic, and the like). Thus, the term as applied to fibers is intended to encompass actual long strands, tapes, threads, and the like, of drawn polymer. The polypropylene can be of any standard melt flow (by testing); however, standard fiber grade polypropylene resins possess ranges of Melt Flow Indices between about 1 and 1000.

The polyolefin can be a polyethylene. The term “polyethylene,” as used herein, is intended to encompass any polymeric composition comprising ethylene monomers, either alone or in mixture or copolymer with other randomly selected and oriented polyolefins, dienes, or other monomers (such as propylene, butylene, and the like). Such a term also encompasses any different configuration and arrangement of the constituent monomers (such as atactic, syndiotactic, isotactic, and the like). Thus, the term as applied to fibers is intended to encompass actual long strands, tapes, threads, and the like, of drawn polymer. The polyethylene can be of any standard melt flow (by testing); however, standard fiber grade polyethylene resins possess ranges of Melt Flow Indices between about 1 and 1000.

The thermoplastic and/or thermosetting material can further comprise one or more processing aids. The processing aid can be a non-polymeric material. These processing aids can be independently selected from the group including, but not limited to, curing agents, initiators, plasticizers, mold release agents, lubricants, antioxidants, flame retardants, dyes, pigments, reinforcing and non-reinforcing fillers, fiber reinforcements, and light stabilizers.

In articles that include a textile, the optical stack can be disposed onto the textile (e.g., the optical stack is likely in the “on its side” configuration unless the textile is thin or otherwise the first side of the optical stack can be illuminated). The textile or at least an outer layer of the textile can include a thermoplastic material that the optical stack can disposed onto. The textile can be a nonwoven textile, a synthetic leather, a knit textile, or a woven textile. The textile can comprise a first fiber or a first yarn, where the first fiber or the first yarn can include at least an outer layer formed of the first thermoplastic material. A region of the first or second side of the structure onto which the optical stack is disposed can include the first fiber or the first yarn in a non-filamentous conformation. The optical stack can be disposed onto the textile or the textile can be processed so that the optical stack can be disposed onto the textile. The textured surface can be made of or formed from the textile surface. The textile surface can be used to form the textured surface, and either before or after this, the optical stack can be applied to the textile.

A “textile” may be defined as any material manufactured from fibers, filaments, or yarns characterized by flexibility, fineness, and a high ratio of length to thickness. Textiles generally fall into two categories. The first category includes textiles produced directly from webs of filaments or fibers by randomly interlocking to construct non-woven fabrics and felts. The second category includes textiles formed through a mechanical manipulation of yarn, thereby producing a woven fabric, a knitted fabric, a braided fabric, a crocheted fabric, and the like.

The terms “filament,” “fiber,” or “fibers” as used herein refer to materials that are in the form of discrete elongated pieces that are significantly longer than they are wide. The fiber can include natural, manmade or synthetic fibers. The fibers may be produced by conventional techniques, such as extrusion, electrospinning, interfacial polymerization, pulling, and the like. The fibers can include carbon fibers, boron fibers, silicon carbide fibers, titania fibers, alumina fibers, quartz fibers, glass fibers, such as E, A, C, ECR, R, S, D, and NE glasses and quartz, or the like. The fibers can be fibers formed from synthetic polymers capable of forming fibers such as poly(ether ketone), polyimide, polybenzoxazole, poly(phenylene sulfide), polyesters, polyolefins (e.g., polyethylene, polypropylene), aromatic polyamides (e.g., an aramid polymer such as para-aramid fibers and meta-aramid fibers), aromatic polyimides, polybenzimidazoles, polyetherimides, polytetrafluoroethylene, acrylic, modacrylic, poly(vinyl alcohol), polyamides, polyurethanes, and copolymers such as polyether-polyurea copolymers, polyester-polyurethanes, polyether block amide copolymers, or the like. The fibers can be natural fibers (e.g., silk, wool, cashmere, vicuna, cotton, flax, hemp, jute, sisal). The fibers can be man-made fibers from regenerated natural polymers, such as rayon, lyocell, acetate, triacetate, rubber, and poly(lactic acid).

The fibers can have an indefinite length. For example, man-made and synthetic fibers are generally extruded in substantially continuous strands. Alternatively, the fibers can be staple fibers, such as, for example, cotton fibers or extruded synthetic polymer fibers can be cut to form staple fibers of relatively uniform length. The staple fiber can have a have a length of about 1 millimeter to 100 centimeters or more as well as any increment therein (e.g., 1 millimeter increments).

The fiber can have any of a variety of cross-sectional shapes. Natural fibers can have a natural cross-section, or can have a modified cross-sectional shape (e.g., with processes such as mercerization). Man-made or synthetic fibers can be extruded to provide a strand having a predetermined cross-sectional shape. The cross-sectional shape of a fiber can affect its properties, such as its softness, luster, and wicking ability. The fibers can have round or essentially round cross sections. Alternatively, the fibers can have non-round cross sections, such as flat, oval, octagonal, rectangular, wedge-shaped, triangular, dog-bone, multi-lobal, multi-channel, hollow, core-shell, or other shapes.

The fiber can be processed. For example, the properties of fibers can be affected, at least in part, by processes such as drawing (stretching) the fibers, annealing (hardening) the fibers, and/or crimping or texturizing the fibers.

In some cases a fiber can be a multi-component fiber, such as one comprising two or more co-extruded polymeric materials. The two or more co-extruded polymeric materials can be extruded in a core-sheath, islands-in-the-sea, segmented-pie, striped, or side-by-side configuration. A multi-component fiber can be processed in order to form a plurality of smaller fibers (e.g., microfibers) from a single fiber, for example, by remove a sacrificial material.

The fiber can be a carbon fiber such as TARIFYL produced by Formosa Plastics Corp. of Kaohsiung City, Taiwan, (e.g., 12,000, 24,000, and 48,000 fiber tows, specifically fiber types TC-35 and TC-35R), carbon fiber produced by SGL Group of Wiesbaden, Germany (e.g., 50,000 fiber tow), carbon fiber produced by Hyosung of Seoul, South Korea, carbon fiber produced by Toho Tenax of Tokyo, Japan, fiberglass produced by Jushi Group Co., LTD of Zhejiang, China (e.g., E6, 318, silane-based sizing, filament diameters 14, 15, 17, 21, and 24 micrometers), and polyester fibers produced by Amann Group of Bonningheim, Germany (e.g., SERAFILE 200/2 non-lubricated polyester filament and SERAFILE COMPHIL 200/2 lubricated polyester filament).

A plurality of fibers includes 2 to hundreds or thousands or more fibers. The plurality of fibers can be in the form of bundles of strands of fibers, referred to as tows, or in the form of relatively aligned staple fibers referred to as sliver and roving. A single type fiber can be used either alone or in combination with one or more different types of fibers by co-mingling two or more types of fibers. Examples of co-mingled fibers include polyester fibers with cotton fibers, glass fibers with carbon fibers, carbon fibers with aromatic polyimide (aramid) fibers, and aromatic polyimide fibers with glass fibers.

As used herein, the term “yarn” refers to an assembly formed of one or more fibers, wherein the strand has a substantial length and a relatively small cross-section, and is suitable for use in the production of textiles by hand or by machine, including textiles made using weaving, knitting, crocheting, braiding, sewing, embroidery, or ropemaking techniques. Thread is a type of yarn commonly used for sewing.

Yarns can be made using fibers formed of natural, man-made and synthetic materials. Synthetic fibers are most commonly used to make spun yarns from staple fibers, and filament yarns. Spun yarn is made by arranging and twisting staple fibers together to make a cohesive strand. The process of forming a yarn from staple fibers typically includes carding and drawing the fibers to form sliver, drawing out and twisting the sliver to form roving, and spinning the roving to form a strand. Multiple strands can be plied (twisted together) to make a thicker yarn. The twist direction of the staple fibers and of the plies can affect the final properties of the yarn. A filament yarn can be formed of a single long, substantially continuous filament, which is conventionally referred to as a “monofilament yarn,” or a plurality of individual filaments grouped together. A filament yarn can also be formed of two or more long, substantially continuous filaments which are grouped together by grouping the filaments together by twisting them or entangling them or both. As with staple yarns, multiple strands can be plied together to form a thicker yarn.

Once formed, the yarn can undergo further treatment such as texturizing, thermal or mechanical treating, or coating with a material such as a synthetic polymer. The fibers, yarns, or textiles, or any combination thereof, used in the disclosed articles can be sized. Sized fibers, yarns, and/or textiles are coated on at least part of their surface with a sizing composition selected to change the absorption or wear characteristics, or for compatibility with other materials. The sizing composition facilitates wet-out and wet-through of the coating or resin upon the surface and assists in attaining desired physical properties in the final article. An exemplary sizing composition can comprise, for example, epoxy polymers, urethane-modified epoxy polymers, polyester polymers, phenol polymers, polyamide polymers, polyurethane polymers, polycarbonate polymers, polyetherimide polymers, polyamideimide polymers, polystylylpyridine polymers, polyimide polymers bismaleimide polymers, polysulfone polymers, polyethersulfone polymers, epoxy-modified urethane polymers, polyvinyl alcohol polymers, polyvinyl pyrrolidone polymers, and mixtures thereof.

Two or more yarns can be combined, for example, to form composite yarns such as single- or double-covered yarns, and corespun yarns. Accordingly, yarns may have a variety of configurations that generally conform to the descriptions provided herein.

The yarn can comprise at least one thermoplastic material (e.g., one or more of the fibers can be made of thermoplastic material). The yarn can be made of a thermoplastic material. The yarn can be coated with a layer of a material such as a thermoplastic material.

The linear mass density or weight per unit length of a yarn can be expressed using various units, including denier (D) and tex. Denier is the mass in grams of 9000 meters of yarn. The linear mass density of a single filament of a fiber can also be expressed using denier per filament (DPF). Tex is the mass in grams of a 1000 meters of yarn. Decitex is another measure of linear mass, and is the mass in grams for a 10,000 meters of yarn.

As used herein, tenacity is understood to refer to the amount of force (expressed in units of weight, for example: pounds, grams, centinewtons or other units) needed to break a yarn (i.e., the breaking force or breaking point of the yarn), divided by the linear mass density of the yarn expressed, for example, in (unstrained) denier, decitex, or some other measure of weight per unit length. The breaking force of the yarn is determined by subjecting a sample of the yarn to a known amount of force, for example, using a strain gauge load cell such as an INSTRON brand testing system (Norwood, Mass., USA). Yarn tenacity and yarn breaking force are distinct from burst strength or bursting strength of a textile, which is a measure of how much pressure can be applied to the surface of a textile before the surface bursts.

Generally, in order for a yarn to withstand the forces applied in an industrial knitting machine, the minimum tenacity required is approximately 1.5 grams per Denier. Most yarns formed from commodity polymeric materials generally have tenacities in the range of about 1.5 grams per Denier to about 4 grams per Denier. For example, polyester yarns commonly used in the manufacture of knit uppers for footwear have tenacities in the range of about 2.5 to about 4 grams per Denier. Yarns formed from commodity polymeric materials which are considered to have high tenacities generally have tenacities in the range of about 5 grams per Denier to about 10 grams per Denier. For example, commercially available package dyed polyethylene terephthalate yarn from National Spinning (Washington, N.C., USA) has a tenacity of about 6 grams per Denier, and commercially available solution dyed polyethylene terephthalate yarn from Far Eastern New Century (Taipei, Taiwan) has a tenacity of about 7 grams per Denier. Yarns formed from high performance polymeric materials generally have tenacities of about 11 grams per Denier or greater. For example, yarns formed of aramid fiber typically have tenacities of about 20 grams per Denier, and yarns formed of ultra-high molecular weight polyethylene (UHMWPE) having tenacities greater than 30 grams per Denier are available from Dyneema (Stanley, N.C., USA) and Spectra (Honeywell-Spectra, Colonial Heights, Va., USA).

Various techniques exist for mechanically manipulating yarns to form a textile. Such techniques include, for example, interweaving, intertwining and twisting, and interlooping. Interweaving is the intersection of two yarns that cross and interweave at right angles to each other. The yarns utilized in interweaving are conventionally referred to as “warp” and “weft.” A woven textile includes include a warp yarn and a weft yarn. The warp yarn extends in a first direction, and the weft strand extends in a second direction that is substantially perpendicular to the first direction. Intertwining and twisting encompasses various procedures, such as braiding and knotting, where yarns intertwine with each other to form a textile. Interlooping involves the formation of a plurality of columns of intermeshed loops, with knitting being the most common method of interlooping. The textile may be primarily formed from one or more yarns that are mechanically-manipulated, for example, through interweaving, intertwining and twisting, and/or interlooping processes, as mentioned above.

The textile can be a nonwoven textile. Generally, a nonwoven textile or fabric is a sheet or web structure made from fibers and/or yarns that are bonded together. The bond can be a chemical and/or mechanical bond, and can be formed using heat, solvent, adhesive or a combination thereof. Exemplary nonwoven fabrics are flat or tufted porous sheets that are made directly from separate fibers, molten plastic and/or plastic film. They are not made by weaving or knitting and do not necessarily require converting the fibers to yarn, although yarns can be used as a source of the fibers. Nonwoven textiles are typically manufactured by putting small fibers together in the form of a sheet or web (similar to paper on a paper machine), and then binding them either mechanically (as in the case of felt, by interlocking them with serrated or barbed needles, or hydro-entanglement such that the inter-fiber friction results in a stronger fabric), with an adhesive, or thermally (by applying binder (in the form of powder, paste, or polymer melt) and melting the binder onto the web by increasing temperature). A nonwoven textile can be made from staple fibers (e.g., from wetlaid, airlaid, carding/crosslapping processes), or extruded fibers (e.g., from meltblown or spunbond processes, or a combination thereof), or a combination thereof. Bonding of the fibers in the nonwoven textile can be achieved with thermal bonding (with or without calendering), hydro-entanglement, ultrasonic bonding, needlepunching (needlefelting), chemical bonding (e.g., using binders such as latex emulsions or solution polymers or binder fibers or powders), meltblown bonding (e.g., fiber is bonded as air attenuated fibers intertangle during simultaneous fiber and web formation).

Now having described various aspects of the present disclosure, additional discussion is provided regarding when the optical stack is used in conjunction with a bladder. The bladder can be unfilled, partially inflated, or fully inflated when the optical stack is disposed onto the bladder. The bladder is a bladder capable of including a volume of a fluid. An unfilled bladder is a fluid-fillable bladder and a filled bladder that has been at least partially inflated with a fluid at a pressure equal to or greater than atmospheric pressure. When disposed onto or incorporated into an article of footwear, apparel, or sports equipment, the bladder is generally, at that point, a fluid-filled bladder. The fluid be a gas or a liquid. The gas can include air, nitrogen gas (N₂), or other appropriate gas.

The bladder can have a gas transmission rate for nitrogen gas, for example, where a bladder wall of a given thickness has a gas transmission rate for nitrogen that is at least about ten times lower than the gas transmission rate for nitrogen of a butyl rubber layer of substantially the same thickness as the thickness of the bladder described herein. The bladder can have a first bladder wall having a first bladder wall thickness (e.g., about 0.1 to 40 mils). The bladder can have a first bladder wall that can have a gas transmission rate (GTR) for nitrogen gas of less than about 15 cm³/m²·atm·day, less than about 10 m³/m²·atm·day, less than about 5 cm³/m²·atm·day, less than about 1 cm³/m²·atm·day (e.g., from about 0.001 cm³/m²·atm·day to about 1 cm³/m²·atm·day, about 0.01 cm³/m²·atm·day to about 1 cm³/m²·atm·day or about 0.1 cm³/m²·atm·day to about 1 cm³/m²·atm·day) for an average wall thickness of 20 mils. The bladder can have a first bladder wall having a first bladder wall thickness, where the first bladder wall has a gas transmission rate of 15 cm³/m²·atm·day or less for nitrogen for an average wall thickness of 20 mils.

In an aspect, the bladder has a bladder wall having an interior-facing side and an exterior (or externally)-facing side, where the interior (or internally)-facing side defines at least a portion of an interior region of the bladder. The optical stack having a first side and a second opposing side can be disposed on the exterior-facing side of the bladder, the interior-facing side of the bladder, or both. The optical stack can be disposed in-line or on its side. Where the optical stack is disposed on its side, the optical stack is disposed on the interior-facing side or the exterior-facing side on its side configuration as opposed to in line configuration.

The exterior-facing side of the bladder, the interior-facing side of the bladder, or both can optionally include a plurality of topographical structures (or profile features) extending from the exterior-facing side of the bladder wall, the interior-facing side of the bladder, or both, where the first side or the second side of the optical stack is disposed on the exterior-facing side of the bladder wall and covering the plurality of topographical structures, the interior-facing side of the bladder wall and covering the plurality of topographical structures, or both, and wherein the optical stack imparts a structural color to the bladder wall.

In a particular aspect, the bladder can include a top wall operably secured to the footwear upper, a bottom wall opposite the top wall, and one or more sidewalls extending between the top wall and the bottom wall of the inflated bladder. The top wall, the bottom wall, and the one or more sidewalls collectively define an interior region of the inflated bladder, and wherein the one or more sidewalls each comprise an exterior-facing side. The optical stack having a first side and a second opposing side can be disposed on the exterior-facing side of the bladder, the interior-facing side of the bladder, or both. Optionally, the exterior-facing side of the bladder, the interior-facing side of the bladder, or both can include a plurality of topographical structures extending from the exterior-facing side of the bladder wall, the interior-facing side of the bladder, or both, where the first side or the second side of the optical stack is disposed on the exterior-facing side of the bladder wall and covering the plurality of topographical structures, the interior-facing side of the bladder wall and covering the plurality of topographical structures, or both, and wherein the optical stack imparts a structural color to the bladder wall.

An accepted method for measuring the relative permeance, permeability, and diffusion of inflated bladders is ASTM D-1434-82-V. See, e.g., U.S. Pat. No. 6,127,026, which is incorporated by reference as if fully set forth herein. According to ASTM D-1434-82-V, permeance, permeability and diffusion are measured by the following formulae:

Permeance

(quantity of gas)/[(area)×(time)×(pressure difference)]=permeance (GTR)/(pressure difference)=cm³/m²·atm·day (i.e., 24 hours)

Permeability

[(quantity of gas)×(film thickness)][(area)×(time)×(pressure difference)]=permeability [(GTR)×(film thickness)]/(pressure difference)=[(cm³)(mil)]/m²·atm·day (i.e., 24 hours)

Diffusion at One Atmosphere

(quantity of gas)/[(area)×(time)]=GTR=cm³/m² day (i.e., 24 hours)

The bladder can include a bladder wall that includes a film including at least one polymeric layer or at least two or more polymeric layers. Each of the polymeric layers can be about 0.1 to 40 mils in thickness.

The polymeric layer can be formed of polymer material such as a thermoplastic material as described above and herein and can be the thermoplastic layer upon which the optical stack can be disposed and optionally upon which the textured layer can be disposed or the thermoplastic layer can be used to form the textured layer, and the like. The thermoplastic material can include an elastomeric material, such as a thermoplastic elastomeric material. The thermoplastic materials can include thermoplastic polyurethane (TPU), such as those described above and herein. The thermoplastic materials can include polyester-based TPU, polyether-based TPU, polycaprolactone-based TPU, polycarbonate-based TPU, polysiloxane-based TPU, or combinations thereof. Non-limiting examples of thermoplastic material that can be used include: “PELLETHANE” 2355-85ATP and 2355-95AE (Dow Chemical Company of Midland, Mich., USA), “ELASTOLLAN” (BASF Corporation, Wyandotte, Mich., USA) and “ESTANE” (Lubrizol, Brecksville, Ohio, USA), all of which are either ester or ether based. Additional thermoplastic material can include those described in U.S. Pat. Nos. 5,713,141; 5,952,065; 6,082,025; 6,127,026; 6,013,340; 6,203,868; and 6,321,465, which are incorporated herein by reference.

The polymeric layer can be formed of one or more of the following: ethylene-vinyl alcohol copolymers (EVOH), poly(vinyl chloride), polyvinylidene polymers and copolymers (e.g., polyvinylidene chloride), polyamides (e.g., amorphous polyamides), acrylonitrile polymers (e.g., acrylonitrile-methyl acrylate copolymers), polyurethane engineering plastics, polymethylpentene resins, ethylene-carbon monoxide copolymers, liquid crystal polymers, polyethylene terephthalate, polyether imides, polyacrylic imides, and other polymeric materials known to have relatively low gas transmission rates. Blends and alloys of these materials as well as with the TPUs described herein and optionally including combinations of polyimides and crystalline polymers, are also suitable. For instance, blends of polyimides and liquid crystal polymers, blends of polyamides and polyethylene terephthalate, and blends of polyamides with styrenics are suitable.

Specific examples of polymeric materials of the polymeric layer can include acrylonitrile copolymers such as “BAREX” resins, available from Ineos (Rolle, Switzerland); polyurethane engineering plastics such as “ISPLAST” ETPU available from Lubrizol (Brecksville, Ohio, USA); ethylene-vinyl alcohol copolymers marketed under the tradenames “EVAL” by Kuraray (Houston, Tex., USA), “SOARNOL” by Nippon Gohsei (Hull, England), and “SELAR OH” by DuPont (Wilmington, Del., USA); polyvinylidiene chloride available from S.C. Johnson (Racine, Wis., USA) under the tradename “SARAN”, and from Solvay (Brussels, Belgium) under the tradename “IXAN”; liquid crystal polymers such as “VECTRA” from Celanese (Irving, Tex., USA) and “XYDAR” from Solvay; “MDX6” nylon, and amorphous nylons such as “NOVAMID” X21 from Koninklijke DSM N.V (Heerlen, Netherlands), “SELAR PA” from DuPont; polyetherimides sold under the tradename “ULTEM” by SABIC (Riyadh, Saudi Arabia); poly(vinyl alcohol)s; and polymethylpentene resins available from Mitsui Chemicals (Tokyo, Japan) under the tradename “TPX”.

Each polymeric layer of the film can be formed of a thermoplastic material which can include a combination of thermoplastic polymers. In addition to one or more thermoplastic polymers, the thermoplastic material can optionally include a colorant, a filler, a processing aid, a free radical scavenger, an ultraviolet light absorber, and the like. Each polymeric layer of the film can be made of a different of thermoplastic material including a different type of thermoplastic polymer.

The bladder can be made by applying heat, pressure and/or vacuum to a film. In this regard, the optical stack and optionally the textured layer, and the like can be disposed, formed from, or the like prior to, during, and/or after these steps. The bladder (e.g., one or more polymeric layers) can be formed using one or more polymeric materials, and forming the bladder using one or more processing techniques including, for example, extrusion, blow molding, injection molding, vacuum molding, rotary molding, transfer molding, pressure forming, heat sealing, casting, low-pressure casting, spin casting, reaction injection molding, radio frequency (RF) welding, and the like. The bladder can be made by co-extrusion followed by heat sealing or welding to give an inflatable bladder, which can optionally include one or more valves (e.g., one way valves) that allows the bladder to be filled with the fluid (e.g., gas).

Now having described the optical stack, the optional textured surface, and methods of making the article are now described. In an aspect, the method includes forming layers using one or more techniques described herein.

In general, another method includes forming the first optical stack in a layer-by-layer manner on a surface of an article such as a textile, film, fiber, or monofilament yarn, where the surface can optionally be the textured surface. Then after the first optical stack is formed, an abrasion release layer is formed on the first optical stack, and then the second optical stack can be formed in a layer-by-layer manner on the abrasion release layer. Optionally, a first abrasion release layer can be formed on the substrate and then the first stack can be formed on the first abrasion release layer. Another embodiment of the present disclosure includes disposing the optical stacks (that was already formed) on the article surface.

In general, another method includes making an article by disposing, applying or positioning a first optical stack onto the article surface (optionally disposing, applying or positioning, a first abrasion release layer on the article surface prior to disposing, applying or positioning a first optical stack onto the article surface). Then the method includes disposing, applying or positioning a second optical stack on the abrasion release layer that is on first stack.

The method can provide for the layers of the optical stack(s) being formed on the textured surface. Alternatively, the textured surface can be formed in/on the layer adjacent the surface of the article, and then the remaining layers are disposed thereon. As described herein, the first optical stack and the second optical stack) can be formed in a layer-by-layer manner, where each layer has a different index of refraction. As each layer is formed the undulations and flat regions are altered. The combination of the optional textured surface (e.g., dimensions, shape, and/or spacing of the profile elements) and the layers of the optical stacks (e.g., number of layers, thickness of layers, material of the layers) and the resultant undulations and planar areas can impart the structural color when exposed to visible light. Each layer of the optical stack(s) can be formed in turn, where each layer can be formed then after an appropriate amount of time, additional processing, cooling, or the like, the next layer of the optical stack can be formed.

Measurements for visible light transmittance and visible light reflectance were performed using a Shimadzu UV-2600 Spectrometer (Shimadzu Corporation, Japan). The spectrometer was calibrated using a standard prior to the measurements. The incident angle for all measurements was zero.

The visible light transmittance was the measurement of visible light (or light energy) that was transmitted through a sample material when visible light within the spectral range of 300 nanometers to 800 nanometers was directed through the material. The results of all transmittance over the range of 300 nanometers to 800 nanometers was collected and recorded. For each sample, a minimum value for the visible light transmittance was determined for this range.

The visible light reflectance was a measurement of the visible light (or light energy) that was reflected by a sample material when visible light within the spectral range of 300 nanometers to 800 nanometers was directed through the material. The results of all reflectance over the range of 300 nanometers to 800 nanometers was collected and recorded. For each sample, a minimum value for the visible light reflectance was determined for this range.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

The term “providing”, such as for “providing an article” and the like, when recited in the claims, is not intended to require any particular delivery or receipt of the provided item. Rather, the term “providing” is merely used to recite items that will be referred to in subsequent elements of the claim(s), for purposes of clarity and ease of readability.

Many variations and modifications may be made to the above-described aspects. All such modifications and variations are intended to be included herein within the scope of this disclosure and protected by the following claims.

We claim:

1. An article, comprising:
a first optical stack of optical layers, a second optical stack of optical layers, and a first abrasion release layer between the first optical stack and the second optical stack, wherein the first optical stack is positioned adjacent an article surface, wherein the first optical stack is positioned relatively closer to the article surface than the second optical stack,
wherein the first optical stack has a first side and a second side opposite the first side, wherein the first side of the first optical stack is adjacent the article surface, wherein the first abrasion release layer has a first side disposed on the second side of the first optical stack, wherein the first abrasion release layer has a second side opposite the first side that is adjacent a first side of the second optical stack, wherein the second optical stack has a second side opposite the first side, wherein the second side of the second optical stack is externally facing;
wherein the first optical stack imparts a first structural color, wherein the second optical stack imparts a second structural color, wherein the first abrasion release layer imparts a third color, wherein the first structural color and the second structural color are different in a hue, a value, a chroma, or any combination thereof when viewed from the same angle of observation from some with 20 20 visual acuity from a distance of about 1 meter from the article.

2. The article of claim 1, wherein the first abrasion release layer is disposed over a first area of the first optical stack, wherein the first area of the first optical stack is not visible to the observer with 20 20 visual acuity from a distance of about 1 meter from the article; wherein in a second area of the optical stack the first abrasion release layer has been removed from the first optical stack and the second area of the first optical stack imparts the first structural color so that the second area of the first optical stack is visible to someone with 20 20 visual acuity from a distance of about 1 meter from the article, optionally, wherein in a third area, the first optical stack, the second optical stack, and the first abrasion release layer have been removed so the surface of the article is visible to the observer with 20 20 visual acuity from a distance of about 1 meter from the article.

3. The article of claim 1, wherein the first abrasion release layer has the characteristic that application of a first abrasive force to a first area of the second optical stack, the second optical stack in the first area is removed; wherein the first abrasion release layer remains disposed on a first area of the first optical stack, wherein the first area of the optical stack is positioned directly underneath the first area of the second optical stack.

4. The article of claim 1, wherein the first abrasion release layer is disposed over a first area of the first optical stack where the second optical stack is not disposed on the first area of the first optical stack, wherein the first area of the first optical stack is not visible to the observer with 20 20 visual acuity from a distance of about 1 meter from the article; optionally wherein the first abrasion release layer has the characteristic that application of a second abrasive force to the first area of the first optical stack, the first abrasion release layer in the first area of the first optical stack is removed so that the first optical stack is visible to someone with 20 20 visual acuity from a distance of about 1 meter from the article.

5. The article of claim 1, wherein the first abrasive force is sufficient to break the bonds between the first abrasion release layer and the second optical stack but less than the an abrasive force sufficient to break the bonds between or among optical layers of the first optical stack or sufficient to break the bonds between the first optical stack and the first abrasion release layer or sufficient to break the bonds between the first optical stack and the article surface, or a combination of these.

6. The article of claim 1, wherein the second abrasive force is sufficient to break the bonds between the first abrasion release layer and the first optical stack but less than an abrasive force sufficient to break the bonds between or among optical layers of the first optical stack or sufficient to break the bonds between the first optical stack and the article surface, or a combination of these.

7. The article of claim 1, wherein a third abrasive force is sufficient to break the bonds between the second optical stack, first abrasion release layer and the first optical stack to remove each of the second optical stack, first abrasion release layer and the first optical stack from the article surface.

8. The article of claim 1, wherein the first abrasion release layer is opaque, wherein the first abrasion release layer does not impart structural color, wherein the first abrasion release layer includes colorants.

9. The article of claim 1, wherein the first abrasion release layer is about 10 to 200 nanometers thick.

10. The article of claim 1, wherein the first abrasion release layer includes a polymeric material or a composite material.

11. The article of claim 10, wherein the polymeric material comprises one or more thermoplastic polymers, or one or more cross-linked polymers.

12. The article of claim 1, wherein the first abrasion release layer comprises or consists essentially of a material that is different than the material of the first optical stack and the second optical stack.

13. The article of claim 1, wherein the first abrasion release layer is a film.

14. The article of claim 1, wherein the first abrasion release layer is a coating.

15. The article of claim 1, wherein the imparted second structural color is attributed to the layers of the second stack and not first abrasion release layer and the first stack.

16. The article of claim 1, wherein the first stack has a base unit height of about 10 to about 200 nanometers, wherein the second stack has a base unit height of about 10 to about 200 nanometers, and wherein second stack and the first stack have an area of about 1 micrometer squared to 100 centimeters squared.

17. The article of claim 1, further comprising a second abrasion release layer disposed between the first side of the optical stack and the article surface.

18. The article of claim 17, wherein a fourth abrasive force is sufficient to break the bonds between the second optical stack, first abrasion release layer and the first optical stack to remove each of the second optical stack, first abrasion release layer and the first optical stack from the second abrasion release layer on the article surface.

19. A method of making an article, comprising:
disposing, applying or positioning a first stack onto the surface of a substrate;
disposing, applying or positioning a release layer on the first stack
disposing, applying or positioning a second stack on the release layer;
wherein the first stack imparts a first structural color and the second stack imparts a second structural color, wherein a hue, a value, a chroma, or any combination thereof of the first structural color and the second structural color are different when viewed from the same angle of observation from someone with 20 20 visual acuity from a distance of about 1 meter from the article, wherein the release layer imparts a first color.

20. An article comprising: a product of the method of claim 19.
